(19) United States
(12) Patent Application Publication
(10) Pub. No.: US 2026/0339027 A1
(43) Pub. Date: Oct. 29, 2026

(54) STRUCTURES AND METHODS FOR INTEGRATED OPTICS MICROELECTROMECHANICAL SYSTEMS

(71) Applicants: FRANCOIS MENARD, TROIS-RIVIERES (CA); JONATHAN BRIERE, TERREBONNE (CA); MARTIN BERARD, STE-CATHERINE-DE-LA-JACQUES-CARTIER (CA); MAEL BRUDER, MONTREAL (CA); FREDERIC NABKI, MONTREAL (CA); MOHANNAD ELSAYED, VERDUN (CA); SURAJ SHARMA, MONTREAL (CA); DAMIEN MICHEL, BROMONT (CA); MICHAEL MENARD, VERDUN (CA); PIERRE POTTIER, MONTREAL (CA); JUSTIN ALEXANDER, GATINEAU (CA); BRUNO LEE SANG, SAINT-HUBERT (CA); CEDRIK COIA, GREENFIELD PARK (CA)

(72) Inventors: FRANCOIS MENARD, TROIS-RIVIERES (CA); JONATHAN BRIERE, TERREBONNE (CA); MARTIN BERARD, STE-CATHERINE-DE-LA-JACQUES-CARTIER (CA); MAEL BRUDER, MONTREAL (CA); FREDERIC NABKI, MONTREAL (CA); MOHANNAD ELSAYED, VERDUN (CA); SURAJ SHARMA, MONTREAL (CA); DAMIEN MICHEL, BROMONT (CA); MICHAEL MENARD, VERDUN (CA); PIERRE POTTIER, MONTREAL (CA); JUSTIN ALEXANDER, GATINEAU (CA); BRUNO LEE SANG, SAINT-HUBERT (CA); CEDRIK COIA, GREENFIELD PARK (CA)

(21) Appl. No.: 19/726,991

(22) Filed: Jul. 1, 2026

Related U.S. Application Data
(63) Continuation of application No. 19/448,640, filed on Jan. 14, 2026.
(63) Continuation of application No. 18/699,984, filed on Nov. 7, 2022.
Application No. 19/448,640 is a continuation of application No. 17/309,230, filed on Nov. 8, 2019, now Pat. No. 12,554,065.
(60) Provisional application No. 62/757,317, filed on Nov. 8, 2018.
(60) Provisional application No. 63/276,052, filed on Nov. 5, 2021.

(51) Int. Cl. G02B 6/132; G02B 6/12; G02B 6/126

(52) U.S. Cl. CPC G02B 6/132; G02B 6/126; G02B 2006/12038; G02B 2006/12061; G02B 2006/121; G02B 2006/12145; G02B 2006/12164; G02B 2006/12169; G02B 2006/12176

(57) ABSTRACT

Silicon Photonics is a candidate technology for adding integrated optics functionality, either passive or active optical waveguides) to integrated circuits by leveraging the economies of scale of the CMOS microelectronics industry and using materials for the waveguide core such as silicon nitride (Si_{X}N_{Y}) and silicon oxynitride (SiO_{X}N_{1-X}) for example. Microelectromechanical systems (MEMS) provide for movable platforms relative to the substrate allowing additional functionality to be added to a silicon circuit but also Silicon Photonics. Accordingly, by combining “fixed” waveguides formed upon a substrate with “movable” waveguides formed upon one or more movable or extendible platforms the inventors have established a series of Integrated Optics MEMS (IO-MEMS) elements based on Silicon Photonics. Such IO-MEMS include optical switches, optical attenuators, optical gates, optical switch matrices, configurable wavelength division multiplexer/demultiplexer devices, phase shifters, phase modulators and amplitude modulators exploiting suspended platforms and beams.

### CROSS-REFERENCE TO RELATED APPLICATIONS

This application claims the benefit of priority as a continuation of U.S. patent application Ser. No. 19/448,640, filed Jan. 14, 2026; which itself claims the benefit of priority as a continuation of U.S. patent application Ser. No. 17/309,230, filed May 10, 2021, issued as U.S. Pat. No. 12,554,065; which itself claims the benefit of priority as a 371 National Phase entry of International Patent Application No. PCT/CA2019/000156, filed Nov. 8, 2019; which itself claims the benefit of priority from U.S. Provisional Patent No. 62/757,317, filed Nov. 8, 2018; the entire contents of each being incorporated herein by reference.

This patent application claims the benefit of priority as a continuation of U.S. patent application Ser. No. 18/699,984, filed Apr. 10, 2024; which itself claims the benefit of priority as a 371 National Phase entry of International Patent Application No. PCT/CA2022/051642, filed Nov. 7, 2022; which itself claims the benefit of priority from U.S. Provisional Patent Application No. 63/276,052, filed Nov. 5, 2021; the entire contents of each being incorporated herein by reference.

### FIELD OF THE INVENTION

This invention is directed to integrated optic MEMS (IO-MEMS) and optical device concepts and more particularly to establishing structures and methods for implementing phase shifting elements, microelectromechanical systems (MEMS) phase shifter elements, MEMS actuated optical devices as well as stress mitigation within MEMS actuated optical devices, optical component packaging, optical coupling and stress compensated component manufacturing.

### BACKGROUND OF THE INVENTION

Silicon Photonics is a promising technology for adding integrated optics functionality to integrated circuits by leveraging the economies of scale of the CMOS microelectronics industry. Common variants of Silicon Photonics may use other materials as the waveguide core such as silicon nitride (Si_{X}N_{Y}) and silicon oxynitride (SiOₓN₁₋ₓ) for example. Microelectromechanical systems (MEMS) are small integrated devices or systems that combine electrical and mechanical functionality within a silicon integrated circuit, although other material systems may be employed. MEMS can range in size from the sub-micrometer level to the millimeter level, and there can be any number, from one, to few, to potentially thousands or millions, in a particular system. Historically, MEMS devices have leveraged and extended the fabrication techniques developed for the silicon integrated circuit industry, namely thin film deposition, lithography, etching, etc. to add mechanical elements such as beams, gears, diaphragms, and springs to silicon circuits either as discrete devices or in combination with silicon electronics.

Accordingly, it would be beneficial to combine a MEMS element within a silicon photonic waveguide to provide optical functionality such as a phase tuning elements, optical attenuators, optical switches, optical modulators etc. without requiring complex additional processing to provide p-doped and n-doped regions vertically and/or laterally for carrier injection adjustment of the optical waveguides. It would be further beneficial to combine silicon photonics devices with silicon CMOS control and drive circuits.

Accordingly, the inventors have established structures and methods for implementing phase shifting elements, microelectromechanical systems (MEMS) phase shifter elements, MEMS actuated optical devices as well as stress mitigation within MEMS actuated optical devices, optical component packaging, optical coupling and stress compensated component manufacturing.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations in the prior art relating to integrated optic MEMS (IO-MEMS) and optical device concepts and more particularly to establishing structures and methods for implementing phase shifting elements, microelectromechanical systems (MEMS) phase shifter elements, MEMS actuated optical devices as well as stress mitigation within MEMS actuated optical devices, optical component packaging, optical coupling and stress compensated component manufacturing.

In accordance with an embodiment of the invention there is provided a waveguide based optical element forming part of an optical device comprising:
the waveguide based optical element comprising:
   a non-suspended portion attached to a substrate of the optical device;
   a suspended portion disposed above the substrate;
   one or more optical waveguides disposed upon the non-suspended portion; and
   another optical waveguide disposed upon the suspended portion; and
an actuator inducing a variation within a property of optical signals propagating within the another optical waveguide upon the suspended portion.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts the implementation of a 2×3 optical switch for dual fiber optical links protected with a third optical fiber providing normal and “fail” protection states/internal interconnections implemented using conventional IO-MEMS 1×2 switch elements;

FIG. 2 depicts the implementation of a 2×3 optical switch for dual fiber optical links protected with a third optical fiber, with normal and “fail” states/internal interconnections implemented using conventional IO-MEMS 1×2 and 2×2 switch elements;

FIG. 3 depicts the normal and “fail” protection modes for a dual fiber optical communications link protected by a third optical fiber, exploiting a pair of identical 2×3 IO-MEMS optical switches according to an embodiment of the invention;

FIG. 4 depicts the internal implementation of a 2×3 optical switch exploiting IO-MEMS concepts according to an embodiment of the invention for dual fiber optical links exploiting 90-degree turning mirrors;

FIG. 5A depicts the normal configuration mode for a dual fiber optical link with single protection fiber exploiting a pair of IO-MEMS based 2×3 optical switches implemented according to embodiments of the invention exploiting 90-degree turning mirrors rather than waveguide bends;

FIGS. 5B and 5C depict the two different “fail” protection modes for a dual fiber optical link with single protection fiber exploiting a pair of IO-MEMS based 2×3 optical switches implemented according to embodiments of the invention exploiting 90-degree turning mirrors;

FIG. 6A depicts an exemplary alternate configuration for a 2×3 optical switch for dual fiber optical link protection implemented using a pair of IO-MEMS based “horseshoe” configuration optical switches according to an embodiment of the invention exploiting waveguide bends rather than turning mirrors;

FIG. 6B depicts an exemplary configuration for connecting a first crossbar switching cell to a second crossbar switching cell such that unit cells can be within embodiments of the invention in an array of M×N instances to create larger switching matrices (arrays) exploiting waveguide bends rather than turning mirrors;

FIGS. 7A and 7B depict exemplary die layouts for a 1×4 optical switch exploiting the IO-MEMS based “horseshoe” configuration optical switch according to an embodiment of the invention where the waveguides on the suspended platform are omitted for clarity and which can exploit either 90-degree turning mirrors or waveguide bends;

FIG. 8 depicts an exemplary design for a programmable switch state stopper for a MEMS based optical switch exploiting the “horseshoe” configuration according to an embodiment of the invention;

FIGS. 9A to 9C depict exemplary designs for stoppers for gap closers within MEMS based optical switches according to an embodiment of the invention;

FIG. 10 depicts an optical coupling between MEMS sections of MEMS optical switches according to embodiments of the invention exploiting waveguide inverse tapers and/or and multimode interference couplers for mode size adaptation at the IO-MEMS interfaces;

FIGS. 11A and 11B depict bar and cross state configurations for a 2×2 MEMS optical switch according to an embodiment of the invention;

FIG. 11C depicts actuator configurations for a 2×2 MEMS optical switch according to an embodiment of the invention with “blocked” power fail state and driven “cross” and “bar” states;

FIG. 12A depicts an unpowered, non-deformed, configuration for a 2×2 MEMS optical switch with direct deformable arm positioning according to an embodiment of the invention;

FIGS. 12B and 12C depict powered bar and cross state configurations for a 2×2 MEMS optical switch with direct deformable arm positioning according to an embodiment of the invention;

FIGS. 13A and 13B depict a deformable optical fiber-waveguide coupling interface according to an embodiment of the invention prior to and after optical fiber-waveguide abutment;

FIGS. 14A and 14B depict a deformable optical fiber-waveguide coupling interface for multiple interfaces according to an embodiment of the invention prior to and after optical fiber-waveguide abutment;

FIG. 14C depicts a deformable optical fiber-waveguide coupling interface according to an embodiment of the invention prior to optical fiber-waveguide abutment;

FIG. 15 depicts an exemplary cross-section of a prior art processed IO-MEMS device;

FIG. 16 depicts exemplary cross-sections of initial starting wafer and processed IO-MEMS device according to an embodiment of the invention for uncompensated mirrorless designs with optional fiber optic attachment;

FIG. 17 depicts exemplary cross-sections of processed IO-MEMS device according to an embodiment of the invention for optical waveguides materials set stress compensated mirrorless designs with optional fiber optic attachment;

FIG. 18 depicts exemplary cross-sections of processed IO-MEMS device according to for optical waveguides materials set stress compensation alternative approaches;

FIG. 19 depicts exemplary cross-sections of initial starting wafer and processed IO-MEMS device according to an embodiment of the invention for cavity based uncompensated designs;

FIG. 20 depicts exemplary cross-sections of initial starting wafer and processed IO-MEMS device according to an embodiment of the invention for cavity based compensated designs with a fiber-optic interface;

FIG. 21 depicts an exemplary cross-section of processed IO-MEMS device according to an embodiment of the invention for cavity based compensated designs with fiber interface;

FIG. 22 depicts exemplary cross-sections of initial starting wafers according an embodiment of the invention exploiting vertically symmetric structures for compensated design;

FIG. 23 depicts exemplary cross-sections of initial starting wafers according an embodiment of the invention exploiting vertically symmetric structures for compensated design formed by combining an SOI structure and a double SOI structure with pre-existing cavity incorporating stress compensation material below the top device layer inside the cavity;

FIG. 24 depicts exemplary cross-sections of processed IO-MEMS device exploiting vertically symmetric structure for compensated design based on use of cavity SOI substrates with two device layers separated by two buried oxide layers without an optional cap;

FIG. 25 depicts exemplary cross-section of processed IO-MEMS device exploiting vertically symmetric structure for compensated design with a fiber optic interface and active semiconductor device integration according to an embodiment of the invention;

FIG. 26 depicts schematics of a 1×1 on/off IO-MEMS optical switch (optical gate) according to an embodiment of the invention in closed and open configurations;

FIG. 27 depicts expanded schematics of the waveguide interfaces at the edges of the moving and non-moving portions of the IO-MEMS optical gate as depicted in FIG. 26 in open and closed configurations;

FIG. 28 depicts expanded schematics of the waveguide interface variants at the edges of the moving and non-moving portions of the IO-MEMS optical gate as depicted in FIG. 26 in open and closed configurations together with an alternate waveguide and MEMS platform configuration;

FIG. 29 depicts a 4 channel wavelength selective IO-MEMS optical receiver according to an embodiment of the invention employing IO-MEMS optical gates upon the outputs of a 4 channel wavelength demultiplexer;

FIG. 30 depicts an expanded view of the 4 channel wavelength selective IO-MEMS optical receiver as depicted in FIG. 29 according to an embodiment of the invention with a single photodetector coupled to the outputs of the IO-MEMS optical gates upon the outputs of the 4 channel wavelength demultiplexer;

FIG. 31 depicts an exemplary process flow according to an embodiment of the invention with nitrogen annealing of the cladding silicon dioxide of a silicon dioxide-silicon nitride-silicon dioxide waveguide structure;

FIG. 32 depicts an exemplary process flow according to an embodiment of the invention with nitrogen annealing of a thin initial silicon dioxide cladding upon the silicon nitride waveguide core during formation of a silicon dioxide-silicon nitride-silicon dioxide waveguide structure;

FIG. 33 depicts an exemplary process flow according to an embodiment of the invention with nitrogen annealing of a thin initial silicon dioxide cladding upon the silicon nitride waveguide core and a second silicon dioxide cladding during formation of a silicon dioxide-silicon nitride-silicon dioxide waveguide structure; and

FIGS. 34A and 34B depict experimental results for a conventional prior art silicon dioxide—silicon nitride-silicon dioxide waveguide structure with a nitrogen annealed silicon dioxide-silicon nitride-silicon dioxide waveguide structure according to the process depicted in FIG. 31.

FIG. 35A depicts an exemplary configuration of a 2×2 Mach-Zehnder interferometer (MZI) according to an embodiment of the invention exploiting a thermo-optic phase shifter (TOPS) according to an embodiment of the invention;

FIGS. 35B and 35C depict designs for the optical waveguides within the reference arm and tuning arm (with thermo-optic phase shifter element) of the 2×2 MZI depicted in FIG. 35A according to embodiments of the invention employing suspended beams;

FIGS. 36A and 36B depict the indicated cross-sections of the thermo-optic phase shifter elements according to embodiments of the invention employing suspended beams depicted in FIGS. 35B and 35C respectively;

FIGS. 37A and 37B depict thermo-optic phase shifter elements according to embodiments of the invention employing suspended beams with anchored linkages to non-suspended portions of the optical device employing the phase shifter elements;

FIGS. 38A and 38B depict thermo-optic phase shifter elements coupled. to an electrothermal MEMS according to embodiments of the invention employing suspended beams employing spring anchored linkages to non-suspended portions of the optical device employing the phase shifter elements;

FIG. 39 depicts a thermo-optic phase shifter element coupled to an electrothermal MEMS according to embodiments of the invention employing a suspended beam with spring and non-spring anchored linkages to non-suspended portions of the optical device employing the phase shifter element;

FIG. 40 depicts a thermo-optic phase shifter element coupled to an electrothermal MEMS according to embodiments of the invention employing a suspended beam with spring anchored linkages to non-suspended portions of the optical device employing the phase shifter element;

FIGS. 41A to 41D depict thermo-optic phase shifter elements coupled to an electrothermal MEMS according to embodiments of the invention employing a suspended beam with spring anchored linkages to non-suspended portions of the optical device employing the phase shifter element;

FIGS. 42A and 42B depict an electrostatic MEMS actuated phase shifter according to an embodiment of the invention in an initial non-deflected state;

FIGS. 43A and 43B depict the electrostatic MEMS actuated phased shifted according to the embodiment of the invention depicted in FIGS. 8A and 8B in a deflected state;

FIGS. 43C and 43D depict the electrostatic MEMS actuated phased shifters according to the embodiment of the invention;

FIG. 44 depicts an electrostatic MEMS actuated phase shifter according to an embodiment of the invention;

FIG. 45 depicts an electrostatic MEMS actuated phase shifter according to an embodiment of the invention;

FIG. 46 depicts a Mach-Zehnder based interferometer/optical switch exploiting an electrostatic MEMS actuated phase shifter according to an embodiment of the invention;

FIG. 47 depicts a Mach-Zehnder based interferometer optical switch exploiting an electrostatic MEMS actuated phase shifter according to an embodiment of the invention;

FIG. 48 depicts a MEMS actuated tunable directional coupler according to an embodiment of the invention;

FIG. 49 depicts a MEMS actuated tunable multimode interferometer according to an embodiment of the invention;

FIG. 50 depicts a MEMS actuated tunable resonator according to an embodiment of the invention;

FIG. 51 depicts a MEMS actuated tunable ring resonator according to an embodiment of the invention;

FIG. 52 depicts a MEMS actuated tunable Bragg grating element according to an embodiment of the invention;

FIG. 53 depicts a MEMS actuated tunable external cavity laser according to an embodiment of the invention;

FIG. 54 depicts a MEMS actuated tunable contra-directional coupler according to an embodiment of the invention;

FIG. 55 depicts an electrostatic MEMS actuated tunable lattice filter according to an embodiment of the invention;

FIG. 56 depicts a depicts a MEMS actuated force/displacement sensor according to an embodiment of the invention;

FIG. 57 depicts a MEMS actuated accelerometer according to an embodiment of the invention;

FIG. 58 depicts an optical photograph and design of a MEMS actuated Mach-Zehnder interferometer according to an embodiment of the invention;

FIG. 59 depicts experimental results for the induced phase shift versus actuator voltage for the MEMS actuated Mach-Zehnder depicted in FIG. 24;

FIG. 60 depicts an electrostatic MEMS actuated dual phase shifter element for a 1×1 Mach-Zehnder interferometer based variable optical attenuator (VOA) according to an embodiment of the invention;

FIGS. 61 to 64 depict MEMS actuated dual phase shifter elements for a 1×1 Mach-Zehnder interferometer based variable optical attenuator (VOA) according to embodiments of the invention;

FIG. 65 depicts a polarization diverse tunable filter exploiting MEMS actuated phase shifter elements within a lattice based switch in conjunction with a grating according to an embodiment of the invention;

FIG. 66 depicts a tunable filter exploiting MEMS actuated phase shifter elements within a lattice based switch in conjunction with a grating according to an embodiment of the invention;

FIG. 67 depicts MEMS actuated phase shifters within an array waveguide grating according to an embodiment of the invention;

FIG. 68 depicts multiple MEMS actuated phase shifter structures within an array waveguide grating according to an embodiment of the invention;

FIG. 69 depicts a thermally actuated suspended beam phase shifter according to an embodiment of the invention to provide athermal operation;

FIG. 70 depicts cascading MEMS actuators to increase deflection to the suspended beam of MEMS phase shifter according to an embodiment of the invention;

FIG. 71 depicts a MEMS actuator based tunable coupler according to an embodiment of the invention;

FIG. 72 depicts a phase shift element according to an embodiment of the invention combining a MEMS actuator with thermo-optic actuator;

FIG. 73 depicts schematics of implemented thermo-optic phase shifters with and without a suspended beam according to an embodiment of the invention;

FIG. 74 depicts schematics of implemented thermo-optic phase shifters with suspended beams according to embodiments of the invention;

FIGS. 75 and 76 depict experimental results for thermo-optic phase shifters with suspended beams according to embodiments of the invention with inset schematics of the structures;

FIG. 77 depicts experimental results and structural schematic for a thermo-optic phase shifter without a suspended beam according to an embodiment of the invention; and

FIGS. 78 and 79 depict experimental results for thermo-optic phase shifters with suspended beams according to embodiments of the invention with inset schematics of the structures.

### DETAILED DESCRIPTION

The present invention is directed to integrated optic MEMS (IO-MEMS) and optical device concepts and more particularly to establishing structures and methods for implementing phase shifting elements, microelectromechanical systems (MEMS) phase shifter elements, MEMS actuated optical devices as well as stress mitigation within MEMS actuated optical devices, optical component packaging, optical coupling and stress compensated component manufacturing.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional elements.

A “two-dimensional” waveguide, also referred to as a 2D waveguide, a slab waveguide or a planar waveguide as used herein may refer to, but is not limited to, an optical waveguide supporting propagation of optical signals within a predetermined wavelength range which does not guide the optical signals laterally relative to the propagation direction of the optical signals.

A “three-dimensional” waveguide, also referred to as a 3D waveguide or a channel waveguide as used herein may refer to, but is not limited to, an optical waveguide supporting propagation of optical signals within a predetermined wavelength range which guides the optical signals laterally relative to the propagation direction of the optical signals.

A “microelectromechanical system” or “microelectromechanical systems” (MEMS) as used herein may refer to, but is not limited to, a miniaturized mechanical, thermo-mechanical and electro-mechanical element which is manufactured using techniques of microfabrication. For example, the MEMS may be implemented in silicon.

A “wavelength division demultiplexer” (WDM DMUX) as used herein may refer to, but is not limited to, an optical device for splitting multiple optical signals of different wavelengths apart which are received on a common optical waveguide, e.g. a waveguide forming part of a photonic integrated circuit or an optical fiber.

A “wavelength division multiplexer” (WDM MUX) as used herein may refer to, but is not limited to, an optical device for combining multiple optical signals of different wavelengths together onto a common optical waveguide, e.g. a waveguide forming part of a photonic integrated circuit or an optical fiber.

A “Mach-Zehnder interferometer” (MZI) as used herein may refer to, but is not limited to, an optical device exploiting phase balance or imbalance between two arms disposed between an input 1×2 or 2×2 3 dB coupler and an output 2×1 or 2×2 3 dB coupler to provide for programmable modulation, attenuation, optical switching or wavelength filtering functions.

A “multimode interference” (MMI) coupler as used herein may refer to, but is not limited to an optical device exploiting the self-imaging principle wherein N-fold images (copies) of the field at an input plane are formed at the output plane after propagation within a multimode waveguide. An MMI coupler can be used as a coupler within a Mach-Zehnder interferometer (MZI), as an optical splitter or combiner with uniform or arbitrary power splitting ratios, as a 90° hybrid for an optical coherent receiver and as a polarization beam splitter/combiner.

Duplex communication over a pair of optical fibers is a common feature of many optical communication networks. For example, these may be what are referred to as “up”/“down” links between two elements of an optical network, e.g. a remote node and a central office, or they may be what are referred to as “east”/“west” links such as between nodes on a ring-based network. Generally, these two optical fibers are routed differently physically, e.g. different optical fiber cables, different geographic routes, etc. so that a fallback fiber, a third fiber, can provide backup in the event that either of the two fibers fails. Co-locating the pair of fibers increases the likelihood that both will fail at the same time and hence both must be backed up. Accordingly, different physical routing is common with the third fiber taking a different physical path to either of the other pair of optical fibers.

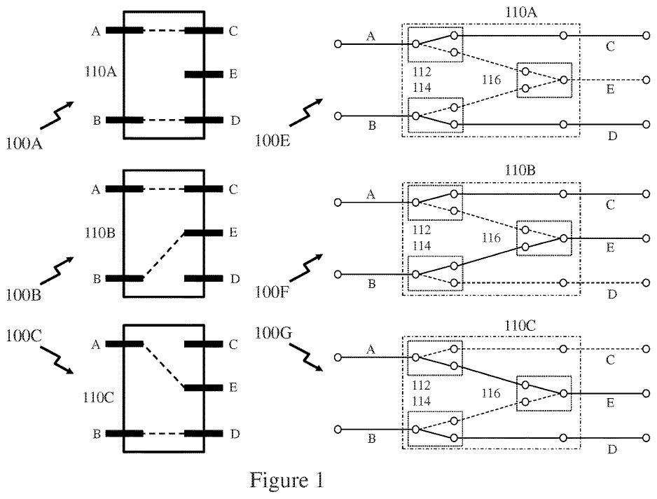

Referring to FIG. 1 there are depicted first to sixth images 100A to 100G respectively with respect to the implementation of a 2×3 optical switch for dual fiber optical link protection using 1×2 switch elements implemented using conventional prior art IO-MEMS 1×2 switch elements. Accordingly, first to third images 100A to 100C depict the block circuit diagram for the three 2×3 switch configurations in “normal” and first and second “fail-over” configurations respectively. Fourth to sixth images 100D to 100F depict the 2×3 optical switch constructed with three 1×2 optical switches 112, 114 and 116. The configuration of each of these three 1×2 switches 112, 114 and 116 within the 2×3 optical switch depicted in the “normal” and first and second “fail-over” configurations respectively in first to third switches 110A to 110C respectively in fourth to sixth images 100D to 100F respectively wherein solid lines represent connections that are “made” or active and dashed lines represent connections are “not made” or inactive in each switch configuration.

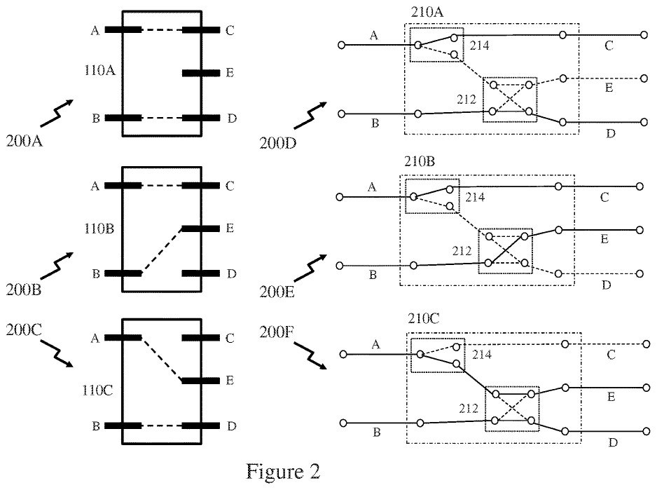

Accordingly, the inventors have established based upon the fact that there is no need to ever connect A to D or B to C that it is possible to redesign the switch to employ a 1×2 and 2×2. Accordingly, referring to FIG. 2 there are depicted first to sixth images 200A to 200F respectively with respect to the implementation of a 2×3 optical switch for dual fiber optical link protection using 1×2 switch elements implemented using conventional prior art 1×2 and 2×2 IO-MEMS switch elements. Accordingly, first to third images 200A to 200C depict the block circuit diagram for the three 2×3 switch configurations such as discussed supra in respect of FIG. 1. Fourth to sixth images 200D to 200F depict the 2×3 optical switch constructed with 1×2 optical switch 214 and 2×2 optical switch 212. The configuration of these switches within the 2×3 optical switch being depicted by first to third switches 210A to 210C respectively in fourth to sixth images 200D to 200F respectively wherein solid lines represent connections that are “made”, or active and dashed lines represent connections are “not made” or inactive.

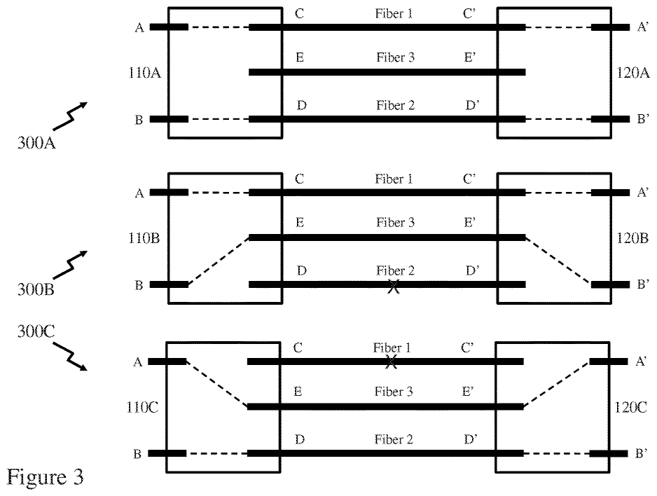

Now referring to FIG. 3 there are depicted first to third image 300A to 300C respectively depicting the normal and “fail-over” protection modes for a dual fiber optical communications link protected by a third optical fiber, exploiting a pair of identical 2×3 optical switches on both ends of the optical link comprising first and second fibers Fiber 1 and Fiber 2 respectively together with the protection “fail-over” optical fiber, Fiber 3. In first image 300A the normal operation of the link is depicted showing the first optical switch in state 110A and second optical switch in state 120A wherein traffic is carried from port A to port A′ (or vice-versa) by Fiber 1 and second traffic is carried from port B to port B′ (or vice-versa) by Fiber 2. First states 110A and 120A are a common switch state for the pair of 2×3 optical switches. Subsequently, upon traffic upon Fiber 2 being disrupted a reconfiguration of the two optical switches re-routes the second traffic on Fiber 2 to Fiber 3. This is depicted in second image 300B wherein the first optical switch is now in state 110B whilst the second optical switch is in state 120B, these states 110B and 120B being another common state of the pair of 2×3 optical switches. Accordingly, should traffic be disrupted on Fiber 2, then the traffic would be switched onto Fiber 3. Accordingly, on the first switch the traffic to/from ports A and B are routed from/to ports C and E respectively whereas on the second switch the traffic to/from ports C′ and E′ are routed from/to ports A′ and B′ respectively. Alternatively, in an alternate fail-over the traffic on Fiber 1 is disrupted and reconfiguration of the two optical switches would be configured together to switch the traffic from Fiber 1 onto Fiber 3.

This being depicted in third image 300C wherein the first optical switch is now in state 110C whilst the second optical switch is in state 120C, these states 110C and 120C being another common state of the pair of 2×3 optical switches. Accordingly, with traffic disrupted on Fiber 1 the traffic is routed to Fiber 3 which is implemented on the first switch such that the traffic to/from ports A and B are routed from/to ports E and D respectively whereas on the second switch the traffic to/from ports E′ and D′ are routed from/to ports A′ and B′ respectively. These configurations being listed in Tables 1 to 3 respectively below.

TABLE 1
Normal Mode

| | |
|---|---|
| Left Switch | Right Switch |

| Input Port | Connected To | Output Port | Connected To |
|---|---|---|---|
| A | C | A′ | C′ |
| B | D | B′ | D′ |

TABLE 2
Protection for Fiber 2 Failure

| | |
|---|---|
| Left Switch | Right Switch |

| Input Port | Connected To | Output Port | Connected To |
|---|---|---|---|
| A | C | A′ | C′ |
| B | E | B′ | E′ |

TABLE 3
Protection for Fiber 1 Failure

| | |
|---|---|
| Left Switch | Right Switch |

| Input Port | Connected To | Output Port | Connected To |
|---|---|---|---|
| A | E | A′ | E′ |
| B | D | B′ | D′ |

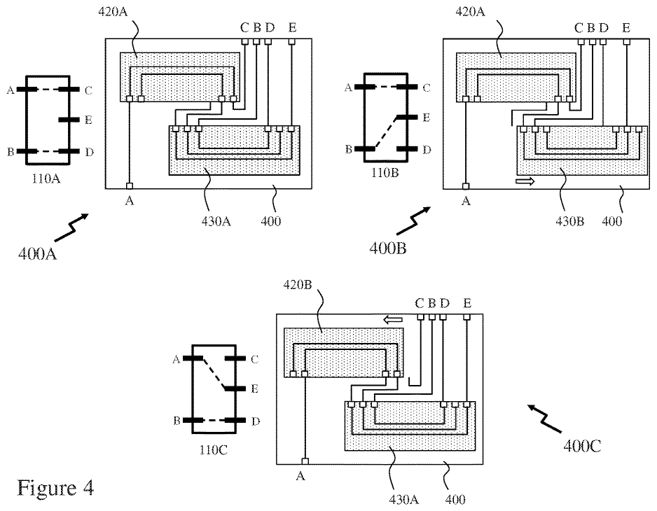

Referring back to FIG. 2 and the 2×2 optical switch 212 within fourth to sixth images 200D to 200F respectively for the “normal” operating mode and the two “fail-over conditions” then it is evident that whilst it is configured in both of, what are commonly referred to as, the “bar state” and “cross state” configurations but that there is no requirement for both “cross” paths to be employed in any configuration. Accordingly, the inventors have established that an IO-MEMS based design where the first IO-MEMS is used only as a 1×2 switch element and the second IO-MEMS 212 is only used for the functionality of “simple” crossbar switch element rather than a full 2×2 doesn't need can be implemented with a second IO-MEMS 212 in the form of a crossbar rather than a 2×2. Accordingly, referring to FIG. 4 there is depicted according to an embodiment of the invention an implementation of a 2×3 optical switch for dual fiber optical link protection implemented using an IO-MEMS based “horseshoe” configuration optical switch according to an embodiment of the invention. The inventors refer to the IO-MEMS design as a “horseshoe” as each optical path within the IO-MEMS elements loops back, as does a horseshoe, wherein the horseshoe can either implement 1×2 or crossbar functionality.

Accordingly, FIG. 4 depicts the internal implementation of a 2×3 optical switch “horseshoe” IO-MEMS (2×3 HS-IO-MEMS) circuit 400 for dual fiber optical link protection via a third optical fiber, wherein the 2×3 optical switch circuit 400 is composed of two IO-MEMS elements, a first IO-MEMS element 420A providing the 1×2 switch functionality, equivalent to 1×2 switch 214 in fourth to sixth images 200D to 200F respectively in FIG. 2, and a second IO-MEMS element 430B providing the required functionality of the crossbar switch, thus allowing the circuit 400 to replace the 2×2 switch 212 in fourth to sixth images 200D to 200F respectively in FIG. 2. Accordingly, these are depicted in first to third images 400A to 400C in FIG. 4 for the “normal” state 110A and the two protected states 110B and 110C respectively. In first image 400A the first and second IO-MEMS elements are depicted as first IO-MEMS 420A and second IO-MEMS 430A which represent the first and second IO-MEMS elements in non-actuated state. In second image 400B the first IO-MEMS element is still in its non-actuated state, depicted as first IO-MEMS 420A, whilst the second IO-MEMS element is in an actuated state, depicted as third IO-MEMS 430B. In third image 400C the first IO-MEMS element is now in its actuated state, depicted as fourth IO-MEMS 420B whilst second IO-MEMS element is in its non-actuated state 430A. Accordingly, as evident in first to third images 400A to 400C respectively there are no waveguide crossings within the 2×3 switch optical switch circuit 400 which arises from the limited active optical path configurations of the crossbar optical switches 430A and 420B.

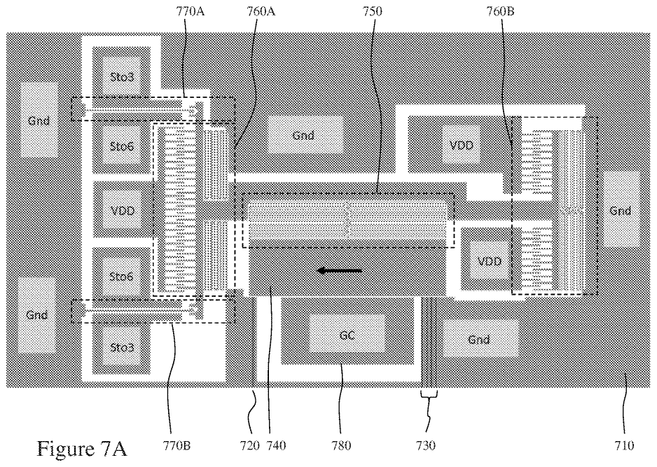

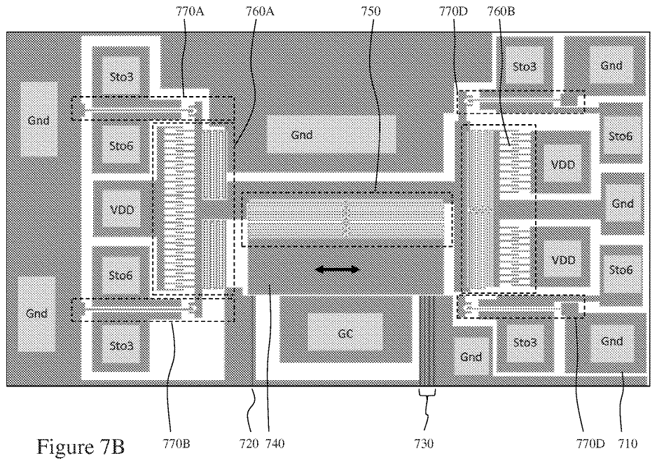

Accordingly, within first to third images 400A to 400C of the 2×3 HS-IO-MEMS in the three switch configurations. First image 400A depicts the 2×3 HS-IO-MEMS in the normal configuration with ports A and B coupled to ports C and D respectively and Fiber 1/Fiber 2 active. Accordingly, the 2×3 HS-IO-MEMS comprises a substrate with a plurality of three-dimensional (3D) optical waveguides from ports denoted A, B, C, D, and E which are coupled to the first and second IO-MEMS elements which are themselves interconnected via appropriate waveguide routing while exploiting 3D optical waveguides. Within this embodiment the waveguides exploit 90 degree turning mirrors rather than waveguide bends, but such 3D waveguides could exploit waveguide bends. Further, such waveguides could be routed and/or implemented at any arbitrary angle at the interface between the fixed and suspended portions of the IO-MEMS as will be further explained later in FIG. 7. In second image 400B the first IO-MEMS element is maintained in the same configuration, but the second IO-MEMS element has been moved right one “stop” such that the second IO-MEMS element is coupled to a different subset of the plurality of 3D optical waveguides on the substrate such that the 2×3 HS-IO-MEMS provides the appropriate routing of port A to port C and port B to port E.

In third image 400C the first IO-MEMS element has now been moved left one “stop” but second IO-MEMS element 420A is in its original configuration as in first image 400A. Accordingly, the first IO-MEMS element is coupled to a different subset of the plurality of 3D optical waveguides on the substrate such that the 2×3 HS-IO-MEMS provides the appropriate routing of port A to port E and port B to port D. Accordingly, the 2×3 HS-IO-MEMS is configured solely based upon lateral motion of the first and second IO-MEMS elements.

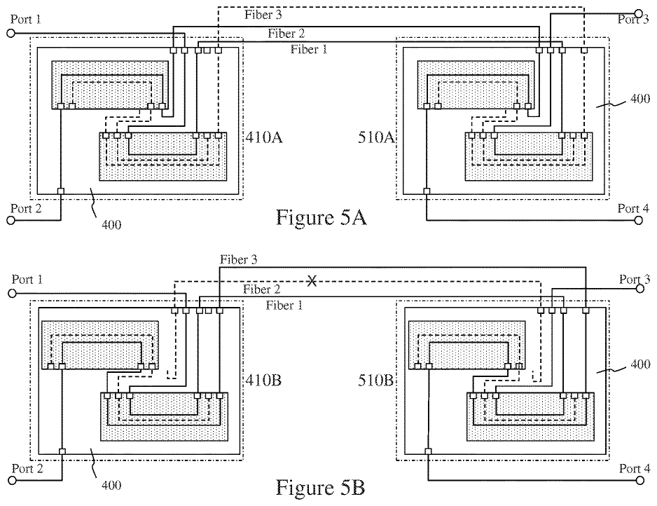

Now referring to FIGS. 5A to 5C respectively there are depicted the normal mode and the two “fail-over” protection modes for a dual fiber optical communications link protected by a third optical fiber, exploiting identical 2×3 HS-IO-MEMS 400 on both ends of the link sharing a common state in each mode of operation. Considering FIG. 5A for the normal operation of the link (state 410A for the left switch and state 510A for the right switch) each 2×3 HS-IO-MEMS is configured as depicted in first image 400A of FIG. 4, i.e. each IO-MEMS element is non-actuated. Accordingly, the optical signals from Ports 1 and 2 are routed to/from Ports 3 and 4 via Fiber 1 and Fiber 2.

In FIG. 5B a first fail-over mode is depicted wherein each 2×3 HS-IO-MEMS is configured as depicted in second image 400B of FIG. 4, i.e. the first IO-MEMS element has been actuated whilst the second IO-MEMS element is non-actuated. Accordingly, the optical signals from Ports 1 and 2 are routed to/from Ports 3 and 4 via Fiber 1 and Fiber 3 respectively. In FIG. 5C a second fail-over mode is depicted wherein each 2×3 HS-IO-MEMS is configured as depicted in second image 400C of FIG. 4, i.e. the first IO-MEMS element is non-actuated whilst the second IO-MEMS element is actuated. Accordingly, the optical signals from Ports 1 and 2 are routed to/from Ports 3 and 4 via Fiber 2 and Fiber 3 respectively.

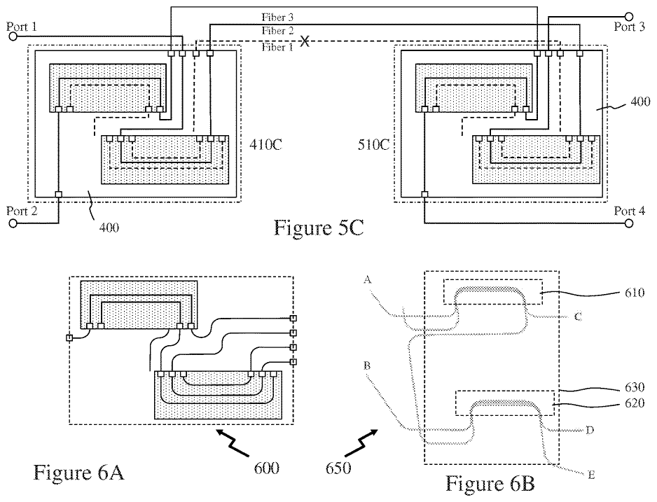

Referring to FIGS. 6A and 6B there are depicted first and second alternate configurations 600 and 650 for a 2×3 HS-IO-MEMS optical switch according to an embodiment of the invention exploiting waveguide bends rather than turning mirrors. The exact design of the waveguide bends may vary in dependence upon factors such as geometrical constraints and waveguide index contrast. Waveguide index contrast of the 3D optical waveguides can vary from low contrast (low confinement), such as SiO2-Si3N4-SiO2, to higher contrast (higher confinement) stemming from use of a rectangular waveguide core or further through high index contrast materials selection such Si core with SiO2 cladding (typical of conventional silicon photonics platforms). As index contrast and confinement increase, tighter lower radius bends can be employed within the 3D optical waveguides. Within first image 600 the IO-MEMS elements are configured in common with those depicted in FIGS. 4 and 5. However, in second image 650 the first and second IO-MEMS elements 610 and 620 are oriented vertically in the same orientation upon a substrate 610 and similarly exploit waveguide bends rather than turning mirrors such as depicted in FIG. 4. Finally, such waveguides could be routed implemented at any arbitrary angle at the interface between the fixed and suspended portions of the IO-MEMS as will be further explained later in FIG. 7.

Referring to FIG. 6B, there is depicted a waveguide routing arrangement between two instances of the HS-IO-MEMS enabling the routing of the optical switch in a manner which allows the duplication of this arrangement in a large M×N array enabling the use of the HS-IO-MEMS in a larger scale matrix optical switch may further conform to a path independent loss topology by placing waveguide crossings between HS-IO-MEMS instances.

Now referring to FIG. 7 there is depicted an exemplary die layout for a 1×4 optical switch exploiting a HS-IO-MEMS optical switch according to an embodiment of the invention. Accordingly, as the HS-IO-MEMS comprises:
Substrate 710;
Input waveguide 720;
Output waveguides 730;
   Shuttle 740, upon which the waveguide layout to connect the input waveguide to each output of the output waveguides 740 when it moves laterally and/or vertically, wherein the waveguides on the Shuttle 740 have been omitted for clarity and can be routed and/or implemented at any arbitrary angle to match the angles of the Input waveguides 720 and Output waveguides 730, enabling for instance the reduction of the waveguide bend on the shuttle 740;
Gap closer MEMS spring 750 to move the shuttle 740 away from the waveguides during reconfiguration and towards the waveguides after reconfiguration is complete, this being under electrostatic action from gap closer 780;
First and second lateral MEMS actuators 760A and 760B to move the shuttle laterally under electrostatic action; and
First and second stop actuators 770A and 770B which define the limit of lateral motion for the different configurations, under electrostatic action

As depicted the 1×4 HS-IO-MEMS has a series of pads for application of the appropriate electrical voltages to provide the target electrostatic action, these being, in addition to ground (GND):
VDD directional displacement voltage;
GC gap closer voltage;
STO3 3 μm stopper actuation; and
STO6 6 μm stopper actuation.

Accordingly, if STO3 is applied the first and second stop actuators 770A and 770B allow a lateral motion of 3 μm from the initial displacement position of the shuttle 740 when VDD=0V. If STO6 is applied the first and second stop actuators 770A and 770B allow a lateral motion of 6 μm from the initial displacement position of the shuttle 740 when VDD-0V. If neither STO3 or STO6 are applied the first and second stop actuators 770A and 770B allow a lateral motion of 9 μm from the initial displacement position of the shuttle 740 when VDD=0V. The shuttle 740 motion being unidirectional to the left from its initial position.

However, in FIG. 7B a variant 1×4 HS-IO-MEMS is depicted wherein bidirectional motion of the shuttle 740 is provided as the second lateral MEMS actuator 760B is “reversed” relative to the first lateral MEMS actuator 760A such that application of a VDD signal to the associated with second lateral MEMS actuator 760B rather than those associated with first lateral MEMS actuator 760A results in motion in the other direction. Also associated with the reversal of the second MEMS actuator 760B are third and fourth stop actuators 770C and 770D respectively which provide stops for motion of the shuttle in the other direction at the same motion limits (although different motion limits may be established for left and right motion if appropriate.

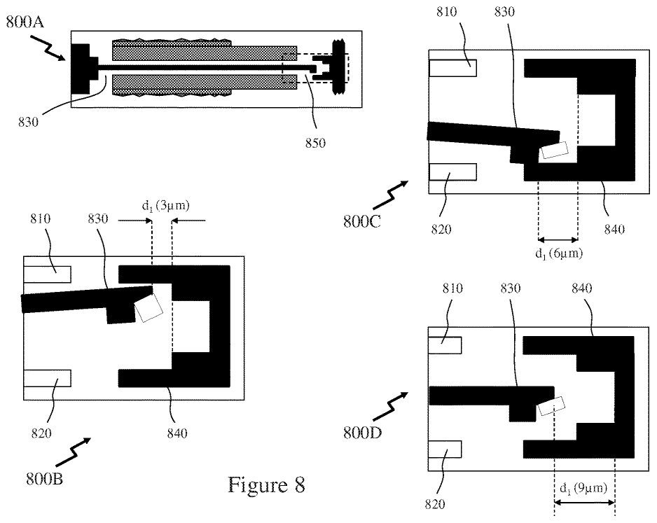

Referring to FIG. 8 there is depicted an exemplary design for a programmable switch state stopper for a MEMS based device such as first and second stop actuators 770 and 770B respectively in FIG. 7A and first to fourth stop actuators 770A to 770D respectively in FIG. 7B. First image 800A depicts the stop actuator with its tip 850 and beam 830. Second to fourth images 800B to 800D respectively depict the stop actuator when actuated for 3 μm and 6 μm motion and unactuated for 9 μm using the configuration described and depicted within FIGS. 7A and 7B respectively. In each there are depicted first and second side electrodes 810 and 820 which are depicted in first image 800A running along the length of the beam 830, beam 830 with shaped tip, and stop contact 840 which as depicted in FIGS. 7A and 7B is connected to ground. First side electrode 810 being coupled to STO3 such that when the actuation voltage is applied to the STO3 pad the beam 830 is attracted electrostatically to the first side electrode 810. Second side electrode 820 is coupled to STO6 such that when the actuation voltage is applied to the STO6 pad, the beam 830 is attracted electrostatically to the second side electrode 820. When no voltage is applied to either first side electrode 810 and second side electrode 820 then the beam is in the middle and not attracted to either.

Accordingly, depending upon whether the beam is in the middle or attracted up/down then a different portion of the beam 830 at its tip will contact the stop contact 840 as the shuttle 740 is moved laterally. Whilst discrete electrostatic actuation with two electrodes is depicted in FIGS. 7A to 8 respectively it would be evident that within other embodiments of the invention that the number of stops may be increased by increasing the number of steps in the stop actuator tip and/or stop contact in conjunction with multiple actuator voltages or that multiple actuators may be employed each offering, for example a first stop with actuation of the upper electrode, a second stop with actuation of the lower electrode and unrestricted motion with neither actuated. Alternatively, multiple stop actuators along a single common beam may be employed, which are individually actuated. Optionally, rather than discrete “on/off” actuators such as those depicted in FIGS. 7A to 8 a tunable actuator, e.g. an electrostatic linear comb drive for example, may be employed wherein tolerance on the voltage to the comb drive for each stop is provided through the overlap between the actuator elements. For example, considering second image 800B in FIG. 8 then once a predetermined voltage is exceeded the beam 830 engages the stop contact 840 and increasing the voltage whilst further pulling the beam 830 does not adjust the action of the stop actuator.

Within the embodiments of the invention described and depicted in respect of FIGS. 4 to 8 the optical waveguides are non-overlapping and each couple a first port of a plurality of ports on one side of the shuttle to a second port of the plurality of ports on the same side of the shuttle. However, within other embodiments of the invention the optical waveguides in order to provide the required optical functionality may overlap (i.e. cross one another) or they may route to the other side of the shuttle distal to the side they originate on (or vice-versa terminate on). Accordingly, different programmable optical interconnects may be implemented. It would be further evident that whilst the embodiments of the invention described and depicted in respect of FIGS. 4 to 8 exploit a pair of shuttles, other designs, such as a simple optical 1×N switch, may exploit a single shuttle whilst others may exploit 3, 4, or more with different interconnections (mappings) between the multiple shuttles.

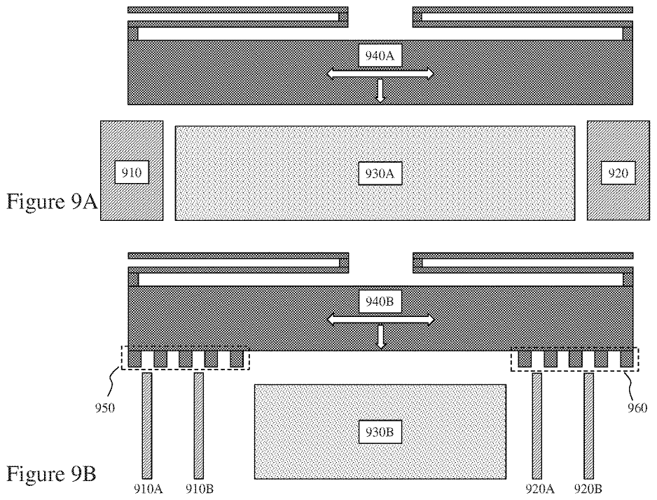

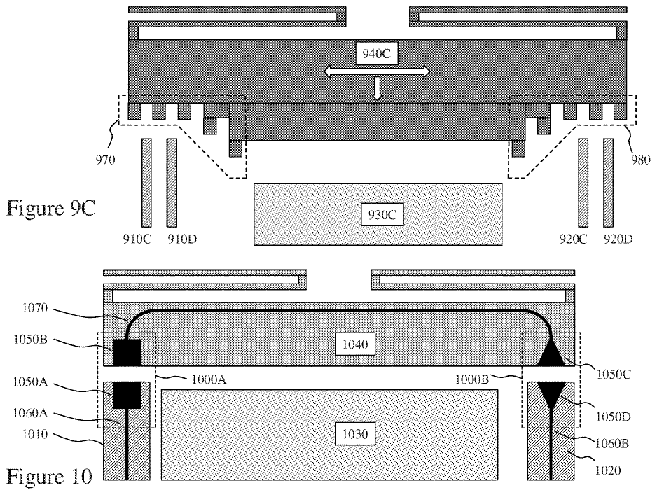

FIGS. 7A to 8 describe and depict stops for lateral motion of the shuttle 740 during its movement. Now referring to FIGS. 9A to 9C there are depicted exemplary designs for stoppers for defining the gap under closure of the gap closers within MEMS based optical switches according to an embodiment of the invention. FIG. 9A depicts the configuration shown in FIGS. 7A and 7B wherein the shuttle under action of the gap closer 780 moves either towards the gap closer 780 when electrostatic attraction exists or is pulled back under action of the gap closer MEMS spring 750. Accordingly, the waveguides are formed onto the stoppers at either side, Stopper 1 910 and Stopper 2 920 whilst the Shuttle 940A is moved towards these under electrostatic attraction arising from the Gap Closer 930A. In order that the Stopper 1 910 and Stopper 2 920 define the limit of the Shuttle 940A under action of the Gap Closer 930A the Gap Closer 930A is “recessed” away such that it cannot contact the Shuttle 940A.

Alternatively, in FIG. 9B an alternate design is employed wherein first and second pairs of stoppers 910A/910B and 920A/920B are depicted and engage against stops 950 upon the shuttle 940B with the Gap Closer 930B recessed again. Whilst the first and second pairs of stoppers 910A/910B and 920A/920B and stops 950 are depicted as square in FIG. 9B it would be evident that within other embodiments of the invention the designs for these may vary to include other geometries. Optionally, within another embodiment of the invention the stops and stoppers may be tapered such that the shuttle 940B is aligned to the stops in a form of “self-aligning” so that as the gap closer closes the gap the shuttle 940B engages the stoppers and “aligns” via the stops 950. Optionally, within other embodiments of the invention the stoppers may be movable rather than fixed using actuators such as, for example, parallel plate actuators, comb drive actuators etc. Optionally, multiple stoppers may be moved together or independently from one another. As the stoppers will, typically, have the optical waveguides upon them to butt couple to optical waveguides upon the shuttle 940B then within other embodiments of the invention the stoppers may be movable, and the shuttle fixed, or both the stoppers and the shuttle may be movable.

Within FIG. 9C an alternate design is depicted wherein first and second pairs of stoppers 910C/910D and 920C/920D are depicted together with first and second stops 970 and 980 which now are at varying offsets from the gap closer 930C. Accordingly, the stops define different stop positions for the shuttle 940C when it moves laterally with respect to the stops. Whilst the stops are depicted parallel to the stoppers in FIG. 9C within other embodiments of the invention one or more of the stoppers may be orientated at an angle relative to the motion of the shuttle 940C with laterally under action of the first and second lateral MEMS actuators 760A and 760B respectively or relative to the motion of the shuttle 940C under the action of the gap closer 930B. Optionally, within another embodiment of the invention the stops and stoppers may be tapered such that the shuttle 940C is aligned to the stops in a form of “self-aligning” so that as the gap closer closes the gap the shuttle 940C engages the stoppers and “aligns” via the stops 970. Optionally, within other embodiments of the invention the stoppers may be movable rather than fixed using actuators such as, for example, parallel plate actuators, comb drive actuators etc. Optionally, multiple stoppers may be moved together or independently from one another. As the stoppers will, typically, have the optical waveguides upon them to butt couple to optical waveguides upon the shuttle 940B then within other embodiments of the invention the stoppers may be movable, and the shuttle fixed, or both the stoppers and the shuttle may be movable.

Within the embodiments of the invention described and depicted with respect to FIGS. 4A to 9C the 3D optical waveguides on the fixed portion of the IO-MEMS “butt-couple” to the 3D optical waveguides on the moving portion of the IO-MEMS. Butt-coupling being where the two optical waveguides “butt” against each other although the term is also used to refer to optical coupling between two optical waveguides with a small gap between them. Within embodiments of the invention the stoppers may define a predetermined gap or no gap to be between the 3D optical waveguides when the gap closer brings the moving portion of the IO-MEMS to the fixed portion of the IO-MEMS. Optionally, the 3D optical waveguides may exploit optical tapers or multi-mode interferometers (MMIs) to expand the optical mode size at the interfaces thereby improving coupling tolerances and/or reducing coupling losses. Optionally, the waveguides may exploit micro-lenses fused onto or formed from the end faces of the 3D optical waveguides through a process such as a laser-based process, for example.

Referring to FIG. 10 there are depicted exemplary optical interfaces between a static portion of an IO-MEMS circuit and the moveable MEMS element forming part of the IO-MEMS circuit. As depicted a movable MEMS element 1040 has a 3D optical waveguide 1070 disposed upon it which is coupled to first and second optical waveguides 1060A and 1060B respectively upon first and second static elements 1010 and 1020 of the IO-MEMS circuit. First optical interface 1000A couples the first optical waveguide 1060A upon first static element 1010 to the 3D optical waveguide 1070 via an MMI coupler comprising first and second portions 1050A and 1050B wherein when these abut each other under action of the MEMS actuator closing the gap between the first and second static elements 1010 and 1020 with movable MEMS element 1040 they form the MMI such that optical signals are coupled to/from the 3D optical waveguide 1070 from/to the optical waveguide 1060A. In contrast in second optical interface 1000B the second optical waveguide 1060B is coupled to the 3D optical waveguide 1070 via first and second optical waveguide tapers 1050C and 1050D respectively.

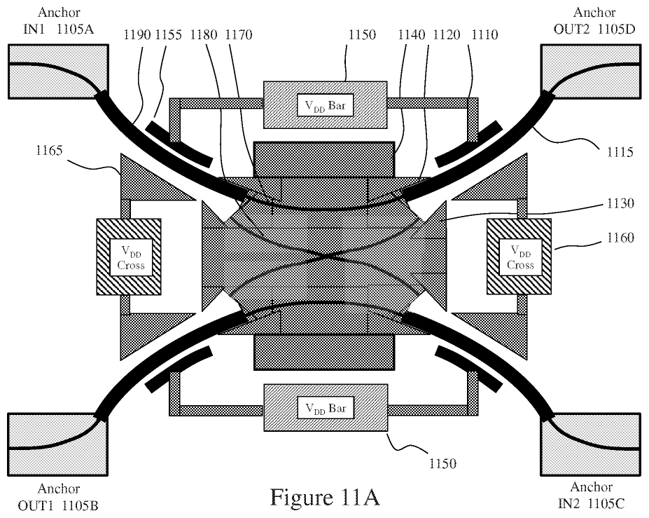

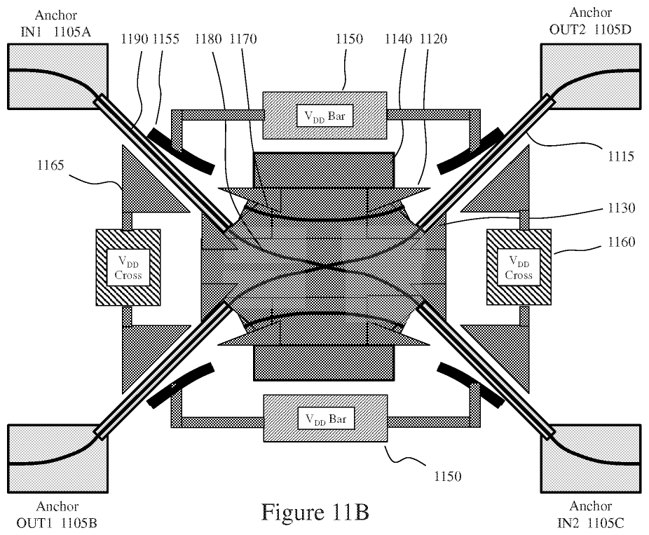

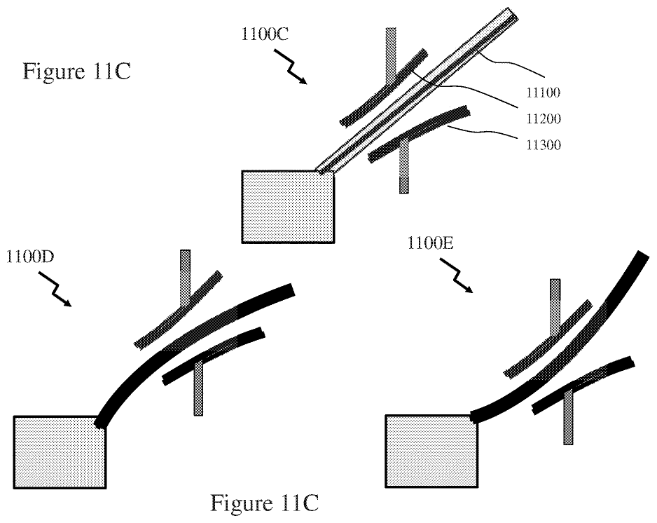

Within the embodiments of the invention described and depicted in respect of FIGS. 4A to 10 IO-MEMS devices supporting reconfiguration of the optical connectivity have been described exploiting fixed portions and a movable portion wherein the movable portion has 3D optical waveguides upon it such that the motion of the movable portion relative to the fixed positions results in the connectivity changes. However, within other embodiments of the invention the moving portion of the IO-MEMS is a flexible waveguide which moves from a first position to a second position such that it couples to different 3D optical waveguides upon another fixed portion of the IO-MEMS. An exemplary embodiment of the invention is described and depicted in FIGS. 11A and 11B with respect to a 2×2 IO-MEMS switch.

Accordingly, referring to FIG. 11A there is depicted a 2×2 IO-MEMS switch according to an embodiment of the invention in a bar state exploiting what the inventors refer to as Thin Beam Unsupported Waveguide (THAW) IO-MEMS actuators. Accordingly, four anchors are depicted: IN1 1105A, OUT1 1105B, IN2 1105C, and OUT2 1105D. Each of these extends with a MEMS beam 1115 which is coupled to a MEMS actuator 1110 and supports a 3D optical waveguide 1190. Disposed centrally to the four anchors is a fixed portion 1140 of the IO-MEMS comprising a pair of bar waveguides 1170 and a pair of cross waveguides 1180. At each corner of the fixed portion 1140 of the IO-MEMS are first and second stops 1120 and 1130 together with bar electrode 1155 and cross electrode 1165. The bar electrodes 1155 are connected to the electrode pads VDD Bar 1150 and the cross electrodes 1165 are connected to the electrode pads VDD Cross 1160. As depicted in FIG. 11A drive voltages are applied to electrode pads VDD Bar 1150 such that the MEMS beams 1115 are electrostatically attracted to the bar electrodes 1155 and against first stops 1120 such that the 3D optical waveguides 1190 are coupled to the bar waveguides 1170. In FIG. 11B the drive voltages are applied to the electrode pads VDD Cross 1160 such that the MEMS beams 1115 are electrostatically attracted to the cross electrodes 1165 and against second stops 1130 such that the 3D optical waveguides 1190 are coupled to the cross waveguides 1180.

Alternatively, FIG. 11C depicts actuator configurations for a 2×2 IO-MEMS optical switch according to an embodiment of the invention with “blocked” power fail state (or default MEMS state) and driven “cross” and “bar” states. In this configuration the initial or non-actuated position for the THAW IO-MEMS actuators with a 3D optical waveguide. Accordingly, first to third images 1100C to 1100E depict a MEMS beam 11100 with optical waveguide, first electrode 11200 and second electrode 11300. In first image 1100C no voltage is applied to either the first electrode 11200 or the second electrode 11200 such that the MEMS beam 11100 is not deformed. In second image 1100D the drive voltage is applied to the second electrode 11300 such that the MEMS beam 11100 is deformed by electrostatic attraction to the second electrode 11300. In third image 1100E the drive voltage is applied to the first electrode 11200 such that the MEMS beam 11100 is deformed by electrostatic attraction to the first electrode 11200. Accordingly, where this actuation scheme is employed with a 2×2 IO-MEMS the first image 1100C represents no optical coupling between the optical waveguide on the MEMS beam 11100 to any waveguides of the IO-MEMS. In contrast in second and third images 1100D and 1100E the optical waveguide on the MEMS beam 11100 to waveguides of the IO-MEMS, such as bar waveguides 1170 and cross waveguides 1180 as depicted in FIGS. 11A and 11B respectively.

It would be evident that within other embodiments of the invention that the initial THAW IO-MEMS actuator position and hence that also the power fail state may be in a defined switch state or coupling condition for the THAW IO-MEMS actuator. Considering FIGS. 11A and 11B then the cross state condition of the switch may be established if the THAW IO-MEMS actuator is aligned to the cross waveguide 1180 without any applied voltage, e.g. VDD Cross=0V. Accordingly, the switch only requires activation for implementing the bar state. Alternatively, the THAW IO-MEMS actuator may be initially fabricated to align with the bar waveguide 1170 such that activation is only required for the cross state. It would be evident that in other embodiments of the invention different configurations of THAW IO-MEMS actuator may be employed such that, for example, the THAW IO-MEMS actuators associated with IN1 1105A and IN2 1105C are aligned in one position with respect to bar and cross waveguides 1170 and 1180 respectively whilst the OUT1 1105B and OUT2 1105D THAW IO-MEMS actuators are aligned to a different position.

It would be evident that different optical devices may be implemented using the THAW IO-MEMS actuators in conjunction with or without mechanical stops. Optical devices may also exploit different numbers and combinations of THAW IO-MEMS actuators. Further THAW IO-MEMS actuators within the same optical device may provide different “functions” in combination with the optical waveguides to which they couple such as attenuator, on-off switch, and route selector with 2, 3, 4 or more routes for example. Whilst electrostatic actuation for low complexity THAW IO-MEMS actuators has been described and depicted it would be evident that other actuation means may be employed for the THAW IO-MEMS actuators such as thermal actuation, rotational electrostatic comb drive and rotational electrostatic comb drive, and circular electrostatic comb drive for example.

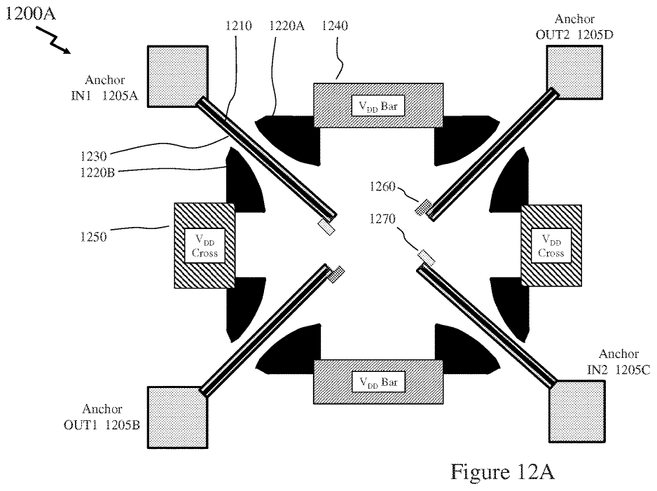

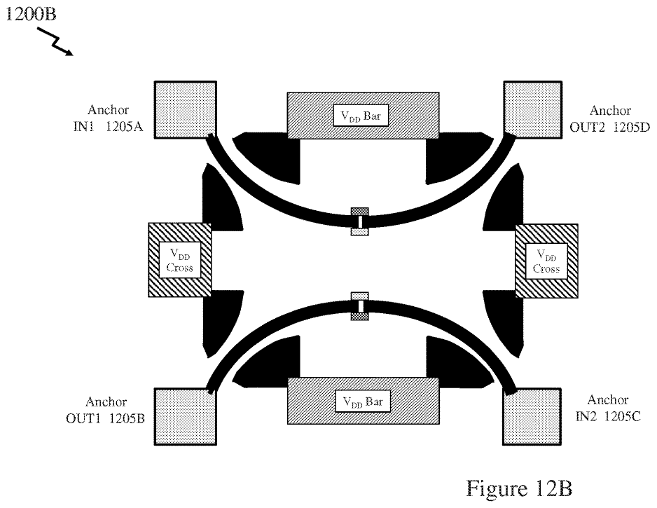

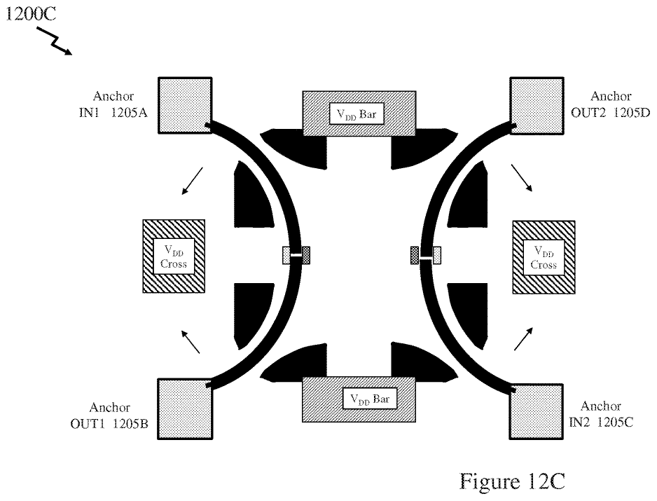

Now referring to FIG. 12A there is depict an unpowered, non-deformed, configuration for a 2×2 MEMS optical switch exploiting THAW IO-MEMS actuators with direct deformable arm positioning according to an embodiment of the invention without intermediate 3D optical waveguides that are fixed. Accordingly, are depicted four anchors, IN1 1205A, OUT1 1205B, IN2 1205C, and OUT2 1205D. Each of these extends with a MEMS beam 1230 which is coupled to a MEMS actuator 1220 and supports a 3D optical waveguide 1210. At the ends of each beam 1230 coupled to the IN1 1205A and IN2 1205C anchors there is a first stop 1260 disposed whilst at the ends of each beam 1230 coupled to the OUT1 1205B and OUT2 1205D anchors there is disposed a second stop 1270. Disposed to either side of each MEMS beam 1230 are bar electrode 1220A and cross electrode 1220B which are coupled to bar electrode pads 1240 and cross electrode pads 1250 respectively. Accordingly, as depicted in FIG. 12B the appropriate drive voltage, VDD Bar, is applied to the bar electrode pads 1240 wherein the MEMS beam 1230 is electrostatically attracted to the bar electrode 1220A in each instance. As the MEMS beams 1230 flex then the tips orientate with respect to each other through the first stop 1260 and second stop 1270. Similarly, in FIG. 12C the appropriate drive voltage, VDD Cross, is applied to the bar electrode pads 1250 wherein the MEMS beam 1230 is electrostatically attracted to the cross electrode 1220B in each instance. As the MEMS beams 1230 flex then the tips orientate with respect to each other through the first stop 1260 and second stop 1270.

Optionally, within other embodiments of the invention the MEMS beams 1230 may be electrostatically charged rather than the bar electrodes 1220A or cross electrodes 1220B. Alternatively, the bar electrodes 1220A and cross electrodes 1220B may be oppositely charged relative to the MEMS beam 1230 to attract or similarly charged to repulse. Optionally, within other embodiments of the invention the MEMS arms 1230 may be directly, i.e. physically, moved through an actuator directly rather than indirectly moved via an attraction/repulsion mechanism. Such direct actuation may, for example, exploit one or more parallel plate MEMS actuators, one or more MEMS comb drive actuators, one or more MEMS circular comb drive actuators, etc.

Amongst the challenges of packaging optoelectronic circuits, photonic circuits, integrated optical circuits, IO-MEMS, etc., referred to generally as photonic integrated circuits (PICs), is the positioning of the optical fiber(s) being coupled to the PIC. This is problematic even with a single optical fiber (fiber) but even more complex where multiple optical fibers (fibers) are to be connected to the PIC, especially on the same side of the PIC die as generally optical fibers require a pitch (spacing) at the die edge that is larger than the pitch of the 3D optical waveguides on the PIC die. Within the prior art to remove handling issues of multiple fibers ribbon optical fibers were developed to provide, for example, 4, 6, 8, or 12 fibers within a single ribbon. Whilst this improves handling of multiple fibers the preparation of the fibers for optical coupling to the PIC raises an additional issue in that in order to provide the multiple fibers with a common end plane for mating to the PIC the ribbon is typically assembled into another assembly and the end polished, such as employed in ribbon fiber connectors. However, amongst the techniques for aligning optical fibers to a PIC is the use of U-shaped grooves (U-grooves) or V-shaped grooves (V-groove) formed into a substrate, this substrate may be the PIC substrate itself within or upon which the PIC is formed upon or it may be another substrate to which substrate the PIC is formed upon is attached to. However, these preclude the use of polished fiber assemblies unless the fibers can be polished and project beyond the end of the assembly they are assembled within. However, cleaving (providing a high-quality end face through inducing a crack in the optical fiber which is then propagated through the fiber) a ribbon fiber results in a variation in the end positions of each fiber within the ribbon.

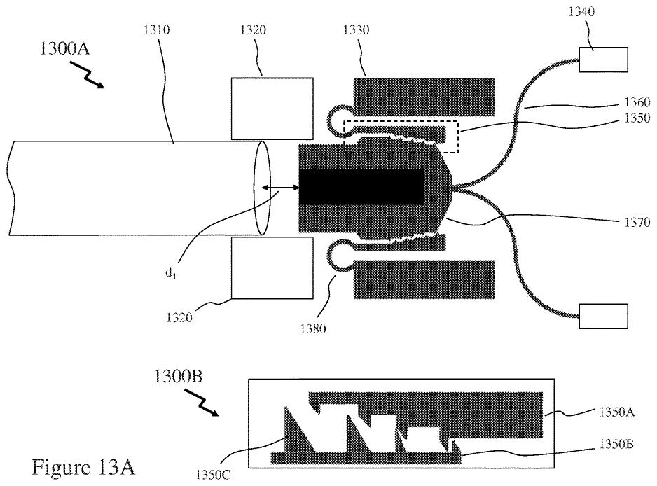

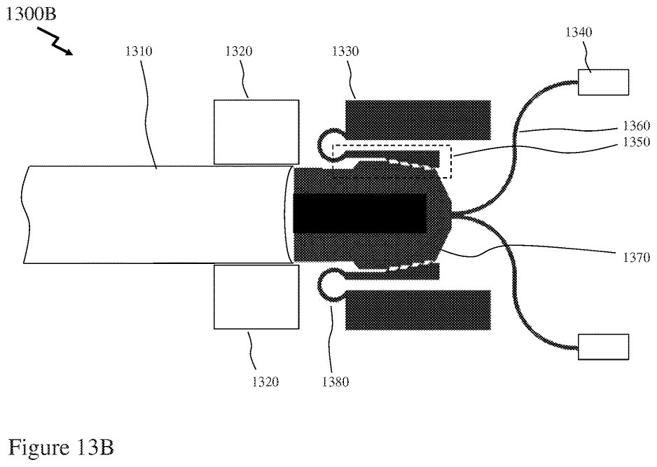

Accordingly, the inventors have established a PIC design approach that allows the PIC to accommodate the length variation within the cleaved fiber ribbon. Accordingly, as depicted in FIG. 13A in first image 1300A the concept, referred to as flexible edge connect (FLEC) by the inventors, comprises a suspended platform 1370 which abuts the end face of the optical fiber 1310 when the fiber is inserted into a U-groove or V-groove which is depicted simply by edge features 1320 (these being patterned portions of the PIC layer stack deposited onto the substrate within which the U-groove or V-groove is formed. In FIG. 13A the fiber end face is depicted at a separation di from the end of the suspended platform 1370. Disposed on either side of the suspended platform 1370 are ratchet structures 1350 which are coupled to mounts 1330 via hinges 1380. The suspended platform 1370 is attached to anchor portions 1340 via flexible anchors 1360. Accordingly, an optical waveguide (not depicted for clarity) can be formed upon the suspended platform 1370 and routed via one of the flexible anchors 1360 to the PIC.

In second image 1300B the ratchet 1350 structure is depicted in detail comprising first section 1350A attached to the hinge 1380 and second section 1350B forming part of the suspended platform 1370. Depicted are a series of teeth 1350C such that as the second section 1350B is moved right relative to the first section 1350A the hinge allows the second section 1350B to move relative to the first section 1350A but cannot reverse direction.

Referring to FIG. 13B the optical fiber 1310 is inserted into the U-groove or V-groove and abuts the suspended platform 1370 wherein it may be “pushed” such that the suspended platform 1370 moves, the ratchet structures 1350 allowing motion of the suspended platform forward wherein the teeth engage to restrict motion of the suspended platform 1370 backwards beyond the last tooth engaged.

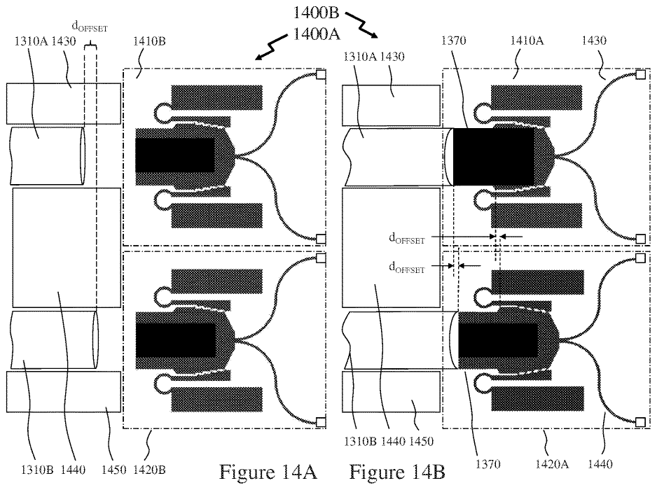

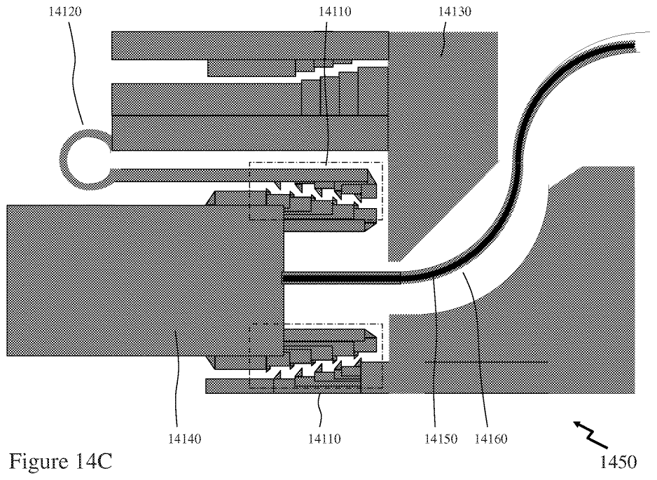

This is depicted in the instance of a pair of fibers 1310A and 1310B in FIG. 14A which are inserted into grooves, not depicted for clarity but indicated by first to third patterned regions 1430 to 1450 respectively. Also depicted are first and second FLEC structures 1410B and 1420B respectively. The pair of fibers 1310A and 1310B being within a ribbon and having an offset, d_{OFFSET}, between their end faces. Next, in FIG. 14B the pair of fibers 1310A and 1310B have been inserted and pushed forward so that they engage the first and second FLEC structures 1410B and 1420B respectively. Accordingly, the offset between the pair of fibers 1310A and 1310B, d_{OFFSET}, is reflected in the same offset in the suspended platforms 1370 within each of the first and second FLEC structures 1410B and 1420B respectively. Accordingly, the first flexible anchor 1430 in first FLEC structure 1410A is deformed by a first amount and the second flexible anchor 1440 in second FLEC structure 1410B is deformed further by a second amount as it accommodates the offset, d_{OFFSET}.

Optionally, array of grooves (V-grooves or U-grooves) may be defined such that the end of the most prominent fiber within the ribbon fiber array, of which first and second fibers 1310A and 1310B form part, “hits” the end of the groove it is in and pushes the suspended platform 1370 the furthest from its initial position. Accordingly, the other optical fibers do not push their respective suspended platforms as far forward as the most prominent optical fiber. This structure is depicted in FIG. 14C wherein the suspended platform 14140 is depicted together with a single flexible structure 14160 with optical waveguide 14150. Also evident are the pair of ratchet structures 14110 that allow the suspended platform to move to the right but not backwards to the left. Also depicted is hinge 14120 attached to one of the ratchet structures 14110. Accordingly, the number of teeth on each ratchet structure may be defined according to the desired tolerance of locking the ratchet once moved forward by the optical fiber.

Within embodiments of the invention described and depicted in respect of FIGS. 7A to 14 above and FIGS. 16 to 21 below, devices exploiting IO-MEMS structures have been described and depicted wherein an optical waveguide is formed atop a MEMS structure in order to support dynamic positioning of the optical waveguide on the suspended portion of the IO-MEMS relative to a plurality of fixed optical waveguides and/or other structures. As noted in respect of photonic integrated circuits (PICs), the management of stress is important as vertical deformation of the IO-MEMS beam(s) relative to the fixed waveguide portions results in increased insertion loss of the PIC. Accordingly, residual stress within the MEMS beam and/or other structures when released from the substrate will result in deformation of the MEMS beam and/or other structures. The sensitivity of the optical waveguide alignment within an IO-MEMS is such that at residual stress levels far below those necessary to impact operation of the MEMS the deformation in the MEMS beam and/or other structures will result in increased insertion loss and potentially complete misalignment. As will become evident in subsequent descriptions in respect of FIGS. 16 to 22 below residual stress also impacts suspended MEMS/IO-MEMS structures such as the beams within IO-MEMS described and depicted within FIGS. 7A to 14C above.

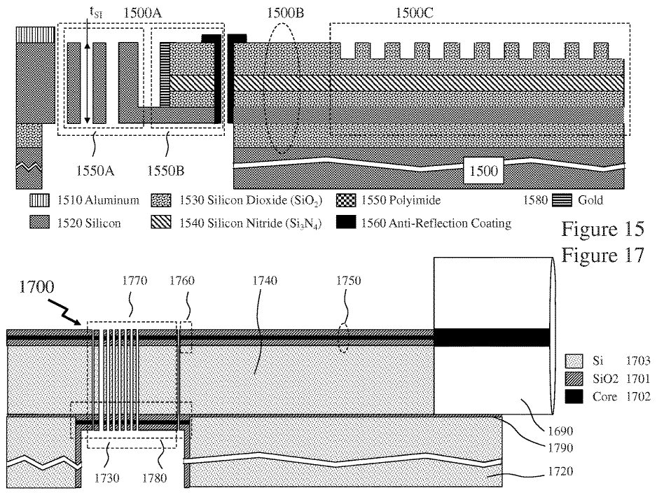

Accordingly, the inventors have established different manufacturing methodologies to address the issue. These being depicted in FIGS. 16 to 22 respectively whilst FIG. 15 depicts a prior art uncompensated waveguide design such as described and depicted within previous patent applications by the inventors including, but not limited to, PCT/CA2015/000135 and PCT/CA2015/000136. Accordingly, FIG. 15 depicts a cross-section of a fabricated IO-MEMS as described and depicted within PCT/CA2015/000135 and PCT/CA2015/000136 comprising:
Substrate 1500 formed from silicon 1520;
MEMS 1500A comprising first and second sections 1550A and 1550B;
Passive waveguide 1500B; and
Bragg waveguide 1500C.

The first section 1550A of the MEMS 1500A being formed solely from silicon 1520. Second section 1550B of the MEMS 1500A comprises an optical waveguide stack atop the silicon 1520. The optical waveguide stack comprising a lower cladding (silicon dioxide 1530), core (silicon nitride 1540), and upper cladding (silicon dioxide 1530). Within the passive waveguide 1500B and Bragg waveguide 1500C then optical waveguide stack is atop the silicon 1520 upper layer and substrate and the intervening buried oxide (BOX) layer of silicon dioxide 1530. The depicted design cross-section is of a rotary MEMS with planar waveguide coupling optical signals to one or more waveguides with a Bragg grating. Within exemplary implementations the thickness, t_{SI}, of the silicon atop the BOX is 25 μm.

Referring to FIG. 16 there are depicted exemplary first cross-section 1600A of initial starting wafer and second cross-section 1600B of a processed integrated optics microelectromechanical system (IO-MEMS) device according to an embodiment of the invention for uncompensated mirrorless designs. The inventors refer to this design concept as “Small Waveguide on Big” IO-MEMS (SWB-IO-MEMS) as a result of two mutually beneficial factors. Firstly, the removal of the optical stack where there is no need for waveguides on the suspended IO-MEMS platform 1660 formed out of the 1610 (silicon 1601) atop the BOX 1620 (SiO2 1602) and secondly the relative thickness of the device layer of the IO-MEMS substrate 1630 (silicon 1601). This device layer has a thickness established in dependence upon the Optical Fiber 1690 outside diameter thereby enabling the creation of a relatively thick suspended mechanical layer for the optical waveguides 1680 and preventing the waveguides on the suspended portion of the IO-MEMS from vertically deflecting out of alignment with the output waveguides on the fixed portion of the IO-MEMS. Furthermore, the SWB-IO-MEMS provides for optical fiber 1690 alignment to waveguides 1680 unlike the prior art geometry depicted in FIG. 15. The back of the wafer has an optional thermally grown or deposited silicon dioxide 1640 layer (SiO2 1602) for minimizing wafer bow.

In second image 1600B the processed device cross-section is depicted with MEMS region 1660 with: i) opening 1670 beneath and waveguide geometry 1650 comprising the fixed 3D optical waveguides atop the substrate 1630, ii) the waveguides atop the IO-MEMS 1660 comprising, and iii) the movable 3D optical waveguides 1680 on the suspended portion of the IO-MEMS. The waveguide geometry 1650 comprising a lower cladding (SiO2 1602), core (core 1603 such as silicon nitride), and upper cladding (SiO2 1602). Alternatively, the waveguide may comprise a silicon nitride (Si3N4)-silicon-silicon nitride stack or another material set and associated waveguide geometry enabling sufficient confinement of light to the core thus limiting the thickness amount of cladding materials to that which may be feasibly deposited on top of an IO-MEMS mechanical layer. Beneficially, the silicon device layer 1610 may be etched down to the BOX 1620 which acts as an etch stop defining a physical reference for the waveguide structures and accordingly the placement of optical fibers 1690 within U-grooves or V-grooves formed within the silicon cover 1610.

The waveguides 1680 according to the following discussions are based upon an embodiment of the invention employing an optical stack material set comprising silicon nitride & silica (SiO2-Si3N4-SiO2) with the following geometric characteristics for which it is desirable to provide for butt-coupling to standard singlemode optical fibers:

| | | |
|---|---|---|
| a lower silica (SiO2) cladding | 3.4 | μm |
| a silicon nitride (SiₓN_{y}) core | 0.435 | μm |
| an upper silica SiO2 cladding | 3.4 | μm |

Accordingly, in order to provide low-costs connectivity to IO-MEMS with standard size optical fibers, it is desirable to provide on-chip fiber attach and butt coupling between the IO-MEMS submicron waveguides and standard ITU G.652D and G.657A optical fibers with a cladding outer diameter (OD) of 125 μm. Therefore, this sets the radius of the cladding to be half of its OD, i.e. R=62.5 μm. Typically, ITU G.652D optical fibers are manufactured to the following tolerances: i) a clad OD tolerance of worst case 125 μm+0.7 μm, ii) a cladding non-circularity constrained to below 1% of the OD (i.e. 1% of 125 μm+0.7 μm, i.e. smaller than <1.257 μm) and iii) a core-cladding concentricity below 0.5 μm. The worst-case sum of all these optical fiber manufacturing tolerances is 125 μm+0.7 μm+1.257 μm+0.5 μm for a total of 127.457 μm, which means that the center of the optical fiber can shift by as much as half of the difference between the intended OD of 125 μm and the manufactured OD. Thus, considering the worst case manufactured OD of 127.457 μm, the center of the of the optical fiber can be up to 127.457−125=2.457/2=1.2285 μm off from the intended radius of 62.5 μm. It is therefore beneficial to use optical fibers with relatively large mode field diameters rather than high numerical aperture optical fibers and to match this optical mode with a spot size converter embedded in the waveguides 1680 at the optical fiber interface. Accordingly, the thickness of the silicon (d_{SI}) is given by Equation (1) below where IF-CLAD is the radius of the fiber cladding, d_{L-CLAD} is the thickness of the lower waveguide cladding and d_{CORE} is the thickness of the waveguide core.

d_{SI}=r_{F-CLAD}−d_{L-CLAD}−0.5*d_{CORE} (1)

Accordingly, the inventors have established that with the waveguide structure above then an IO-MEMS device layer 1610 set at (62.5-3.4-0.5*0.435)=58.8825 μm provides for optimal fiber alignment grooves as well as implementation of SWB-IO-MEMS while providing for the alignment of the center of waveguides 1680 to the center of the optical fiber within a vertical tolerance of worst case 1.2285 μm stemming from the manufacturing tolerances of the clad in standard ITU G.652D optical fibers.

However, whilst optical fiber manufacturers offer selected optical fiber to improve the overall accuracy of the core position it would be beneficial to employ an inherently higher specification optical fiber. Such an option exists in 80 μm OD ‘reduced clad’ optical fiber which provides for much tighter manufacturing tolerances than ITU G.652D optical fiber. Using this fiber results in r=40 μm and hence d_{SI}=40−0.5*0.435-3.4 μm=36.38 μm. Compared to the device layer thickness required by SMF28 optical fiber with 125 μm OSD, an IO-MEMS with a mechanical layer thickness of 36.38 μm, while thinner, is still thick enough to prevent significant vertical deflection of the suspended portion of the IO-MEMS shuttle 740 containing the waveguide 1680 without requiring a stress compensation stack provided that the waveguide stack material set is etched away where no waveguides are needed. However, a relatively thinner MEMS mechanical layer provides significantly easier manufacturing as the MEMS may now be formed by etching through 36.38 μm of silicon rather than 58.88 μm. The inventors have established how to set the MEMS mechanical layer thickness as a function of the OD of the optical fiber chosen for fiber attach to the IO-MEMS. Within an alternative waveguide design comprising Si3N4 (2 μm): Si (0.6 μm): Si3N4 (2.0 μm) then for D=40 μm and hence d_{SI}=37.7 μm with a 4.6 μm waveguide atop it.

Within another embodiment of the invention rather than the BOX 1620 forming the bottom of the grooves within which the optical fibers are placed may be removed. Accordingly, the thickness of the silicon, d_{SI}, is reduced by the thickness of the BOX 1620, e.g. 1 μm, such that with the example of the Si3N4 (2 μm): Si (0.6 μm): Si3N4 (2.0 μm) waveguide then d_{SI}=37.7−1.0 μm=36.7 μm.

The inventors have fabricated exemplary PIC devices exploiting PECVD for the optical waveguide structure. However, elimination of absorption from OH-within the Si3N4 deposited by PECVD requires annealing thereby inducing stress within the optical waveguide structures such that LPCVD may offer lower stress waveguides. However, it would be evident that other embodiments of the invention may exploit PECVD, LPCVD or other waveguide deposition processes.

Whilst FIG. 16 further depicts a geometry consistent with that described and depicted in respect of FIG. 16 such that the thickness of the thick silicon device layer 1610 serving as the mechanical layer for the IO-MEMS is defined to allow U-groove formation with the bottom of the U-groove and hence lower mechanical stop for the position of the optical fibers, it would be evident that the methodology of forming the IO-MEMS 1660 or MEMS within the thick silicon cover 1610 with an opening 1670 within the substrate prior to fabrication of the IO-MEMS and/or MEMS may be employed in other PICs that do not exploit U-groove designs etc. such that the thickness of the device layer 1610 serving as the mechanical layer for the IO-MEMS 1610 is defined by other design, cost, performance tradeoffs rather than the vertical alignment of the optical fiber.

Within FIG. 16, an embodiment of the invention comprises the waveguides 1680 atop the fixed 1650 and suspended portions 1660 of the IO-MEMS comprising the movable 3D optical waveguides on the beams. The waveguide geometry 1650 comprising a lower cladding (SiO2 1602), core (core 1603 such as silicon nitride), and upper cladding (SiO2 1602) as depicted but it may comprise other waveguide designs such as Si3N4 (2 μm): Si (0.6 μm): Si3N4 (2.0 μm) waveguide in either the Si3N4 (3.4 μm): Si (0.435 μm): Si3N4 (3.4 μm) waveguide or Si3N4 (2 μm): Si (0.6 μm): Si3N4 (2.0 μm) waveguide variants described above.

Referring to FIG. 17 there is depicted an exemplary cross-section of processed IO-MEMS device according to an embodiment of the invention exploiting a cavity compensated design with fiber interface wherein the silicon substrate has an opening 1730 within it such that a complementary waveguide stack 1780 can be formed on the lower surface of the SOI structure device layer 1740 serving as the mechanical support for the IO-MEMS, on the opposite side to the waveguide stack 1750 which is deposited on the upper surface of the SOI structure device layer 1740. The complementary waveguide stack 1780 etched in the same process step as the IO-MEMS 1770 with its suspended waveguide such that the complementary waveguide stack 1780 and waveguide stack 1750 are patterned the same. The opening 1730 being formed within the substrate 1720. Accordingly, etching through the waveguide stack 1750 and thick silicon 1740 in the region where the optical fiber 1690 is to be inserted and coupled provides for the optical core of the optical fiber 1690 to be vertically aligned to the core 1702 of the optical waveguide stack 1750. Within FIG. 17 the optical waveguide has upper and lower cladding of silicon dioxide (SiO2) 2001 whilst the substrate is silicon 1703. The optical waveguides materials on the suspended 1770 and fixed portions of the IO-MEMS 1750 set may optionally be removed in locations where there is no need for actual waveguides, enabling the mitigation of the stress imposed by these materials onto the suspended portion of the IO-MEMS and or to minimize the bow of the SOI substrate upon etching the openings 1730 from the backside of the SOI substrate 1720.

The cross-section 1700 of the IO-MEMS in FIG. 17 finally shows that the thickness of the silicon device layer of the SOI structure serving as the mechanical layer 1740 of the IO-MEMS may be defined as a function of the diameter of an optical fiber 1690 with the buried oxide layer 1790 serving as an etch stop which may or may not be removed at the bottom of the groove below the optical fiber 1690.

Accordingly, the geometry depicted in FIG. 17 is intended to provide for compensation of the stress induced from the optical waveguide by providing a complementary structure on the lower surface of the IO-MEMS mechanical layer 1740. However, it would be evident that the deposition and patterning of the structure(s) on the lower surface of the IO-MEMS mechanical layer 1740 is performed through the opening 1730 within the silicon substrate 1720. Accordingly, the structure deposited and patterned onto the lower surface of the IO-MEMS mechanical layer 1740 may, in some embodiments of the invention, not be a direct replica of that formed upon the upper surface. The design of the structure deposited and patterned onto the lower surface of IO-MEMS mechanical layer 1740 may, in some embodiments of the invention, be based upon numerical simulations/computer aided design etc. whilst in other embodiments of the invention it may be established qualitatively rather than quantitively.

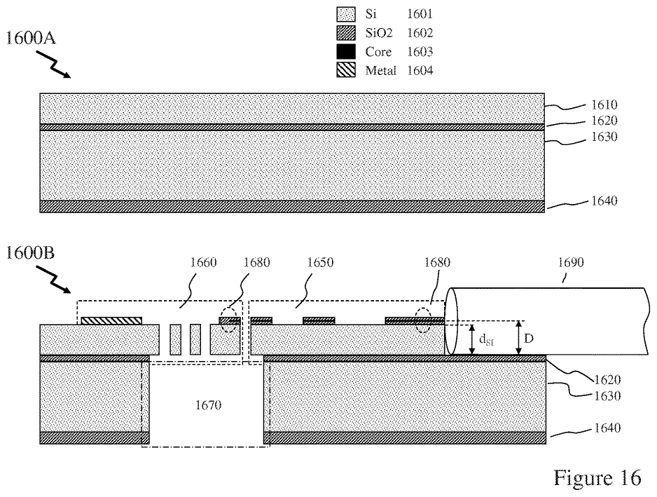

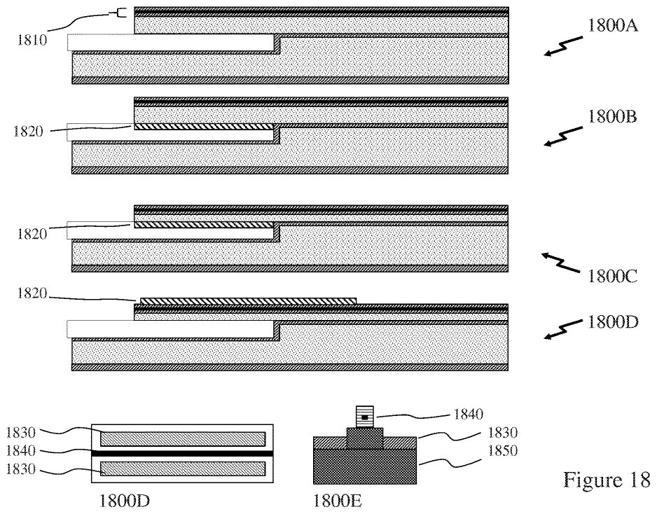

In contrast, embodiments of the invention depicted in respect of FIG. 18 in first to fourth images 1800A to 1800D respectively which provide additional structures to provide post-fabrication adjustment of the IO-MEMS beam. Within first image 1800A the waveguide structure 1810 above the beam employs aluminum nitride (AlN) core with silicon dioxide upper and lower cladding layers. The core is connected to one or more electrode pads allowing electrical activation of the AlN film which is piezoelectric. Accordingly, the AlN can be employed to provide a stress to counteract any present within the IO-MEMS beam to “flatten” the IO-MEMS beam. Alternatively, as depicted in second image 1800B an AlN film 1820 is provided on the lower surface of the IO-MEMS beam, for example, by patterning on a silicon layer on a first handler wafer which is inverted and bonded to the silicon substrate such as described and depicted supra in respect of fabricating other embodiments of the invention. Within third image 1800C the AlN file 1820 is deposited upon the lower surface of a thin IO-MEMS beam rather than a thick IO-MEMS beam.

Alternatively, as depicted in fourth image 1800D AlN regions 1830 may be added laterally to the IO-MEMS beam either side of the optical waveguide 2140. Further, as evident in fifth image 1800E the IO-MEMS beam may be further processed such that the AlN regions 1830 are adjacent and on thinner silicon 1850 than the optical waveguide 1840. Optionally, the geometries of fourth and fifth images 1800D and 1800E may be augmented with AlN film 1820 beneath as well as employ a waveguide with AlN core. Within other embodiments of the invention variants of second to fifth images 1800B to 1800E respectively may employ conductive films that provide resistive heating of the IO-MEMS beam in order to induce asymmetric stress to counter stress within the IO-MEMS beam to “flatten” the IO-MEMS beam(s).

Coming back to FIG. 16, whilst IO-MEMS 1660 was released by etching through BOX 1620 and the entire substrate 1630 thereby yielding opening 1670, the presence of many of such openings may result in increased packaging complexity for IO-MEMS to the need to bottom cap the openings to prevent glue or solder from entering into the openings below the IO-MEMS. Furthermore, given that a typical SOI substrate is 735 μm thick, the fabrication of the openings 1670 results in a long etch process through this 735 μm of silicon 1630.

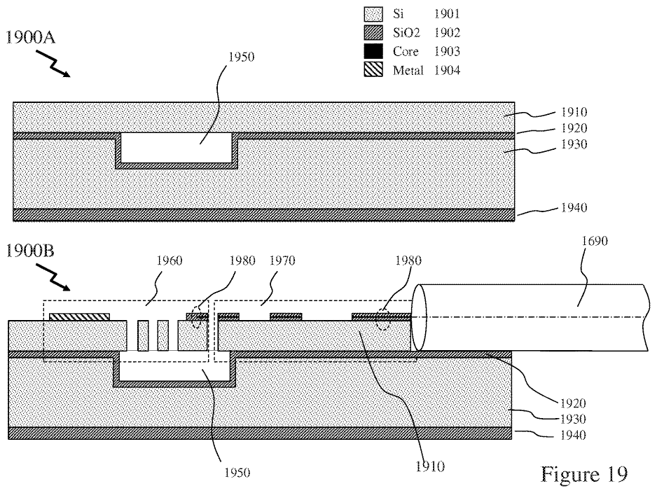

Consequently, the inventors have established a variant of the silicon-on-insulator (SOI) design depicted in FIG. 19 which exploits the SWB-IO-MEMS concept but exploits an initial silicon substrate 1930 with recesses 1950 formed within it, serving as cavities beneath the IO-MEMS 1960 and allowing the IO-MEMS to become suspended upon being etched from the top without any need for removing material below the IO-MEMS in order to suspend the IO-MEMS. Accordingly, the inventors refer to this as Cavity SOI (CSOI). CSOI enables a much simpler packaging of IO-MEMS as there is no need to bottom cap the IO-MEMS as there are no longer a need for vias etched from the backside of the SOI substrate 1930 in order to suspend the IO-MEMS 1960.

Accordingly, referring to FIG. 19 there are depicted exemplary first cross-section 1900A of initial starting wafer and second cross-section 1900B of a processed integrated optics microelectromechanical system (IO-MEMS) device according to an embodiment of the invention for uncompensated mirrorless designs. The inventors refer to this design concept as CSOI small waveguides on big IO-MEMS (SWB-IO-MEMS) due to the thick mechanical layer 1910 (silicon 1901) atop the BOX 1920 (SiO2 1602) and substrate 1930 (silicon 1901). Beneficially the SWB-IO-MEMS provides for optical fiber 1690 alignment in common with the geometry depicted in FIG. 16. The back of the wafer having an optional thermally grown or deposited oxide 1940 (SiO2 1602) to minimize wafer bow. In first image 1900A, the BOX 1920 is formed after the substrate 1930 has been etched to provide the recess 1950. A sacrificial material (not depicted) for clarity may be deposited within the openings 1950 prior to the formation of the silicon device layer 1910.

In second image 1900B the processed device cross-section is depicted with IO-MEMS region 1960 with opening 1970 beneath and waveguide geometry 1950 comprising the fixed 3D optical waveguides atop the substrate 1930. Upon patterning the MEMS in the silicon device layer 1910, the IO-MEMS 1960 is thereby released and becomes suspended by its anchors (not shown) over the cavity 1950. The removal of the optical stack material set where there is no need for waveguides 1980 on the suspended portion of the IO-MEMS 1960 and the fixed portion of the IO-MEMS 1990 provides for a mechanism to minimize the upon the SOI substrate stemming from the material set of the optical stack deposited upon the IO-MEMS device layer 1910. The thickness of the device layer 1910 serving as the mechanical layer for the IO-MEMS has direct impact on the ability to maintain the waveguides 1980 on the suspended portion of the IO-MEMS 1960 optically aligned with those on the fixed portion 1970 of the IO-MEMS. Further, second image 1900B, the optical fiber 1690 is depicted and optically aligned with the optical waveguides 1980 in the same manner as previously described in FIG. 16, that is by a cavity formed in the device layer of the SOI wafer serving as the mechanical support for the IO-MEMS 1960 and resting on the top of the buried oxide 1920 or on the top of the SOI substrate silicon 1930 should the buried oxide be removed deliberately.

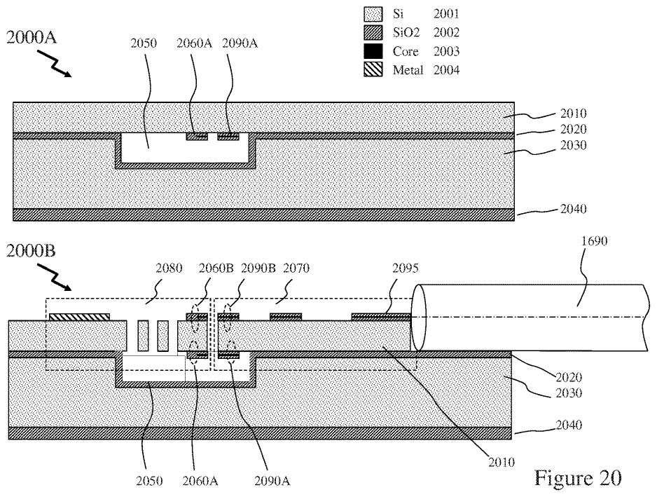

Within the embodiments of the invention depicted in FIG. 20 and variants that do or do not exploit thick SOI device layer 2010 serving as the mechanical layer of IO-MEMS and dimensioned for vertical alignment of the optical fiber, the target performance of the optical elements within the IO-MEMS portions of the PIC may require additional processing and design to achieve the desired performance. This may arise from pattern dependent stress of the optical waveguide portion of the IO-MEMS such that, for example, deflection of the IO-MEMS suspended portion 2080 varies according to the design of the optical waveguide(s) atop it, be they 3D or two-dimensional (2D or planer) waveguides or combinations thereof. Accordingly, the inventors have established what they refer to as Compensated Cavity Silicon-on-Insulator (C-CSOI). This being depicted in FIG. 20 via first and second images 2000A and 2000B respectively which are cross-sections of the initial starting wafer and processed integrated optics microelectromechanical system (IO-MEMS) device according to embodiments of the invention. Considering first image 2000A then the starting wafer comprises substrate 2030, lower thermal oxide 2040, BOX 2020, and thick silicon 2010 with opening 2050 in common with the opening 1950 in the CSOI design depicted in FIG. 19. However, the bottom surface of the thick silicon 2010 has first and second regions 2060A and 2090A deposited with the same waveguide structures as are deposited in the upper surface of the thick silicon 2010 as depicted in second image 2000B within the IO-MEMS region 2080 and fixed waveguide region 2070. The fixed waveguide region 2070 also comprising waveguides 2095 in regions with underlying BOX 2020 and substrate 2030. Optionally, within alternate embodiments of the C-CSOI process the first and second regions 2060A and 2090A respectively on the lower side of the SOI structure device layer silicon 2010 serving as the mechanical support of the IO-MEMS 2080 may also be formed with a variant of the design depicted in FIG. 16 albeit with the processing limitations and complexities of forming the required layer structures with or without either low resolution or high resolution patterning at the bottom of a deep recess formed by the etched substrate.

Accordingly, the C-CSOI design methodology exploits providing a back surface layer structure which is the mirrored structure deposited atop the top surface such that the first and second regions 2060A and 2090A respectively on the lower side of the IO-MEMS SOI structure device layer 2010 provide a compensation for the corresponding third and fourth regions 2060B and 2090B on the upper side of the thick silicon 2010. Accordingly, the opening 2050 during processed is filled with a filler and then processed to deposit the layer stack and pattern the first and second regions 2060A and 2090A prior to patterning and the IO-MEMS SOI structure device layer 2010. Then the upper surface processed to form the third and fourth regions 2060B and 2090B as part of forming the IO-MEMS region 2080 and fixed waveguide region 2070. Subsequently when the thick silicon 2010 is etched to form the IO-MEMS (and/or MEMS) then the filler can be removed thereby releasing the IO-MEMS (and/or MEMS) which have the first and second regions 2060A and 2090A respectively on the lower side of the IO-MEMS SOI structure device layer 2010 in the IO-MEMS region 2000 and fixed waveguide region 2070. Within the descriptions in respect of FIG. 20, the process flow described considers the first and second regions respectively formed on the lower side of the thick silicon to have been formed through a process exploiting a sacrificial filler within the opening.

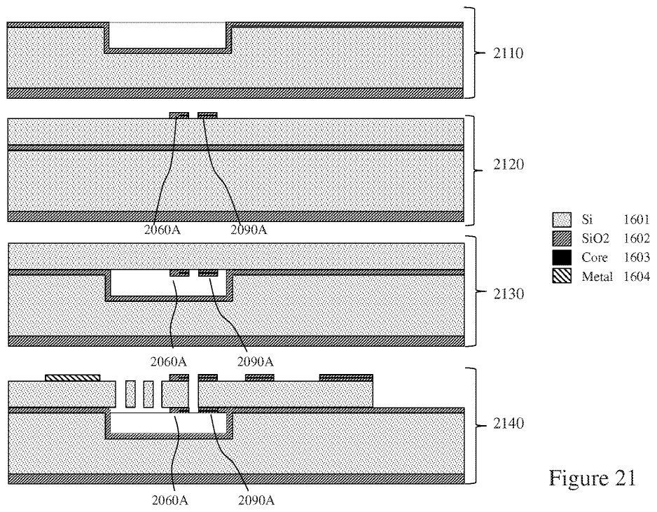

Referring to FIG. 21 there is depicted an alternate process exploiting multiple silicon handling wafers to form the base Cavity SOI substrate. Accordingly, in first image 2110 a first handling wafer comprising the silicon substrate with lower thermal oxide, processed openings, and upper BOX is manufactured. Next a second handling wafer is processed as depicted in second image 2120 comprising a silicon substrate, sacrificial layer and thick silicon layer onto which are deposited the stress compensation structures 2060A and 2090A that will subsequently be within the recess. Accordingly, in third image 2130 the second handling wafer is flipped onto the first handling wafer, bonded to it, and then the substrate of the second handling wafer removed to leave the thick silicon. This is then processed to provide the top waveguide structures, silicon etched to form IO-MEMS and/or MEMS, U-grooves etc. as depicted in fourth image 2140.

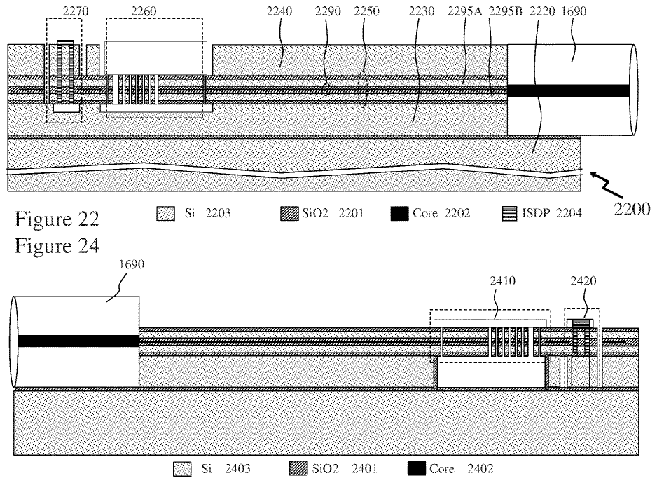

There remains an opportunity to implement a pattern-independent naturally balanced suspended portion of the IO-MEMS, which may not need to be stress-compensated. Now referring to FIGS. 22-25 there are depicted vertically symmetric structures for compensated IO-MEMS designs according to embodiments of the invention such as that depicted in FIG. 22 wherein the optical waveguide stack 2290 is embedded between first and second device layers 2295A and 2095B to form structure 2200.

Now referring to FIG. 22 there is depicted an exemplary cross-section of processed integrated optics microelectromechanical system (IO-MEMS) device according to an embodiment of the invention exploiting vertically symmetric structure for compensated design with fiber optic interface wherein the optical waveguide stack 2290 lower cladding-core-upper cladding is embedded between two device layers 2295A and 2295B to form the structure 2250. Either side of the structure 2250 are two thick silicon layers 2230 and 2240 respectively with intervening BOX layers. The structure 2250 forming the mechanical layers within which the IO-MEMS/MEMS suspended structures such as beam 2260 are fabricated. The electrical control signals for the IO-MEMS being routed through vias in via region 2270 electrically joining the device layers 2295A and 2295B of the IO-MEMS. Also depicted in FIG. 22 are the optical fiber 1690 and substrate 2220.

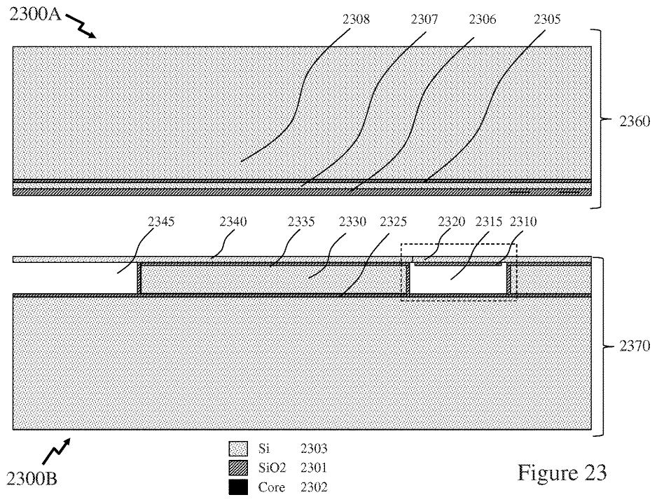

In accordance with an embodiment of the invention in FIG. 23, it may also be possible to obtain an equivalent layered structure as illustrated in FIG. 22, by way of either bonding an SOI structure 2360 having received an optical stack material set serving for the patterning of optical waveguides, composed of a bottom clad 2301, a core 2302 and top clad 2301 to a double SOI with cavity structure 2370 having two buried oxide layers 2325 & 2335, a cavity 2315 wherein while forming the cavity in the double SOI structure, a stress compensation layer 2310 is pre-applied matching the stress of the buried oxide layer 2305 from SOI structure 2360. The Double SOI structure with cavity 2370 having a device layer 2320 of the same thickness as the device layer 2307 of SOI structure 2360 such as that upon bonding SOI structure 2360 onto Double SOI structure with Cavity 2370, the structural stack for an IO-MEMS comprises the stress compensation material 2310 below the 2^{nd} device layer 2320, the device layer 2320, the optical stack material set 2306, the device layer 2307 of the SOI structure 2360 and the buried oxide 2305 of SOI structure 2360. Further, it is desirable to omit placing the stress compensation stack 2310 in areas of the Double SOI with Cavity 2370 for cavities 2345 which may be used for purposes such as optical fiber attach (not shown) instead of for IO-MEMS. After the bonding is performed, the handle portion of SOI structure 2360 is subsequently removed such that the buried oxide 2305 forms the top surface of the IO-MEMS.

FIG. 24 illustrates a cross-section of an IO-MEMS formed from the bonding of SOI structure 2360 and Double SOI structure with Cavity 2370 upon having removed the handle portion of SOI structure 2360 showing optical fiber 1690 resting in cavity 2345 of FIG. 23 and IO-MEMS 2410 resting over cavity 2315 of FIG. 23. FIG. 24 also illustrates the electrically conductive via 2420 connecting the two device layers 2307 of SOI Structure 2360 and 2340 of Double SOI structure with Cavity 2370 of FIG. 23. Beneficially, the design depicted in FIG. 24 maintains a symmetric vertical structure around the optical waveguide throughout the entire waveguide of the IO-MEMS 2410 which is functionally equivalent to that of IO-MEMS 2260 of FIG. 22.

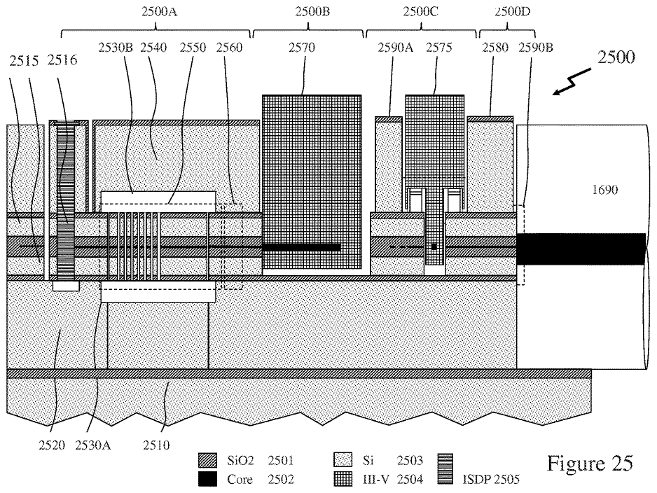

Referring to FIG. 25 there is depicted an exemplary cross-section of processed IO-MEMS device according to an embodiment of the invention exploiting vertically symmetric structure for compensated design with fiber optic interface and active semiconductor device integration. The underlying concept of the design being that depicted in FIG. 22 but extended to include active semiconductor device integration. Accordingly, the PIC 2500 depicted comprises an IO-MEMS 2300A, waveguide photodetector 2500B, semiconductor optical amplifier 2500C and fiber interface 2500D wherein the PIC is coupled to an optical fiber 1690. Accordingly, the PIC comprises in vertical sequence:
Substrate 2510
Lower thick silicon 2520 within which first recess 2530A is formed;
Symmetric optical structure 2590A comprising waveguide stack 2580 disposed between upper and lower silicon layers; and
Upper thick silicon 2540 within which second recess 2530B is formed
Electrically conductive material such as ISDP 2505 in the via 2516 to connect the two silicon layers 2515A and 2515B of IO-MEMS 2550.

The PIC comprising multiple regions of the waveguide. These being, IO-MEMS 2550; suspended waveguide 2560, e.g. a beam of an actuator; and fiber interface region 2590B. Due to the symmetric structure of the lower and upper thick silicon 2520 and 2540 respectively the first and second recesses 2530A and 2530B provide encapsulation of the IO-MEMS 2550.

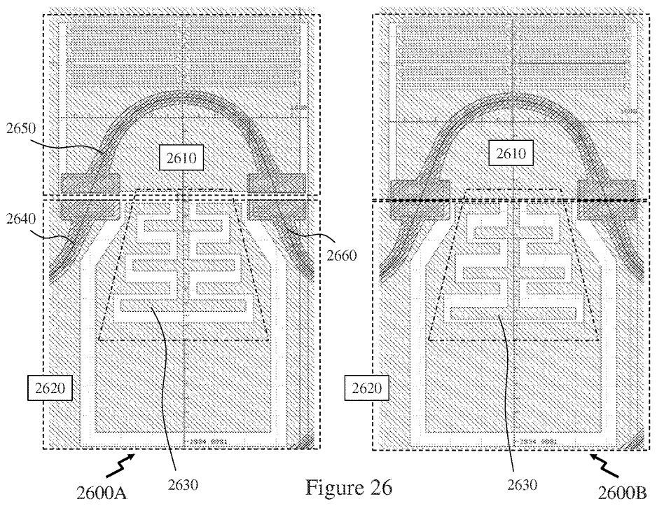

Now referring to FIG. 26 there are depicted first and second schematics 2600A and 2600B of a 1×1 on/off IO-MEMS optical switch (fully reconfigurable optical gate or FROG) according to an embodiment of the invention in closed and open configurations respectively. As depicted in first schematic 2600A the first movable portion 2610 of the FROG is in a first position relative to the second non-movable portion 2620 such that the optical waveguide portions on each are not optically coupled to each other such that the FROG is “open” and the on-off switch is thus in “off” state where light doesn't come across the FROG. Motion of the first movable portion 2610 relative to the second non-movable portion 2620 being controlled by the MEMS actuator 2630. Accordingly, optical signals do not propagate from the input waveguide 2640 upon the second non-movable portion 2610 to the waveguide 2650 upon the first movable portion 2610. Any residual optical signals which do couple through the now misaligned coupling interface between the input waveguide 2640 and waveguide 2650 are similarly attenuated further by the now misaligned coupling interface between the waveguide 2650 and the output waveguide 2660.

As depicted in first schematic 2600B the first movable portion 2610 of the FROG is in a second position relative to the second non-movable portion 2620 such that the optical waveguide portions on each are optically coupled to each other such that the FROG is “closed.” Motion of the first movable portion 2610 relative to the second non-movable portion 2620 being controlled by a MEMS actuator 2630. Accordingly, optical signals propagate from an input waveguide 2640 upon the second non-movable portion 2610 to a waveguide 2650 upon the first movable portion 2610 and therein back to an output waveguide 2660 upon the second non-movable portion 2620.

Accordingly, the FROG provides for an optical gate when the MEMS actuator 2630 is driven from a first position (such that the first movable portion 2620 and second non-movable portion 2610 are not in contact with another under action of the MEMS actuator 2630 in one direction) where optical signals do not pass through the optical gate to a second position (such that the first movable portion 2620 and second non-movable portion 2610 are now in contact with another under action of the MEMS actuator 2630 in an opposite second direction) where optical signals pass through the optical gate. It would be apparent to one of skill in the art that at intermediate positions between contact and furthest motion of the MEMS actuator 2630 moving the first movable portion 2610 to its furthest point away from the second non-movable portion 2620 optical signals may pass through the optical gate albeit attenuated. Accordingly, as it would be also evident to one skilled in the art, the FROG structure may also within embodiments of the invention provide for a variable optical attenuator, which may be further enhanced as a variable optical attenuator by replacing the MEMS actuator from one which works in pull-in to one which is linear.

Referring to the first and second schematics 2600A and 2600B of FIG. 26, the authors refer to the angle of incidence as that measured between a normal to the facet and the routing of the waveguide on the first movable portion 2610. However, in instances where only an optical gate (on-off switch) functionality is required then the inventors have further extended the FROG concept by establishing that the angle at which the optical waveguides are aligned to the facets of the first movable portion and the second non-movable portion should meet a predetermined condition as outlined below.

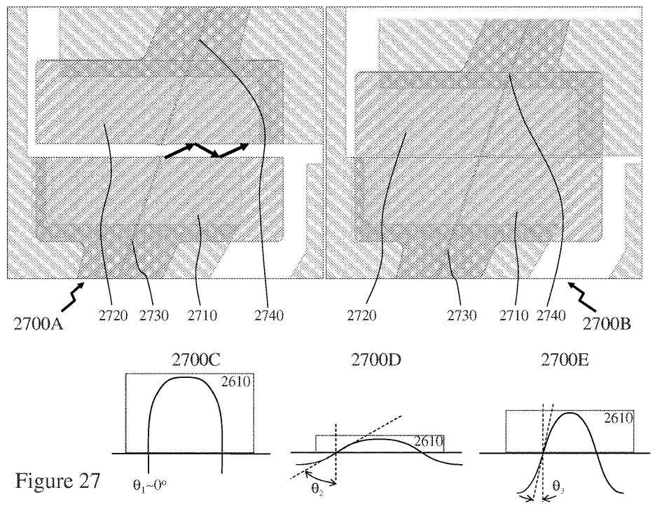

Now referring to FIG. 27 there are depicted expanded first and second schematics 2700A and 2700B of the waveguide interfaces at the edges of the moving and non-moving portions of the IO-MEMS optical gate as depicted in FIG. 26 in open and closed configurations respectively. Accordingly, as depicted in first schematic 2700A for the “open” configuration optical signals propagating from a first waveguide 2730 upon a first non-movable portion 2710 of the FROG may be prevented from coupling to a second waveguide 2740 upon the second movable portion 2720 of the FROG at an angle exceeding the total reflection angle of the air-waveguide interface such that the optical signals from the first waveguide 2730 naturally diverge in the open gap and either do not couple into waveguide 2740 or couple with a large degree of attenuation. However, as depicted in second schematic 2700B when the first non-movable portion 2710 and second movable portion 2720 are brought into physical contact the optical signals propagate from the first waveguide 2730 to the second waveguide 2740.

Referring to FIG. 27, in the “open” configuration as depicted in first schematic 2700A then as the angle of incidence is increased from θ₁~0° in third schematic 2700C to θ₁>0° in fourth schematic 2700D, then the input and output waveguides 2640 and 2660 respectively are increasingly parallel to the facet which results in the waveguide on the suspended platform 2650 having to turn through a reduced angle. This increasingly results in divergence of optical signals propagating in the air gap in the “open” state as well reflection of these optical signals from opposite facets of the opposite platform, e.g. the moving portion 2720 when the optical signals are coupled from the non-moving portion 2710 or the non-moving portion 2710 when the optical signals are coupled from the moving portion 2720. However, as depicted in the third schematic 2700C, where this angle is close to zero, undesirable reflections at the facets result in optical signals coupling back. For example, from first waveguide 2730 back into first waveguide 2730 may occur given either the air gap in “open” state, or any residual air gap in the “closed” state, as may arise for example from the etch profile of the optical facets of the second waveguide 2740 on the moving portion 2720 despite it making contact with the optical waveguide 2710 on the non-moving portion 2720. Alternatively, to suppress such back-reflections, it would be evident to one skilled in the art that the application of anti-reflective coatings on the facets may achieve a similar objective albeit at the expense of additional processing steps.

Referring to FIG. 27, when the FROG is an ‘off’ state, in the presence of an open air gap, the selection of an increased angle of incidence of the waveguides relative to the facets may reduce the overall extent of the waveguide 2650 on the first movable portion 2610 as demonstrated by the large size of the first movable portion 2610 in third image 2700C which is further reduced to the greatest extent in fourth schematic 2700D as the angle θ₂ is increased to or beyond the critical angle of refraction, which is approximately 42° when the effective refractive index of the facet is 1.5. As the angle of incidence approaches 42 degrees when the effective index is 1.5, this reduces or prevents the divergence of optical signals launched from the waveguide 2730 in the open air gap and would cause back reflections from first waveguide 2730 back into the first waveguide 2730 or unwanted coupling from first waveguide 2730 into second waveguide 2740.

Therefore, the inventors have established a predetermined angle θ₃ as depicted in fifth schematic 2700E which balances tradeoffs between several design objectives. A first design objective being minimizing the overall extent of the optical waveguide on the movable portion of the FROG. A second design objective being to maximize the optical loss of optical signals launched from the first waveguide 2730 to the second waveguide 2740 in the “open” or “off” state i.e. to have these optical signals terminate in the open gap and thus minimally couple into the second waveguide 2740. A third design objective being minimizing the return loss of optical signals incoming on first waveguide 2730 returning into first waveguide 2730. A fourth design objective may be of avoiding use of anti-reflective coatings on the optical facets of the non-movable portion 2710 and movable portion 2720 facing the air gap. A fifth design objective may be to remove the requirement for anti-reflective coatings on the facets in the presence of a possible residual air gaps stemming from the etching profile of the optical facets of non-movable portion 2710 and movable portion 2720. In fourth schematic 2700D the waveguides have a large angle of incidence, θ₂, above the critical angle of refraction. The predetermined angle, θ₃, for achieving the requisite tradeoffs between the design objectives is depicted in fifth schematic 2700E in FIG. 27 such that θ₃<critical angle of refraction. The exact value of θ₃ being established in dependence upon the subset of the design objectives being optimized.

It would also be evident, referring to FIG. 26, that the angle of the input and output waveguides 2640 and 2660 could also be different, such as to allow for, for example, a large angle of incidence to be employed from the input waveguide to the waveguide on the movable portion and a small angle of incidence from the waveguide on the movable portion to the output waveguide. Alternatively, the reverse configuration may be employed.

Now referring to FIG. 28 there are depicted expanded schematics of the waveguide interface variants at the edges of the moving and non-moving portions of the IO-MEMS optical gate as depicted in FIGS. 26 and 27 respectively in open configurations. Accordingly, there are depicted:
First schematic 2800A with facets 2810A and 2810B respectively each having an angled projecting portion with linear waveguide-facet intersection with a constant width optical waveguide either side;
Second schematic 2800B with facets 2820A and 2820B respectively having a curved waveguide-facet intersection with a constant width optical waveguide either side;
Third schematic 2800C with facets 2830A and 2830B respectively having a curved waveguide-facet intersection with a constant width optical waveguide either side but employing spot size converters in the shape of tapers (expanding the waveguide core width) or inverse tapers (reducing the waveguide core width) to improve the coupling performance by increasing the optical mode size, near the interface;
Fourth schematic 2800D with facets 2840A and 2840B respectively having a curved waveguide-facet intersection with a constant width optical waveguide either side but employing micro-lenses formed upon the facets;
Fifth schematic 2800E with facets 2850A and 2850B respectively having a straight waveguide-facet intersection wherein the optical waveguides either side are coupled via a multimode interference (MMI) coupler split across the coupling interface and formed upon gap closing, allowing for increased coupling performance across the interface.

Also depicted in FIG. 28 in sixth schematic 2800F is an alternate geometry for an optical gate such as the FROG described and depicted above in respect of FIGS. 26 and 27 respectively. As depicted an input waveguide 2870 is formed upon the non-moving portion 2860B of the structure as is an output waveguide 2890. A gate waveguide 2880 is formed upon the moving portion 2860A of the structure. Accordingly, movement of the moving platform 2860A translates the gate waveguide 2880 into or out of alignment with the input waveguide 2870 and output waveguide 2890. Such an optical gate may be typically manufactured in the “open” state wherein actuation of a MEMS actuator coupled to the moving platform 2860A translates the gate waveguide 2880 into alignment such that the gate is “closed” and optical signals pass through. Beneficially, this configuration allows for the input waveguide 2870, gate waveguide 2880, and output waveguide 2890 to be straight or have low angular offsets as the angle of incidence of the optical waveguides with the facets are now defined by the angles placed upon the facets within the structure relative to the optical waveguides rather than requiring the optical waveguides to bend to the required angle of incidence. Whilst the configuration depicted in sixth schematic 2800F in FIG. 28 depicts curved waveguides these may be straight within other embodiments of the invention.

It would be evident that other coupling structures may be employed including directional couplers, zero gap directional couplers, meta lenses formed within the waveguide core etching profile, meta-material couplers, suspended spot size converters whereas the optical mode would be large enough to couple into the substrate below the bottom clad for the substrate not removed below the bottom clad under the spot size converter, etc. all without departing from the scope of the invention. Within embodiments of the invention an optical gate such as described and depicted within FIGS. 26 to 28 may be designed to be “open” such that actuation of the MEMS actuator is required to close the optical gate. Within other embodiments of the invention an optical gate such as described and depicted within FIGS. 26 to 28 may be designed to be “closed” such that actuation of the MEMS actuator is required to open the optical gate. Within other embodiments of the invention the optical gate such as described and depicted within FIGS. 26 to 28 may be designed to be “open”, but not full open such that actuation of the MEMS actuator is required to either close the optical gate or open the optical gate fully.

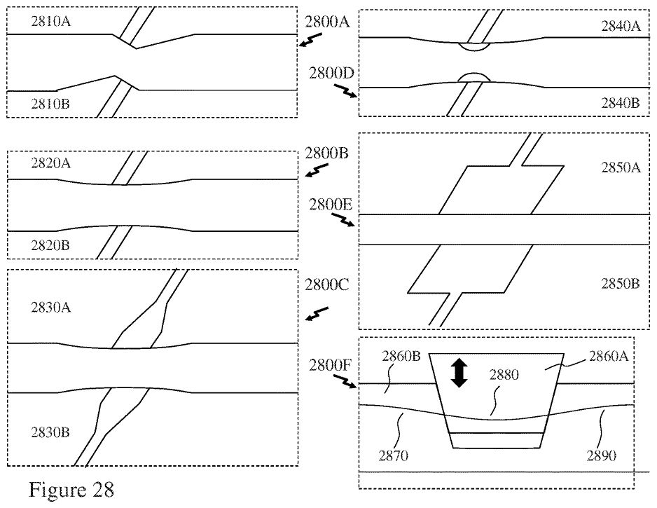

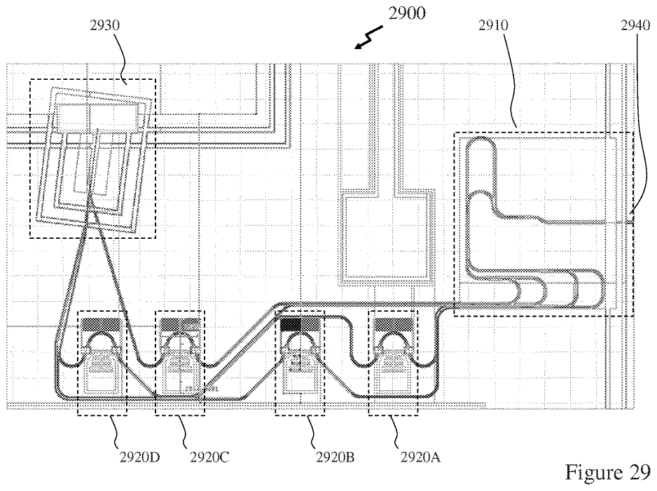

Now referring to FIG. 29 there is depicted a 4-channel wavelength selective IO-MEMS optical receiver 2900 according to an embodiment of the invention employing IO-MEMS optical gates upon the outputs of a 4-channel wavelength demultiplexer (DMUX) 2910. As depicted an input waveguide 2940 is coupled to a 4-channel DMUX 2910 which provides 4 wavelength demultiplexed outputs which are each coupled to a single photodetector 2930 via first to fourth MEMS actuated optical gates 2920A to 2920D respectively. Accordingly, where the optical gates are designed to be normally open then closing only one of the first to fourth MEMS actuated optical gates 2920A to 2920D respectively through actuation of its actuator results in the associated wavelength from the 4-channel DMUX 2910 being coupled to the photodetector 2930. Alternatively, if the optical gates are normally closed then opening all of the other gates other than the one desired is undertaken.

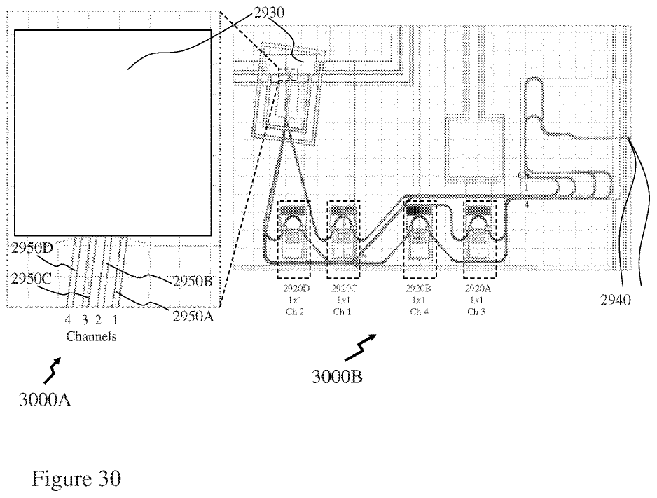

Referring to FIG. 30 there is depicted in first image 3000A an expanded view of the photodetector portion of the 4-channel DMUX of which a portion is depicted within the schematic in second image 3000B. As depicted within second image 3000B:
the first MEMS actuated optical gate 2920A is coupled to channel 3 of the DMUX;
the second MEMS actuated optical gate 2920B is coupled to channel 4 of the DMUX;
the third MEMS actuated optical gate 2920C is coupled to channel 1 of the DMUX; and
the fourth MEMS actuated optical gate 2920D is coupled to channel 2 of the DMUX.

As depicted in first image 3000A first to fourth channel waveguides 2950A to 2950D respectively couple to the single p-i-n photodetector 2940 which are coupled to channels 4, 3, 2, and 1 respectively of the 4-channel DMUX. Optionally, each of the first to fourth channel waveguides 2950A to 2950D could be coupled to a discrete photodetector, e.g. 4 photodiodes for the 4 channels of the 4-channel wavelength selective IO-MEMS optical receiver or these may be paired to a pair of photodiodes, e.g. 2 photodiodes for the 4 channels of the 4-channel wavelength selective IO-MEMS optical receiver.

It would be evident within other embodiments of the invention the number of channels within the DMUX may be varied, for example 8, 16, 20, 24, 40 and 48 etc. whilst one or more photodetectors may be employed where with multiple photodetectors each photodetector is coupled to a predetermined subset of the outputs of the DMUX. Optionally, an optical gate may be disposed upon the input of the DMUX disabling the circuit optically. Within other embodiments of the invention the optical gates may be employed in conjunction with a wavelength multiplexer (MUX) in order to block inputs of the MUX and/or the output of the MUX.

Within embodiments of the invention described above in respect of FIGS. 1 to 30 optical waveguides have been described with respect to guiding, routing etc. optical signals within integrated optical (photonic integrated) circuits (IO circuits or PICs). Within FIG. 15 the optical waveguides are described and depicted as comprising a silicon nitride (Si_{X}N_{Y}, Si3N4 or SiN) core with silicon dioxide (silica) cladding (shown as upper and lower cladding in the cross-section of FIG. 15). Within FIGS. 16 to 25 the waveguides are described and depicted as comprising a core, e.g. silicon nitride, with silica cladding. Accordingly, a typical manufacturing sequence for such SiO₂—Si₃N₄—SiO₂ waveguides according to the prior art may comprise depositing an initial lower SiO₂ cladding, depositing and patterning the Si₃N₄ core, and then depositing the upper SiO2 cladding. Accordingly, etching of the silicon nitride core using processes such as wet etching (e.g. phosphoric acid, orthophosphoric acid or ethylene glycol (HOCH₂CH₂OH)-acetic acid (CH₃COOH)-nitric acid (HNO₃)-ammonium fluoride (NH₄F) mixture) or plasma etching (e.g. CF₄/H₂, CF₄/O₂/N2, SF₆/O₂/N2, SF₆/CH₄/N2, SF₆/CH₄/N2/O₂ for example) is undertaken to define the three-dimensional (3D) optical waveguides (also known as channel waveguides). The resulting 3D waveguides have a side-wall roughness and a surface roughness which due to the high index contrast of the silicon nitride (n_{λ=1550 nm}~2.463) to the silicon dioxide (n_{λ=1550 nm}~1.443) results in significant optical scattering from the sidewalls resulting in increased propagation loss.

Within the prior art approaches to reducing the surface roughness of the silicon nitride cores have included:
a modified Damascene reflow process, see for example Pfeiffer et al. “Ultra-Smooth Silicon Nitride Waveguides based on the Damascene Reflow Process: Fabrication and Loss Origins” (Optics, Vol. 5, No. 7, pp. 884-892, July 2018);
multi-step high temperature (1150 °C) extended duration annealing processes for lower cladding, core and upper cladding, see for example Dupont “Low loss Silicon Nitride Waveguides for Photonic Integrated Circuits” (Master Thesis, Ecole Polytechnique Fédérale de Lausanne, March 2019); and
a chemical-physical annealing process employing a hydrogen anneal for morphological modification, an oxygen anneal to reduce surface states and a nitrogen anneal to break excess N—H bonds and drive out excess hydrogen, see El Dirani et al. “Ultralow-Loss Tightly Confining Si3N4 Waveguides and High-Q Microresonators” (Optics Express, Vol. 27, No. 14, 30726, October 2019).

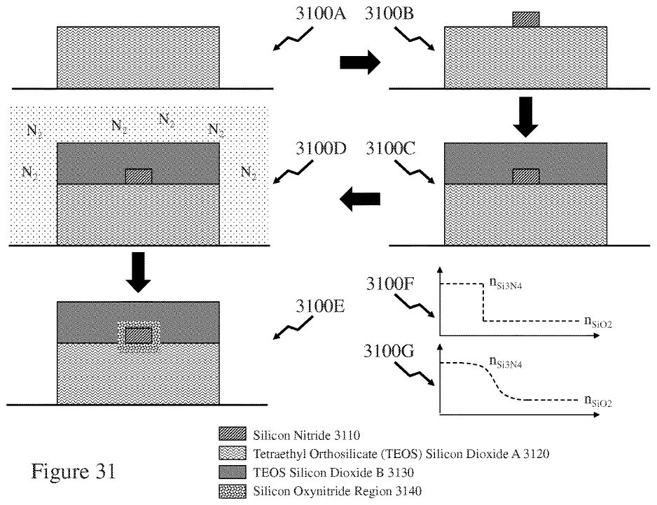

However, the inventors have established an alternate manufacturing process which removes the complications of these prior art techniques which aim to directly induce morphological changes in the silicon nitride core as deposited, patterned, and etched. Referring to FIG. 31 there is depicted an exemplary process flow according to an embodiment of the invention exploiting nitrogen annealing of the upper cladding silicon dioxide of a silicon dioxide-silicon nitride-silicon dioxide waveguide structure. As depicted the exemplary process flow comprises first to fifth images 3100A to 3100E respectively comprising:
First image 3100A wherein a lower silicon dioxide cladding is deposited, such as tetraethyl orthosilicate (TEOS) based Silicon Dioxide A 3120, upon a substrate (omitted for clarity but depicted by the single line under the Silicon Dioxide A 3120);
Second image 3100B wherein a silicon nitride layer, silicon nitride 3110, is deposited and patterned;
Third image 3100C wherein an upper cladding is deposited, TEOS based silicon dioxide B 3130 encapsulating the silicon nitride core;
Fourth image 3100D wherein the structure is exposed to a nitrogen annealing process; and
Fifth image 3100E which depicts the final waveguide structure.

The nitrogen annealing process results in a silicon oxynitride (SiOₓN₁₋ₓ) region 3140 between the silicon nitride core and the upper cladding, formed from TEOS Silicon Dioxide B 3130, and lower cladding, formed from TEOS Silicon Dioxide A 3120. Whilst the exemplary process depicted in FIG. 31 employs TEOS silicon dioxide it would be evident that other silicon dioxide precursors other than TEOS may be employed including, but not limited to, silane (SiH₄) and dichlorosilane (SiCl₂H₂) through deposition techniques including, but not limited to, chemical vapour deposition (CVD), plasma enhanced CVD (PECVD), low pressure CVD (LPCVD), metalorganic chemical vapor deposition (MOCVD), photochemical vapor deposition etc. Alternatively, silicon dioxide may be deposited through other techniques such as spin-on glasses (SOG) for example.

Accordingly, referring to sixth image 300F there is depicted the refractive index profile of the SiO₂—Si₃N₄—SiO₂ waveguide at third step 3100C which is equivalent to a prior art SiO₂—Si₃N₄—SiO₂ waveguide which has a step index profile between the refractive index of Si₃N₄ in the core and the refractive index of SiO₂ in the cladding. In contrast, seventh image 3100G depicts the refractive index profile of the optical waveguide as fabricated according to the exemplary process as depicted in first to fifth images 3100A to 3100E respectively wherein rather than a step index the refractive index profile from the core of the optical waveguide to the cladding exhibits a graded index profile as the material composition varies from silicon nitride, Si₃N₄,-through silicon oxynitride SiO_{X}N_{1-X} to silicon dioxide, SiO₂. As depicted in fifth image 3100E the silicon oxynitride region 3140 is formed all around the waveguide core. It would be evident that the thickness and composition variation of the silicon oxynitride region around the waveguide core is dependent upon the temperature, time, and environment of the annealing together with aspects of the silicon nitride and silicon dioxide layers including, but not limited to, their composition, impurities, densification, density, porosity and morphology.

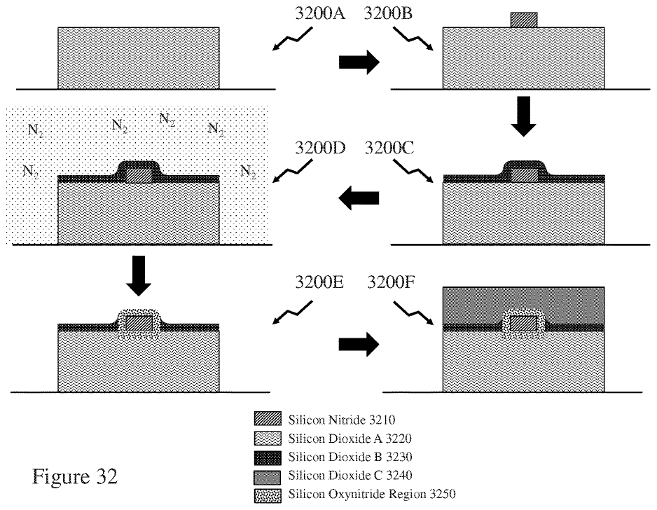

Now referring to FIG. 32 there is depicted an exemplary process flow according to an embodiment of the invention with nitrogen annealing of a thin initial silicon dioxide cladding upon the silicon nitride waveguide core during formation of a silicon dioxide-silicon nitride-silicon dioxide waveguide structure. As depicted the exemplary process flow comprises first to sixth images 3200A to 3200F respectively, comprising:
First image 3200A wherein a lower silicon dioxide cladding is deposited, such as TEOS based Silicon Dioxide A 3220, upon a substrate (omitted for clarity);
Second image 3200B wherein a silicon nitride layer, silicon nitride 3210, is deposited and patterned;
Third image 3200C wherein a thin first upper cladding is deposited, TEOS based silicon dioxide B 3230 encapsulating the silicon nitride core;
Fourth image 3200D wherein the structure is exposed to a nitrogen annealing process;
Fifth image 3200E which depicts the resulting intermediate waveguide structure; and
Sixth image 3200F wherein a second thick upper cladding is deposited, TEOS based silicon dioxide C 3240.

As depicted in fifth and sixth images 3100E and 3100F the silicon oxynitride region 3250 is formed all around the waveguide core. It would be evident that the thickness and composition variation of the silicon oxynitride region around the waveguide core is dependent upon the temperature, time, and environment of the annealing together with aspects of the silicon nitride and silicon dioxide layers including, but not limited to, their composition, impurities, densification, density, porosity and morphology.

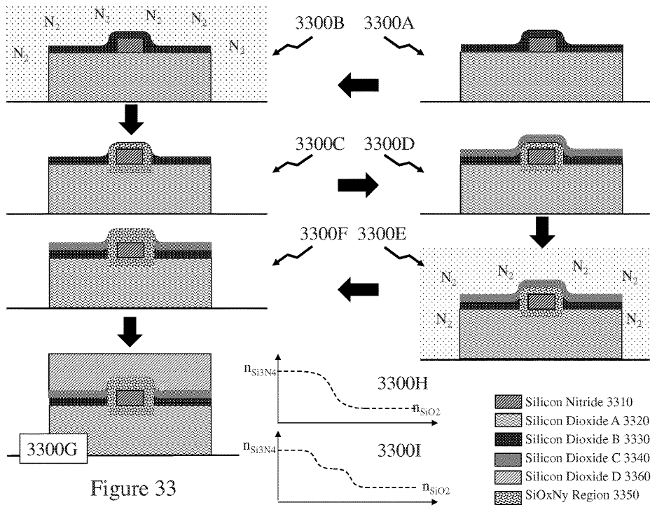

Referring to FIG. 33 there is depicted an exemplary process flow according to an embodiment of the invention with nitrogen annealing of a thin initial silicon dioxide cladding upon the silicon nitride waveguide core and a second silicon dioxide cladding during formation of a silicon dioxide-silicon nitride-silicon dioxide waveguide structure. As depicted the exemplary process flow comprises first to seventh images 3300A to 3300G respectively, comprising:
First image 3300A wherein a lower silicon dioxide cladding has been deposited, such as TEOS based Silicon Dioxide A 3320, upon a substrate (omitted for clarity) followed by deposition and patterning of a silicon nitride layer, silicon nitride 3310, and an initial thin first upper cladding, TEOS based silicon dioxide B 3330 encapsulating the silicon nitride core;
Second image 3300B wherein the structure is exposed to a first nitrogen annealing process;
Third image 3300C wherein a first intermediate waveguide structure is depicted resulting from the first nitrogen anneal such that an initial silicon oxynitride region 3350 is formed around the silicon nitride core;
Fourth image 3300D wherein a thin second upper cladding, TEOS based silicon dioxide C 3340 is deposited;
Fifth image 3300E wherein the structure is exposed to a second nitrogen annealing process;
Sixth image 3300F wherein a second intermediate waveguide structure is depicted resulting from the first and second nitrogen anneals upon the thin first and second upper cladding such that an extended silicon oxynitride region 3350 is formed around the silicon nitride core; and
Seventh image 3300G wherein a thick third upper cladding, TEOS silicon dioxide D 3360 is deposited.

Referring to eighth and ninth images 3300H and 3300I respectively it would be evident that by adjustments in the thickness of the first and second upper cladding layers and/or the first and second nitrogen annealing processes that the refractive index profile from the silicon nitride core to the silicon oxide cladding may exhibit a range of profiles including an essentially Gaussian profile region between the core and cladding such as depicted in eighth image 3300H which is similar to the profile depicted in seventh image 3100G in FIG. 31 or that depicted in ninth image 3300I which is a combination of multiple profiles from the first and second nitrogen annealing steps.

It would be evident that the vertical refractive index profile may according to the films employed, annealing conditions etc. have a similar refractive index profile to that laterally or within other embodiments of the invention it may be different.

It would be evident that within other process flows the final thick third upper cladding may not be required depending upon the total thickness and refractive index profile of the silicon oxynitride region around the silicon nitride core. It would be evident that within other embodiments of the invention three or more deposition/anneal stages may be employed. It would also be evident that considering the process flow depicted in FIG. 33 that according to the thicknesses of the first and second silicon dioxide cladding layers that the third silicon dioxide, Silicon Dioxide D 3360, may be eliminated. Alternatively, this layer may be replaced with a spin-on planarization layer, such as a spin-on glass, a photoresist, polyimide, etc. rather than a deposited film, e.g. a TEOS based silicon dioxide, in order to planarize the structure for subsequent processing steps such as formation of electrodes, photolithography etc.

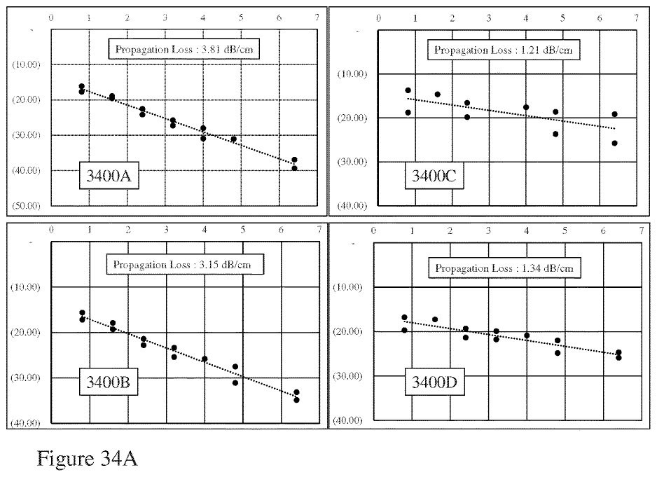

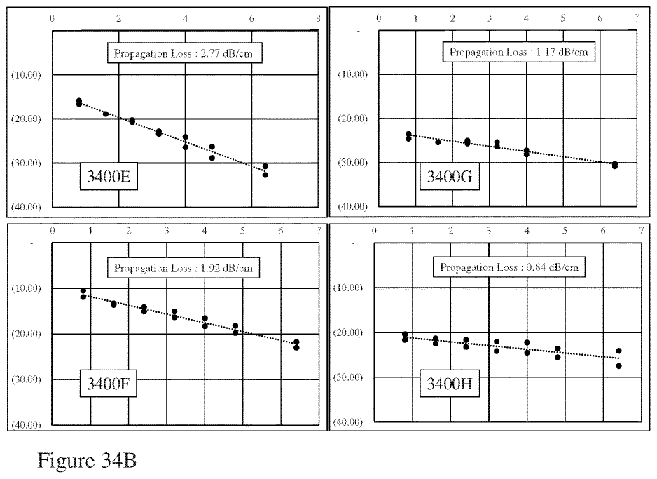

Now referring to FIGS. 34A and 3400B there are depicted experimental results for an exemplary nitrogen based annealing process such as described and depicted in respect of FIG. 31 with a single thick silicon dioxide cladding with respect to a prior art as deposited silicon oxide silicon nitride-silicon oxide waveguide. The as fabricated optical waveguides comprised:
Lower silicon dioxide cladding of nominal thickness 3.3 μm;
Silicon nitride core thickness 450 nm;
Silicon nitride core width 575 nm; and
Upper silicon dioxide cladding of nominal thickness 3.35 μm.

The initial annealing conditions employed with these waveguides comprised:

| | |
|---|---|
| Atmosphere | Dry nitrogen flowing at 250 sscm; |
| Annealing Temperature | 1000°; |
| Dwell at Annealing Temperature | 60-75 mins; and |
| Total Processing Cycle | 14-15 hrs. |

Referring to FIG. 34A there are depicted first to fourth graphs 3400A to 3400D respectively with respect to the prior art as fabricated waveguide and the same waveguide structure annealed according to an exemplary embodiment of the invention. These depict respectively:
First graph 3400A depicts optical loss measurements versus waveguide length for the as fabricated SiO₂—Si₃N₄—SiO₂ waveguide in TE polarization with the C-band (1530 nm-1565 nm) with a propagation loss of approximately 3.8 dB/cm;
Second graph 3400B depicts optical loss measurements versus waveguide length for as fabricated SiO₂—Si₃N₄—SiO₂ waveguide according to an embodiment of the invention in TE polarization in the L-band (1565 nm-1625 nm); with a propagation loss of approximately 3.15 dB/cm;
Third graph 3400C depicts optical loss measurements versus waveguide length for an annealed SiO₂—Si₃N₄—SiO₂ waveguide according to an embodiment of the invention in TE polarization with the C-band (1530 nm-1565 nm) with a propagation loss of approximately 1.2 dB/cm;
Fourth graph 3400D depicts optical loss measurements versus waveguide length for an annealed SiO₂—Si₃N₄—SiO₂ waveguide according to an embodiment of the invention in TE polarization in the L-band (1565 nm-1625 nm); with a propagation loss of approximately 1.35 dB/cm.

Referring to FIG. 34B there are depicted first to fourth graphs 3400E to 3400H respectively with respect to the prior art as fabricated waveguide and the same waveguide structure annealed according to an exemplary embodiment of the invention. These depict respectively:
First graph 3400E depicts optical loss measurements versus waveguide length for the as fabricated SiO₂—Si₃N₄—SiO₂ waveguide in TM polarization with the C-band (1530 nm-1565 nm) with a propagation loss of approximately 2.8 dB/cm;
Second graph 3400F depicts optical loss measurements versus waveguide length for as fabricated SiO₂—Si₃N₄—SiO₂ waveguide according to an embodiment of the invention in TM polarization in the L-band (1565 nm-1625 nm); with a propagation loss of approximately 1.9 dB/cm;
Third graph 3400G depicts optical loss measurements versus waveguide length for an annealed SiO₂—Si₃N₄—SiO₂ waveguide according to an embodiment of the invention in TM polarization with the C-band (1530 nm-1565 nm) with a propagation loss of approximately 1.2 dB/cm;
Fourth graph 3400H depicts optical loss measurements versus waveguide length for an annealed SiO₂—Si₃N₄—SiO₂ waveguide according to an embodiment of the invention in TM polarization in the L-band (1565 nm-1625 nm); with a propagation loss of approximately 0.85 dB/cm.

Accordingly, it is evident from comparing these results that the exemplary nitrogen annealing process according to embodiments of the invention results in a significant reduction in the propagation loss of the SiO₂—Si₃N₄—SiO₂ waveguides in both polarisations wherein in the C-band the optical propagation loss for TE and TM polarisations is reduced by approximately 2.6 dB/cm and 1.6 dB/cm respectively. For the L-band the optical propagation loss for TE and TM polarisations is reduced by approximately 1.8 dB/cm and 0.95 dB/cm respectively. As the annealing process impacts both the lateral sidewalls and the surfaces at the upper and lower boundaries of the silicon nitride core with the upper and lower claddings then improvements are observed for both polarisations.

Accordingly, significant improvements from initial experimental results are evident from FIGS. 34A and 34B respectively. Further improvements are projected as the annealing process for this configuration, depicted in FIG. 31, is further optimized. Improvements are also expected from the configurations of FIGS. 32 and 33.

Within the embodiments of the invention described supra in respect of embodiments of the invention optical waveguides exploiting a silicon nitride core with silicon oxide upper and lower cladding, a SiO₂—Si₃N₄—SiO₂ waveguide structure has been described and depicted together with a silicon core and silicon nitride upper and lower claddings, a Si₃N₄—Si—Si₃N₄ waveguide structure. However, it would be evident that other waveguide structures may be employed including, but not limited to, silica-on-silicon, with doped (e.g. germanium, Ge) silica core relative to undoped cladding, silicon oxynitride, polymer-on-silicon, doped silicon waveguides. Additionally, other waveguide structures may be employed including vertical and/or lateral waveguide tapers and forming microball lenses on the ends of the waveguides via laser and/or arc melting of the waveguide tip. Further, embodiments of the invention have been described primarily with respect to the optical alignment of silicon-on-insulator (SOI) waveguides, e.g. SiO₂—Si₃N₄—SiO₂; SiO₂—Ge: SiO₂—SiO₂; or Si—SiO₂, but it would be evident embodiments of the invention may be employed to coupled passive waveguides to active semiconductor waveguides, such as indium phosphide (InP) or gallium arsenide (GaS), e.g. a semiconductor optical amplifier (SOA), laser diode, etc. Optionally, an active semiconductor structure may be epitaxially grown onto a silicon IO-MEMS structure, epitaxially lifted off from a wafer and bonded to a silicon IO-MEMS structure, etc. However, it would be evident to one skilled in the art that the embodiments of the invention may be employed in a variety of waveguide coupling structures coupling onto and/or from waveguides employing material systems that include, but not limited to, SiO₂—Si₃N₄—SiO₂; SiO₂—Ge: SiO₂—SiO₂; Si—SiO₂; ion exchanged glass, ion implanted glass, polymeric waveguides, InGaAsP, GaAs, III-V materials, II-VI materials, Si, SiGe, and optical fiber. Whilst primarily waveguide-waveguide systems have been described it would be evident to one skilled in the art that embodiments of the invention may be employed in aligning intermediate coupling optics, e.g. ball lenses, spherical lenses, graded refractive index (GRIN) lenses, etc. for free-space coupling into and/or from a waveguide device.

As noted above silicon photonics is a promising technology for reducing the cost structure of various optical components employed within optical networks by leveraging the economies of scale of the microelectronics industry. In the same way as silicon CMOS circuits can be packaged using multiple dies, then in principle so can silicon photonics devices. In order to provide active components either to adjust/correct for manufacturing tolerances or implement components such as reconfigurable optical add-drop multiplexers, optical switches, tunable filters etc. it is necessary to adjust the optical phase of signal propagating within the silicon photonic waveguides. Within the prior art focus has centered upon establishing high frequency interactions through effects such as carrier injection for modulators. However, low frequency or DC control of phase within optical waveguides is important for optical switching, tunable filters, etc. as well as tuning to correct for static phase offsets arising through manufacturing tolerances etc. Accordingly, such phase shifts must be induced and kept (e.g. tuning out fabrication effects) or induced, maintained and then periodically adjusted (e.g. only when a switch, router, add-drop multiplexer reconfigures or an attenuator adjusted). Accordingly, there is a requirement for DC or quasi-DC phase tuning of silicon photonic devices.

Silicon photonics is one of a series of integrated photonic circuit technologies that support optical functions such as modulation, switching, filtering, etc. Within the prior art integrated optical circuits have exploited thermo-optic or electro-optic phase shifter elements. These, however, result in issues such as thermal management of multiple thermo-optic elements within a single integrated optical circuit or power consumption problems due to these elements being power hungry and/or continuously operated.

As also noted above silicon microelectromechanical systems (MEMS) are small integrated devices or systems that combine electrical and mechanical components within a single silicon die, although other material systems may be employed. MEMS devices have leveraged and extended the fabrication techniques developed for the silicon integrated circuit industry, namely lithography, doping, deposition, etching, etc. to add mechanical elements such as beams, gears, diaphragms, and springs to silicon circuits either as discrete devices or in combination with silicon electronics. Accordingly, the manufacturing processes for silicon photonics and MEMS can be combined in what the inventors refer to as integrated optical microelectromechanical systems which combine MEMS elements with optical waveguides.

### A: BACKGROUND

As outlined above a design element of optical devices exploiting optical waveguides and/or silicon photonics is a phase shifter allowing for tuning and control of optical elements. In many instances the number of phase shifter elements is low, e.g. one or two in a Mach-Zehnder based optical protection switch, or moderate. In these instances, the power dissipation of the individual phase shifter elements is not critical to the overall performance of the optical device and/or the optical equipment the optical devices are integrated within.

However, in modern data centers, evolving requirements for dynamic optical resource allocation, configuration and/or reconfiguration require implementation of high-density optical switches. As the number of nodes (e.g. servers) to which these optical resources are connected can be in the thousands, tens of thousands to hundreds of thousands then the overall functionality of the optical switching within the data center can rapidly evolve to a distributed network of optical switch matrices, e.g. 8×8, 16×16, 32×32, etc. optical switch matrices, where the number of optical switch matrices may be hundreds, thousands or tens of thousands. Consequently, it is desirable for these optical switch matrices to have small footprint, be energy efficient and low cost which is a competitive advantage of optical waveguide based switching over free space optical switches.

The overall power consumption of an optical switch matrix is a direct function of both the number of individual 2×2 cells used to implement it and the power consumption of each switch element within the optical switch matrix. The number of optical switches within an optical switch matrix can itself be a function of both size of the optical switch matrix, e.g. N×M where N and M may be 8, 16, 32, 64, etc., and the degree of blocking of the optical switch matrix, e.g. strictly non-blocking or re-arrangeably non-blocking, where different design methodologies can be employed to reduce the overall number of switches from that of a strictly non-blocking switch matrix. For example, a strictly non-blocking switch employs N₂ switches whilst a re-arrangeably non-blocking Benes switch uses Nlog₂(N)−(N/2) switches with other architectures such as Clos networks between these limits. For N=32 the number of 2×2 switches is therefore 1,024 in the strictly non-blocking switch and 144 in the Benes switch.

Accordingly, within a data center the number of 2×2 optical switch elements may easily exceed tens of thousands or hundreds of thousands with lager data centers potentially requiring millions of 2×2 switch elements. With prior art thermo-optic (TO) phase shifters typically consuming several at least ten milliwatts in “hero” experiments to tens or hundreds of milliwatts typically these devices would lead to an unacceptable level of power consumption overall for the data center.

Further, within a 2×2 optical switch (cell) exploiting a Mach-Zehnder architecture typical geometries are several millimeters in length to accumulate the required 180 degrees (π radians) of phase shift for enacting the transition from the cross state of the optical switch to the bar state (or vice versa). Such geometries are typically not compact enough to enable matrices incorporating tens if not hundreds of 2×2 cells to be integrated within an acceptable chip die size suitable for implementing cost effective 8×8 or 16×16 or 32×32 optical switches in a single die.

Accordingly, minimizing the footprint and the power consumption of a 2×2 cell directly impacts both the carbon footprint and the overall power consumption of a data center potentially making use of many optical switches, each containing a plurality of 2×2 cells.

Within optical waveguides a variety of effects can be employed according to the material system exploited, e.g. electro-optic effect, magneto-optic effect, thermo-optic effect. It is widely recognized that the thermo-optic effect can be utilized to implement a compact and low-power 2×2 cell with a low insertion loss by way of an interferometer embodiment such as a Mach-Zehnder interferometer (MZI), not foregoing other possible embodiments exploiting other functional elements such ring resonators, etc. Within optical waveguides such as those exploiting silicon (commonly referred to as silicon photonics), the thermo-optic effect is widely accepted as the result of a change in the effective index upon varying temperature, which directly affects the group velocity experienced by different optical modes propagating within the waveguides as a function of their various many possible geometries.

Accordingly, it would be beneficial to improve the efficiency of the thermo-optic effect within a 2×2 optical switch cell to lower the power consumption of the 2×2 switch cells from tens of milliwatts per 2×2 cell to single digit milliwatts or below into hundreds of microwatts per 2×2 cell.

### B: Thermal Delays, Phase Shifter Structures and Methods

During experiments performed on optical waveguides employing a silicon nitride core (Si₃N₄) with silicon oxide (SiO₂) upper and lower cladding, a SiO₂—Si₃N₄—SiO₂ waveguide structure or what the inventors refer to as an oxide-nitride-oxide (ONO) waveguide, it was established that by applying sufficient power to a thermal heater to change the local temperature in the ONO waveguide that induced local temperature variations from 25 °C to 350 °C could be achieved. In these experiments the inventors established that the transverse electric (TE) optical mode within the ONO waveguide experienced an approximately 0.38% change in effective index, increasing from around 1.690 to approximately 1.697, for optical signals at telecom wavelengths.

Optical material science theory has long established the relationships between a material's coefficients of thermal expansion (CTE), polarizability, and refractive index, and their dependence to temperature. For example, Potter et al. in “Optical Materials” (ISBN 9780128226490, Elsevier, 2021) shows that the effect of temperature on the refractive index at infrared wavelengths depends upon two counteracting phenomena. The first one is the increase in specific volume upon increasing temperature for materials with a positive CTE, which decreases the refractive index. The second one, and generally more dominant contributor, is the increase in polarizability with increasing temperature, which transfers to an increase in refractive index. Accordingly, it is the difference between these two effects which determines the net behavior of the refractive index against temperature for any given material. Equations (2A) to (2C) below describe this relationship between the coefficient of thermal expansion and the polarizability and the resulting variation of the refractive index with temperature where P is the polarizability of the material, Φ the change in polarizability, T temperature, My the molar volume, CTE the coefficient of thermal expansion and n the refractive index.

$$Φ = \frac{1}{P} ( \frac{d P}{d T} ) \qquad ( 2 A )$$

$$CTE = \frac{1}{{M}_{V}} ( \frac{d {M}_{V}}{d T} ) \qquad ( 2 B )$$

$$\frac{d n}{d T} = \frac{( {n}^{2} - 1 ) ( {n}^{2} + 2 )}{6 n} [ Φ - C TE ] \qquad ( 2 C )$$

At telecom wavelengths of 1260-1650 nm, an increase in temperature will cause an effective index change that is positive both in silicon dioxide and in the much denser silicon nitride because the polarizability of their covalent bonds increases. In contrast, materials such as polymers, with high positive CTE values, will exhibit a negative change in index with increased temperature, since in those cases, the refractive index arising from CTE is the dominant factor.

Following this logic, the inventors ONO waveguides are expected to display a positive change in refractive index with increasing temperature at telecommunications wavelengths of 1250-1650 nm, owing to their low but positive coefficient of thermal expansion (CTE). Indeed the materials employed for these waveguides, silicon dioxide (SiO₂) and silicon nitride (Si₃N₄) have low, but positive CTE values, of 5.6×10⁻⁷ and 1.4×10⁻⁶ 1.4 E−6 respectively. Accordingly, Potter states that in materials with low CTE the increased polarizability at higher temperatures dominates by an order of magnitude the smaller negative component of the refractive index change caused by the volumetric expansion thereby yielding a net positive refractive index increase.

Accordingly, the inventors conclude that the positive refractive index change observed in ONO waveguides could be amplified were it possible to eliminate the small relative decrease in refractive index imparted by the CTE. Such amplification could be further enhanced by waveguide architectures and/or material selections which leverage stress as an adjunct to the thermo-optic effect.

Whilst an overall change in the ambient temperature of the die for an optical waveguide device will induce a thermo-optic effect globally to the entire optical waveguide device, the requirement for discrete phase control of waveguides within each 2×2 optical switch etc. means that is desirable to adjust the phase of optical modes within a specific waveguide without, ideally, affecting other nearby waveguides. It is known in the prior art that employing one or more heaters placed above or in proximity to the core of a given optical waveguide is an effective approach to change the local effective index. This allows for phase shifts to be induced with improved efficiency and spatial selectivity while ensuring that the radiative heat from the heater is “sunk”, e.g. into the substrate, before reaching nearby waveguides where it could change their effective index unintentionally. Within a balanced arm 2×2 MZI cell, the thermo-optic effect upon increasing the temperature on one arm of an MZI (or the differential temperature between both arms) can change the effective index enough to achieve the 180-degree (π radians) phase shift required to effect a change from the default cross state to the bar state (or vice-versa).

Within the context of a 2×2 optical switch cell implemented by way of balanced Mach-Zehnder Interferometer (MZI), the inventors consider two figures of merits for the efficiency of the thermo-optic effect. The first is the overall power consumption of all the thermo-optic phase shifters present within the balanced MZI to bias it into its intended default cross or bar state (Power to the Default State or P-default). This state corresponds to a thermal compensation of any/all offsets imparted by fabrication tolerances. The second is the overall power consumption of all thermo-optic phase shifters present within the balanced MZI to intentionally attain a desired switched state (cross or bar) after imparting a 180-degree (π radians) phase shift using push, pull or push-pull drive configurations (Power to the Switched State, or P-switched).

Further to this, the notion of overall power consumption in a complete system must necessarily extend to the complexity of the control electronics necessary to drive the thermo-optic phase shifters. This includes monitoring and holding the bias voltages and current levels steady to maintain the P-default and P-switched states across all 2×2 optical switch cells of the entire optical switch system and across the entire temperature range of operation of a complete system.

The power consumption of 2×2 waveguide-based optical switch cells in their switched state has been the subject of significant published research over the last 20 years over multiple platforms including, but not limited to, polymers, lithium niobate, lead zirconate titanate (PZT), silicon, silicon dioxide, silicon nitride, indium phosphide, gallium arsenide and over various control mechanisms including thermo-optics and electro-optics. However, from reviewing this prior art the inventors note that there has been little work on the power consumption of the entire optical switch system that includes control electronics for maintaining the optical switch in either its P-default or P-switched states. The same conclusion is reached concerning the overall driver power consumption to achieve the switching either for discrete switches or across a plurality of switch cells forming an entire optical switch system. Such analysis if it existed, would show an overall system benefit from switch matrices employing SiN waveguides over those using silicon in holding both of the P-default and P-switched states arising from the relaxed tolerances on the precision of the current required to keep the switches in proper bias at their intended state.

Furthermore, the inventors note that the assessment of performance for a complete system should consider additional figures of merit related to the overall insertion and polarization-dependent losses, as well as bandwidth of the optical switch system as these may call for overall design tradeoff, within embodiments of the invention, between optical performance and electrical performance.

Accordingly, the inventors established through their analysis that an appropriate selection of the waveguide materials leads to switch designs with a high efficiency thermo-optic effect for switching state changes but also, and most importantly, with lowered overall power consumption for maintaining the 2×2 optical switch cells in either the P-default or P-switched states. This is in spite of the fact that silicon nitride (SiN) has a lower thermo-optic coefficient than silicon.

Further to this, the inventors have established that through an appropriate selection of the materials employed within the optical waveguides etc. exploiting the thermo-optic effect on a 2×2 optical switch, for example, that mechanical effects can be leveraged in parallel with the thermo-optic effect thereby leading to an improvement of the power consumption figures of merit for the P-default and P-switched states.

Indeed, the inventors, through their experience with microelectromechanical systems (MEMS) process flows and understanding of the power efficiency of stretching suspended silicon-rich or stochiometric silicon nitride waveguides (silicon nitride integrated photonics), have therefore sought to improve of the performance of thermo-optic devices in silicon photonics by exploiting mechanical deformation in parallel to the thermo-optic effect by using electrostatic and/or thermal expansion forces. An exemplary use-case of this enhancement may be found within a Mach-Zehnder Interferometer where it would help to attain the necessary 180 degree (π radians) phase shift for a change from the cross to the bar state or vice-versa.

Within the following descriptions, embodiments of the invention are presented with respect to silicon nitride being employed as the waveguide core material of a mechanically enhanced thermo-optic phase shifter element within an MZI. However, it would be evident to one of skill in the art that the design processes, design methodologies and designs may be employed with other waveguide geometries and/or material systems in addition to providing phase shifter elements for other optical circuit elements.

As will be presented below in Section C, the inventors have implemented phase shifters elements in an ONO-waveguide-based Mach-Zehnder interferometer (MZI) by suspending and stretching one of the two arms using a MEMS actuator. Accordingly, the inventors are leveraging the impact of physically altering the path length imbalance between the two arms of an MZI as a means to effect a set phase shift as opposed to simply slowing down photons on one arm by way of increasing the temperature of one arm in relation to the other arm. The inventors conclude to the possibility of combining both the effects of physical elongation and of the thermo-optic effect stemming from polarizability on the same arm of an MZI to further reduce the power consumption required relative to a conventional thermo-optic MZI heated up to a set phase shift.

The mechanical enhancement of the thermo-optic effect can also be achieved in silicon nitride waveguide cores clad in compressive silicon dioxide. Refractive index generally increases following compressive stress build up in optical materials. The same trend may be observed upon releasing or counteracting tensile stress. Mechanical enhancement can therefore be engineered by selecting core and clad material couples and their initial state of stress, especially that of the core material, such that CTE mismatch between the core and clad leads to refractive index variations of same sign than the one imparted by the polarizability variation. In the ONO material stack of the inventors, the silicon nitride is initially in a state of medium tensile stress of a few hundreds of MPa while symmetrically clad in approximately 3.2 μm of silicon dioxide. Upon heating, the initially tensile silicon nitride core will try to expand with a rate that is about 3 times larger than the silicon dioxide cladding, gradually being compressed by the latter, hence decreasing its tensile stress.

Following the logic expressed above, the refractive index of the silicon nitride should increase as the tensile stress is being counteracted by the relative compression the silicon dioxide clad exerting upon it. This increase in refractive index is concurrent with the one imparted by the increasing temperature, thereby providing a mechanical, stress-related enhancement to the thermo-optic effect. Unlike, in conventional silicon integrated photonics (silicon photonics) which employs silicon as a waveguide core in silicon nitride integrated photonics, the core of the optical waveguide is usually formed by way of chemical vapor deposition of silicon nitride upon a bottom cladding layer, usually of silicon dioxide, upon a substrate, with subsequent patterning, etching and over cladding. The nature of the silicon nitride core can be silicon rich (Si_{X}N_{Y}) or stochiometric (Si₃N₄). The substrate can be the device layer of a silicon on insulator wafer or a portion (e.g. what is known as the handle portion) of a thermally oxidized bulk silicon wafer.

In order to obtain low optical propagation loss in silicon nitride waveguides, higher tensile stress silicon rich silicon nitride (600 MPa) or ultra-high tensile stress stochiometric Si₃N₄ (1 GPa) is employed by way of high-temperature deposition processing. The high-temperature process and possible subsequent annealing being employed to reduce the hydrogen present in the process of converting the silane precursor to the silicon nitride film formation as hydrogen is known to severely attenuate optical propagation at telecom wavelengths of interest (e.g. 1260-1650 nm) as defined by the cut-off frequencies of standard silica single mode optical fiber.

When the integrated optics waveguide is released from the substrate, for example from a handle layer (bulk wafer) or device layer (the silicon layer of a silicon-on-insulator (SOI) wafer) through an isotropic etching or any other kind of undermining process the core-clad material couple becomes both mechanically and thermally independent of the silicon allowing for the enhancements mentioned above to be increased. Typically the cladding layer of the optical waveguide is approximately 3.5 microns thick and has the same density as the stoichiometric SiO₂ from their formation via tetraethyl orthosilicate (TEOS).

Within embodiments of the invention the optical waveguide stack may be released from the substrate through a sacrificial layer such that the region below the suspended beam and the substrate forms a cavity such as described below. Whilst the descriptions below describe a waveguide core discretely or in combination with an upper cladding atop a lower cladding and/or mechanical support within other embodiments of the invention the mechanical support (e.g. mechanical layer 3550 in FIGS. 2A and 2B respectively) may be omitted.

Releasing an arm of a MZI arm, but maintaining a connection between the suspended beam and the substrate by employing a series of springs can improve the performance of the thermo-optic phase shifter by introducing a mechanical component into the thermo-optic phase shifter thereby making the thermo-optic phase shifter more efficient. The springs allowing channeled expansion/contraction of the suspended beam whilst restraining it one or more other axes. Whilst the designs described and depicted are with respect to an ONO waveguide upon silicon the design methodology could be applied in any waveguide material systems exhibiting a tensile stress component within the thermo-optic phase shifter.

The inventors also note that the series of springs designed and implemented into the suspended silicon dioxide membrane supporting the tensile silicon nitride waveguide core, within an arm of an MZI (or both arms), allow heat sinking relative to an isolated suspended beam. Such heat sinking will allow increased dissipation to the substrate upon deactivating the heaters. In this manner, the thermal time constant of the thermo-optic phase shifter is reduced from that where the suspended waveguide and membrane are solely surrounded by air which behaves like an insulator. As such the springs provide a lower thermal resistance path allowing improved heat conduction while maintaining a good degree of thermal insulation compared to a fully anchored design.

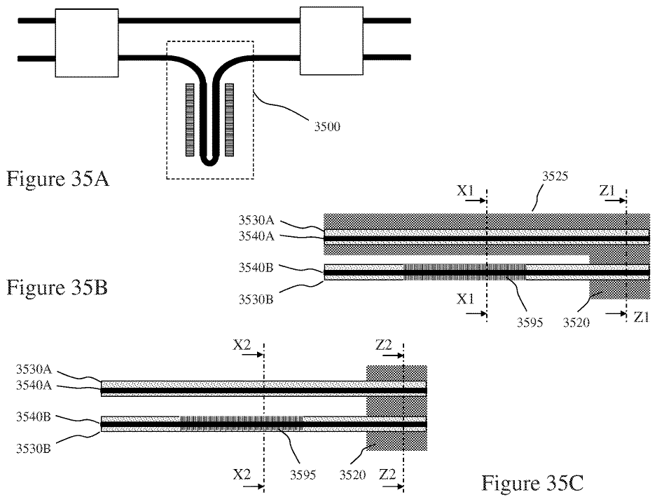

Referring to FIG. 35A there is depicted an exemplary configuration of a 2×2 Mach-Zehnder interferometer (MZI) according to an embodiment of the invention exploiting a thermo-optic phase shifter. As depicted a thermo-optic phase shifter (TOPS) element 3500 is disposed on one arm of the MZI where it can impart a differential phase shift with respect to the other reference arm.

Within the following FIGS. 35B to 41D the optical waveguides are described and depicted as comprising a lower cladding and a core. Accordingly, within these embodiments of the invention the waveguides exploit an air cladding. However, it would be evident that within other embodiments of the invention the waveguides may exploit an upper cladding such as described above with the ONO waveguide geometry employing a silicon oxide lower cladding, a silicon nitride core and a silicon oxide upper cladding. It would be evident to one of skill in the art the geometry of the optical waveguide may vary according to the material system it is implemented in and the specific materials employed without departing from the scope of the invention as defined by the claims.

Now referring to FIGS. 35B and 35C there are depicted exemplary designs for the optical waveguides within the reference arm and tuning arm of the MZI, the tuning arm incorporating the TOPS 3500. Referring to FIG. 35B a first geometry is depicted from a top view wherein a first waveguide comprising a first core 3540A atop a first lower waveguide cladding 3530A. The first waveguide runs along a non-suspended portion 3525 of the device. This first waveguide forming the reference arm of the 2×2 MZI in FIG. 35A, it does not comprise the TOPS 3500.

A second waveguide is depicted forming part of the tuned arm of the 2×2 MZI in FIG. 35A with the TOPS 3500. The second waveguide comprising a second core 3540B atop a second lower waveguide cladding 3530B wherein the second (suspended) waveguide runs unsupported from an anchor 3520 so that it can expand/contract without additional stress being induced by its being disposed between a pair of anchors 3520. As will be evident in subsequent figures the waveguide on the suspended portion with the TOPS 3500 is a loop such that optical waveguide can couple at each end to the remainder of the MZI but freely extend. The TOPS within the tuned arm is comprised of one or more heaters 3595 disposed upon the second lower waveguide cladding 3540B.

Referring to FIG. 35C a second geometry is depicted wherein a first waveguide comprising a first core 3540A atop a first lower waveguide cladding 3530A which runs along a suspended portion of the device. The first waveguide forming the reference arm of the 2×2 MZI in FIG. 35A without the TOPS 3500. A second waveguide is again depicted forming part of the tuned arm of the 2×2 MZI in FIG. 35A with the TOPS 3500. The second waveguide comprising a second core 3540B atop a second lower waveguide cladding 3530B wherein the second (suspended) waveguide runs unsupported from an anchor 3520 so that it can expand/contract without additional stress being induced by its being disposed between a pair of anchors 3520. As will be evident in subsequent figures the waveguide on the suspended portion with the TOPS 3500 is a loop such that optical waveguide can couple at each end to the remainder of the MZI but freely extend. The TOPS within the tuned arm is comprised of one or more heaters 3595 disposed upon the second lower waveguide cladding 3540B.

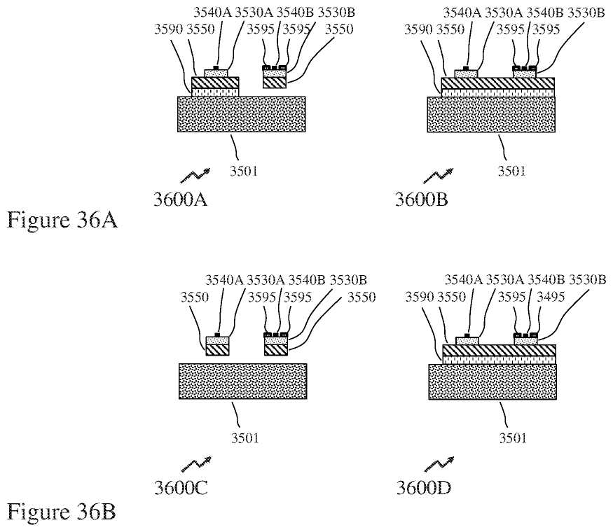

Now referring FIGS. 36A and 36B there are depicted the indicated cross-sections of the thermo-optic phase shifter elements according to embodiments of the invention employing suspended beams depicted in FIGS. 35B and 35C respectively. Referring initially to FIG. 36A there are depicted first and second cross-sections 3600A and 3600B along sections X1-X1 and Z1-Z1 of the geometry depicted in FIG. 35B. Accordingly, in first cross-section 3600A along X1-X1 there is depicted the first waveguide core 3540A and first lower waveguide cladding 3530A atop a mechanical layer 3550 which is coupled to the substrate 3501 by layer 3590. Accordingly, the layer 3590 mechanically supports the mechanical layer 3550 such that this portion is the non-suspended portion 3525 depicted in FIG. 35B. Also depicted are second waveguide core 3540B and second lower waveguide cladding 3530B atop the mechanical layer 3550 which is now isolated from the substrate 3501 thereby forming a suspended waveguide portion depicted in FIG. 35B.

In second cross-section 3600B along the section Z1-Z1 the mechanical layer 3550 is now continuous between the first and second waveguides and supported by the layer 3590 such that both the waveguide portions are non-suspended waveguides at this point. Now referring FIG. 36B there are depicted first and second cross-sections 3600C and 3600D along sections X2-X2 and Z2-Z2 of the geometry depicted in FIG. 35C. Accordingly, in first cross-section 3600C along X2-X2 there is depicted the first waveguide core 3540A and first lower waveguide cladding 3530A atop a mechanical layer 3550 which is not coupled to the substrate 3501 by layer 3590. Accordingly, the first waveguide is upon a suspended portion of the device as depicted in FIG. 35C. Also depicted are second waveguide core 3540B and second lower waveguide cladding 3530B atop the mechanical layer 3550 which is now isolated from the substrate 3501 thereby forming another suspended waveguide portion. In second cross-section 3600D along the section Z1-Z1 the mechanical layer 3550 is now continuous between the first and second waveguides and supported by the layer 3590 such that both the waveguide portions are non-suspended waveguides at this point. The heater is also depicted as comprising two elements one either side of the second waveguide core 3540B.

Within embodiments of the invention a heater may be formed beside the waveguide core(s) on the lower cladding, beside the waveguide core(s) on an upper cladding (when implemented), be embedded within the waveguide, be disposed upon the sides of the waveguide and/or mechanical layer, formed upon the bottom of the mechanical layer, formed between the mechanical layer and the lower waveguide cladding or other variants thereof. Within some embodiments of the invention the heater may be formed as part of the optical waveguide by varying an aspect of the waveguide, e.g. doping, material composition. Optionally, depending upon the electrical characteristics of the mechanical layer which may locally varied through doping for example the mechanical layer itself may form the heater(s).

Within the embodiments of the invention depicted in FIGS. 35A to 36B and subsequently in Section C in FIGS. 8A to 9B, a mechanical layer is depicted supporting the lower waveguide cladding, waveguide core, heaters(s) and (if implemented) the upper cladding. This may for example be a silicon layer where the waveguides are formed upon a silicon-on-insulator (SOI) wafer such that the layer 3590 is the insulator layer which can be selectively isotropically etched to release the suspended waveguide portions and any MEMS structures formed within the devices. It would be evident to one of skill in the art that, depending upon the mechanical properties of the lower cladding and its geometrical design, with considerations for the core layer and/or an upper cladding layer (when present), the mechanical layer 3550 may be omitted within other embodiments of the invention.

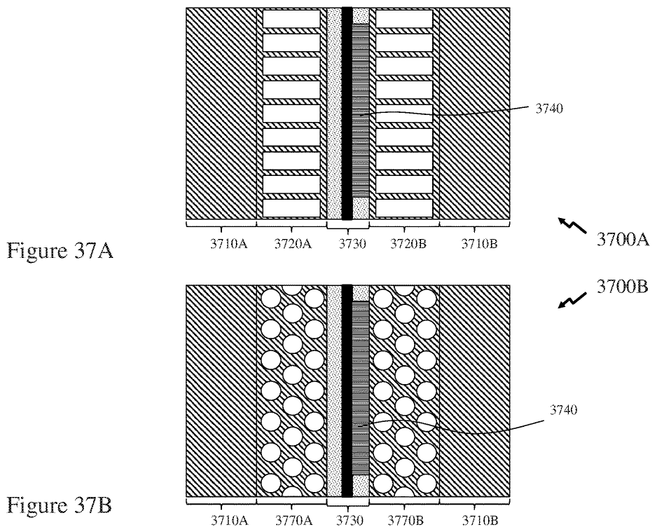

As discussed above the inventors have established that the suspended waveguide portion may, rather than being isolated except at an end from the substrate, be coupled to the substrate through a membrane. Referring to FIGS. 37A and 37B there are depicted thermo-optic phase shifter elements according to embodiments of the invention employing suspended beams with linkages to non-suspended portions of the optical device employing the phase shifter elements. Referring FIG. 37A there is depicted a non-suspended portion of the device 3710A, another non-suspended portion of the device 3710B and a suspended waveguide portion 3730 disposed in between coupled to these via first and second membranes 3720A and 3720B, whereby holes or voids 3750 have been micromachined providing flexures for suspended waveguide portion 3730 to move. As noted above, the suspended waveguide portion when isolated in air has a high thermal resistance such that when the heater power is reduced the time constant of the suspended waveguide portion cooling is long. The only path for thermal loss other than through the surrounding air being the small portion of the suspended waveguide portion coupled to the non-suspended portion of the device where typically a narrow thin geometry presents a high thermal resistance as well.

Accordingly, first and second membranes 3720A and 3720B provide openings through which the underlying layer (e.g. layer 3590) is removed through one or more processes according to the material(s) forming the layer 3590, including isotropic etching for example, to release the suspended waveguide portion. As depicted these openings provide a series of beams connecting the suspended waveguide portion 3730 to the non-suspended portion of the device 3710A and another non-suspended portion of the device 3710B. The beams acting as flexures allow the suspended waveguide portion 3730 to expand longitudinally with respect to the non-suspended portion of the device 3710A and another non-suspended portion of the device 3710B. The beams may be varied in width to adjust their stiffness. Similarly, where the mechanical layer is provided it may be varied in material, material composition, thickness etc. to also tune the stiffness of the flexures so that they support motion of the suspended waveguide portion without inducing additional mechanical strains, deformations, etc. Disposed upon the suspended waveguide portion 3730 is a heater 3740.

In FIG. 37B the same basic structure is depicted where the suspended waveguide portion 3730 is now connected to the non-suspended portion of the device 3710A and another non-suspended portion of the device 3710B via first and second membranes 3770A and 3770B respectively. These first and second membranes 3770A and 3770B based upon the design and pattern of holes 3760 providing flexures for suspended waveguide portion 3730 to move but with increased stiffness relative to that of the structure depicted in FIG. 37A. The holes also provide for pathways to isotropically etch of the underlying sacrificial layer (e.g. layer 3590) to release the suspended portion(s).

Within FIGS. 37A and 37B where a mechanical layer is provided the membranes may be formed solely within the mechanical layer or they may be formed within the mechanical layer and additional layers, e.g. lower waveguide cladding, etc. Optionally, within embodiments of the invention the membranes may be formed solely within the lower cladding layer or a stack of materials forming the waveguide where either no mechanical layer is implemented or it is also selectively etched.

FIGS. 38A and 38B depict thermo-optic phase shifter elements according to embodiments of the invention where suspended beams with phase shifter elements employ spring linkages to non-suspended portions of the optical device. Within each of FIGS. 38A and 38B a non-suspended portion of the device 3710A and another non-suspended portion of the device 3710B carry a suspended waveguide portion 3730 disposed between them where these are coupled via first and second membranes 3810A and 3810B in FIG. 38A and first and second membranes 3830A and 3830B in FIG. 38B. In each instance disposed upon the suspended waveguide portion 3730 is a heater 3740.

Referring to FIG. 38A the first membrane 3810A comprises a series of first springs 3820A whilst second membrane 3810B comprises a series of second springs 3820B. The first springs 3820A and second springs 3820B being mirror images relative to an axis of the suspended waveguide portion. Referring to FIG. 38B the first membrane 3830A comprises a series of third springs 3840A whilst second membrane 3830B comprises a series of fourth springs 3840B. The third springs 3840A and fourth springs 3840B not being mirror images of each other relative to an axis of the suspended waveguide portion.

The beams of the springs may be varied in width to adjust their stiffness. Similarly, where the mechanical layer is provided it may be varied in material, material composition, thickness etc. to also tune the stiffness of the flexures so that they support motion of the suspended waveguide portion without inducing additional mechanical strains, deformations, etc.

Within FIGS. 38A and 38B where a mechanical layer is provided the membranes may be formed solely within the mechanical layer or they may be formed within the mechanical layer and additional layers, e.g. lower waveguide cladding, etc. Optionally, within embodiments of the invention the membranes may be formed solely within the lower cladding layer or a stack of materials forming the waveguide where either no mechanical layer is implemented or it is also selectively etched.

Now referring to FIG. 39 there is depicted a thermo-optic phase shifter element according to embodiments of the invention where a suspended beam with the phase shifter element employ spring and non-spring linkages to non-suspended portions of the optical device. Accordingly there is depicted a non-suspended portion of the device 3710A and another non-suspended portion of the device 3710B having a suspended waveguide portion 3730 disposed between them where these are coupled via first and second membranes 3910A and 3910B. First membrane 3910A comprising a series of first springs 3820A and series of non-spring linkages 3920. Second membrane 3910B comprising a series of second springs 3820B and series of non-spring linkages 3920. The non-spring linkages provide flexing in the direction of motion of the suspended waveguide portion under thermal expansion but limit lateral movement. The suspended portion is thermally addressed by heaters 3930 and 3940.

Referring to FIG. 40 there is depicted a thermo-optic phase shifter (TOPS) 4000A according to embodiments of the invention where suspended beam with the phase shifter element employs spring linkages to non-suspended portions of the optical device. As depicted the TOPS 4000 comprises a first portion 4010, a second portion 4020 and a third portion 4030. The first portion is a non-suspended waveguide portion supporting an input waveguide and output waveguide which are coupled to the pair of waveguides on the second portion 4020. The second portion 4020 comprising a central suspended waveguide portion with the pair of waveguides disposed between, and coupled to via springs, a pair of non-suspended portions. Accordingly, operation of the heater(s) results in longitudinal expansion of the suspended waveguide portion. Disposed at the end of the second portion 4020 is third portion 4030 which is another suspended waveguide portion 4040 having a waveguide looping so that it couples from one waveguide on the suspended waveguide portion of the second portion 4020 to the other waveguide on the suspended waveguide portion of the second portion 4020 so that light is coupled from the input to the output on the first portion 4010 with a phase shift induced by the thermo-optic effects imparted by the heater(s).

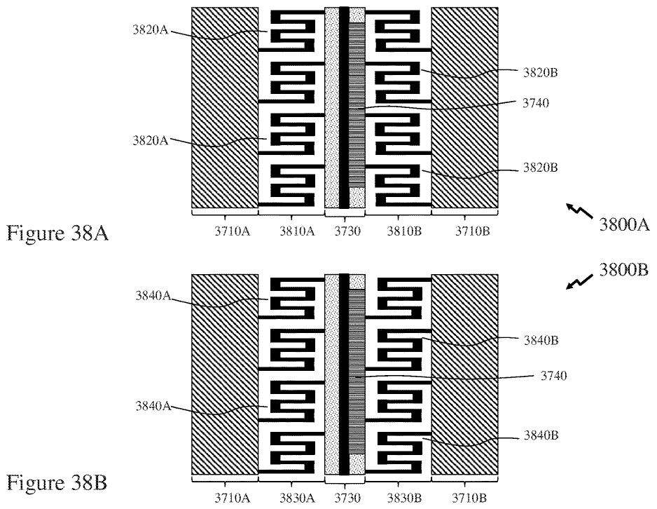

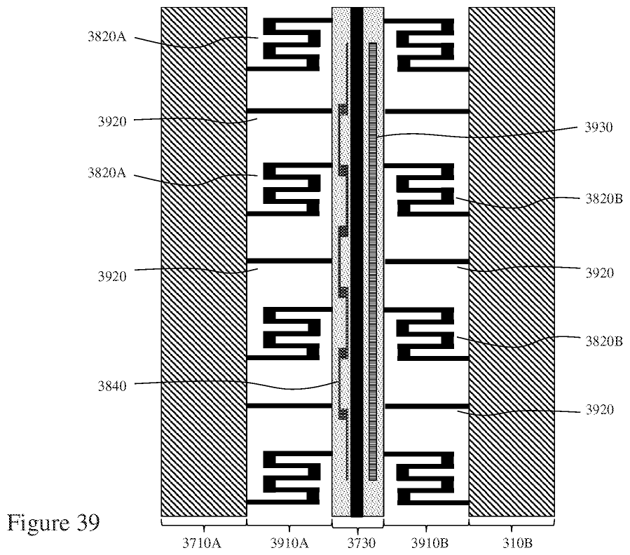

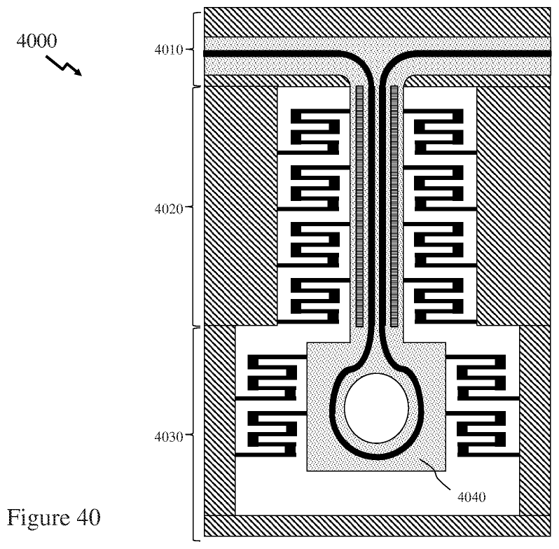

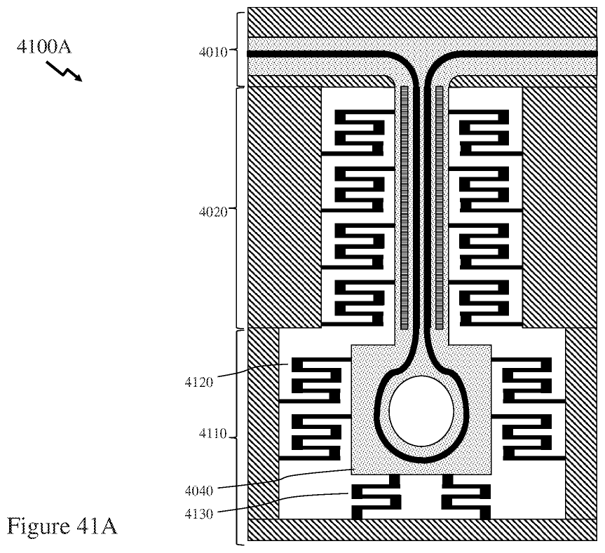

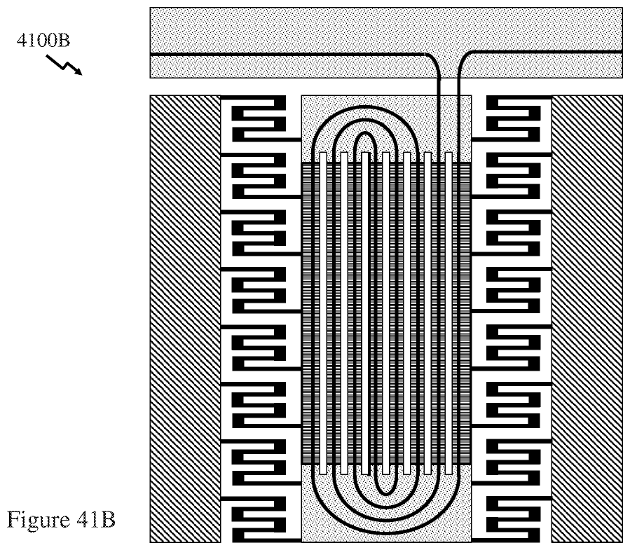

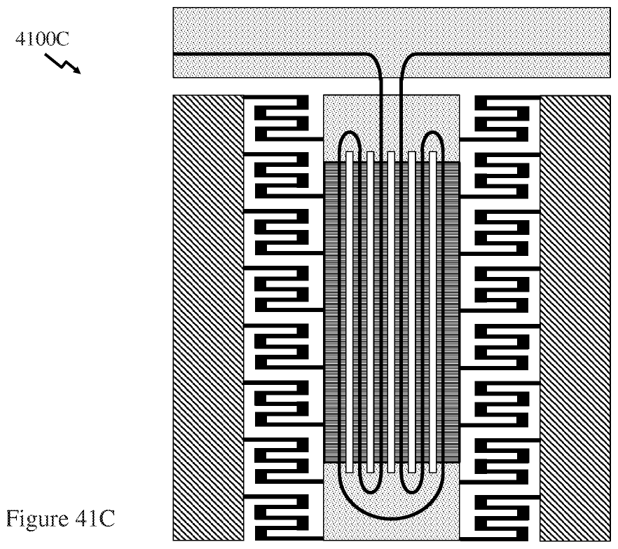

FIG. 41A depicts a thermo-optic phase shifter element 4100A according to embodiments of the invention employing a suspended beam with spring linkages to non-suspended portions of the optical device employing the phase shifter element. The structure depicted in FIG. 41 is structurally similar to that depicted in FIG. 40 except that a further set of springs (or single spring) are coupled from the end of the third suspended waveguide portion 4040 to a non-suspended portion of the device with the springs axis of extension being aligned with that of the extension of the second portion 4020. Optionally, non-spring linkages such as depicted in FIG. 39 may also be added.

FIGS. 41B and 41C depict further variants 4100B and 4100C where the number of “traverses” of the suspended waveguide portion made by the optical waveguide are increased to increase the effective path length. In FIG. 41B the “looped” waveguide is disposed to one side of the input/output waveguides whilst in FIG. 41C it is disposed either side of these waveguides.

Whilst FIGS. 41A to 41C depict suspended portions upon which the phase shifter element is implemented that extends perpendicular to an axis of the non-suspended portion having input and output waveguides coupled to the phase shifter element it would be evident that other orientations and geometries may be employed without departing from the scope of the invention. For example FIG. 41D depicts a geometry where the phase shifter element is substantially parallel to the axis of the of the non-suspended portion having the input and output waveguides. Further, whilst FIG. 41A depicts an elongated beam in a clamped-free (i.e. the clamped end being that rigidly attached to the substrate via the non-suspended portion and the free end being that linked via springs to the substrate via the non-suspended portion and FIGS. 41B and 41C other rectangular geometries it would also be evident that the suspended waveguide portion (i.e. a beam with waveguide disposed atop it or a beam from a waveguide) may have other geometries including, but not limited to, for example a spiral.

Accordingly, the inventors have established novel designs for a phase shifter. For example, they have determined that should one arm of an MZI be suspended by springs rather than with fixed anchors, such springs would allow the volumetric expansion stemming from coefficient of thermal expansion (CTE) to elongate the arm of the MZI suspended by the springs in relation to the other arm of the MZI. The inventors have determined that rather than merely allowing the residual energy from the thermal heater serving the primary purpose of increasing the refractive index through the impact of temperature on polarizability to sink to the substrate, the sinking through springs in the silicon dioxide cladding on the same suspended arm of the MZI, would result in an enhancement of the total phase shift possible within an MZI, at a fixed level of power consumption. The inventors had thus devised a manner to achieve the same level of phase shifting at an overall lower level of power consumption, by allowing a thermo-optic phase shifter to physically elongate one arm of an MZI in relation to the other arm of the MZI, and thus slow down the photons both by way of increasing the refractive index of one arm in relation to the other arm as well as physically increasing the length of one arm in relation to the other arm.

Within a typical design implemented by the inventors for prototypes approximately 90% of the overall phase shift is due to the thermo-optic polarizability effect with the remainder (approximately 10%) being due to the physical elongation of the path using springs rather than anchors suspending one arm of the MZI.

The resulting mechanically enhanced thermo-optic MZI 2×2 cell is more power efficient than one based only on a thermo-optic phase shifter without mechanical contribution to the 180-degree phase shift.

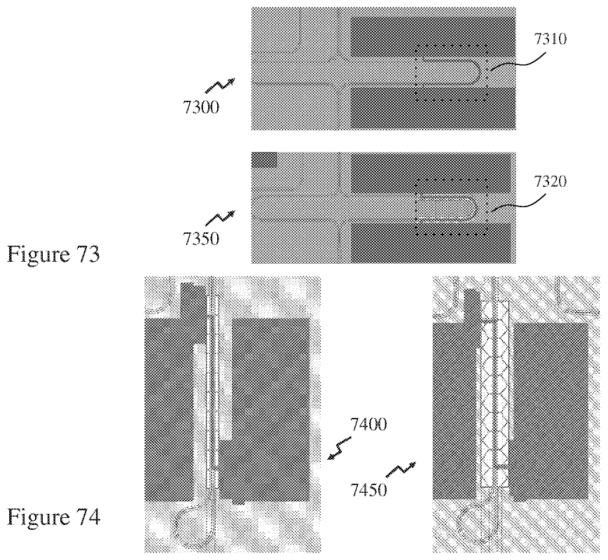

FIG. 73 depicts first and second Schematics 7300 and 7350 of implemented thermo-optic phase shifters with and without a suspended beam according to an embodiment of the invention. The region within the two implemented circuits that differs being Regions 7310 and 7320 which is not suspended in first Schematic 7300 and comprising a suspended beam in second Schematic 7350. The circuit implemented being a 1×2 MZI. The experimental results for the non-suspended design in first Schematic 7300 were an effective shift of the MZI by 1.5 GHz/W for TE and 1.8 GHz/W for TM. In contrast, the suspended design in second Schematic 7350 yielded an effective shift of the MZI of 25 GHz/W for TM. Accordingly, for TM the suspended beam design increased the phase shifting efficiency by approximately 1400%.

FIG. 74 depicts first and second Schematics 7400 and 7450 of implemented thermo-optic phase shifters with suspended beams according to embodiments of the invention. Within first Schematic 7400 the suspended beam with optical waveguide and heater is laterally suspended via 9 straight supports whereas in second Schematic 7450 it is laterally suspended by 9 beams that are coupled to the substrate via Y-joints so that each lateral suspension is attached at two points to the non-suspended portion of the device. The measured efficiencies for the MZI devices with the design of first Schematic 7400 being 47 GHz/W and 40 GHz/W for TE and TM respectively. The measured efficiencies for the MZI devices with the design of second Schematic 7450 being 65 GHz/W and 56 GHz/W for TE and TM respectively, i.e. approximately 40% increase in efficiency for both TE and TM polarisations respectively.

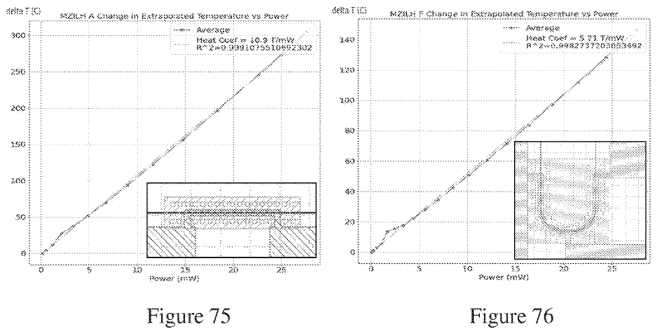

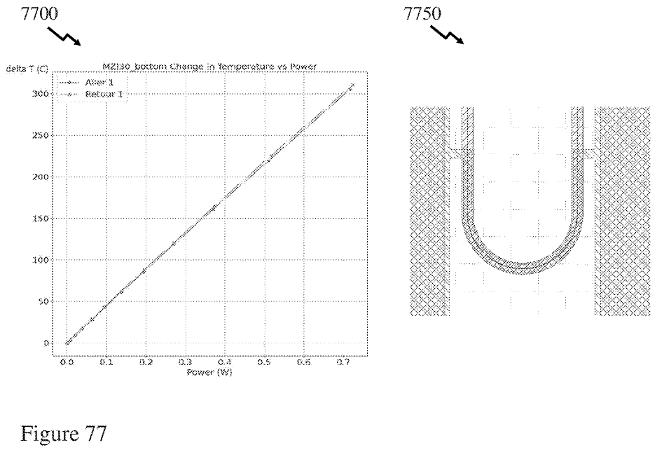

FIGS. 75 and 7642 depict experimental results for thermo-optic phase shifters with suspended beams according to embodiments of the invention with inset schematics of the structures. FIG. 75 depicts a design wherein the phase shifting element is attached at either end to the substrate with a central suspended portion employing circular openings to suspend the waveguide with periodic attachment, such as depicted in FIG. 37B, albeit a single row either side of the waveguide, with a linear heating element disposed along part of the suspended beam. The measured temperature increase of the suspended beam was 10.9 °C/mW such that a temperature increase of 100 °C for phase shifting was achieved with less than 10 mW electrical drive power.

In FIG. 76 there is depicted an alternate design wherein the suspended phase shifter element is a U-shaped design with a suspension again comprising a single row of openings either side of the waveguide such as depicted in FIG. 37B to suspend the waveguide with periodic attachment points. The heater element is similarly U-shaped with three contacts, one at each side of the U-shaped element and a third at the mid-point of the U-shaped element. The measured temperature increase of the suspended beam was 5.2 °C/mW such that a temperature increase of 100 °C for phase shifting was achieved with less than 20 mW drive electrical power.

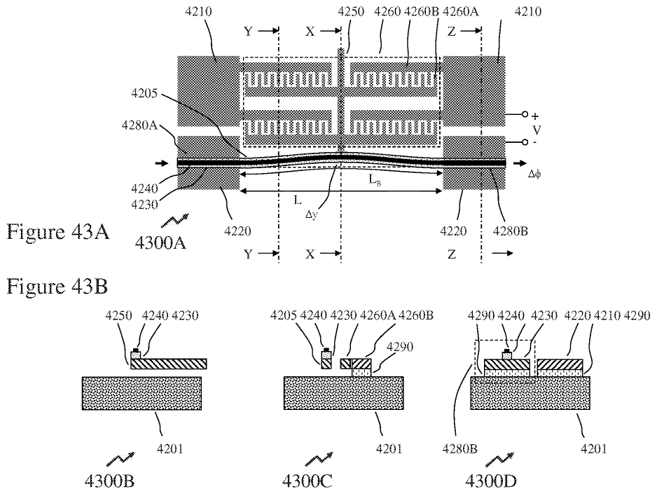

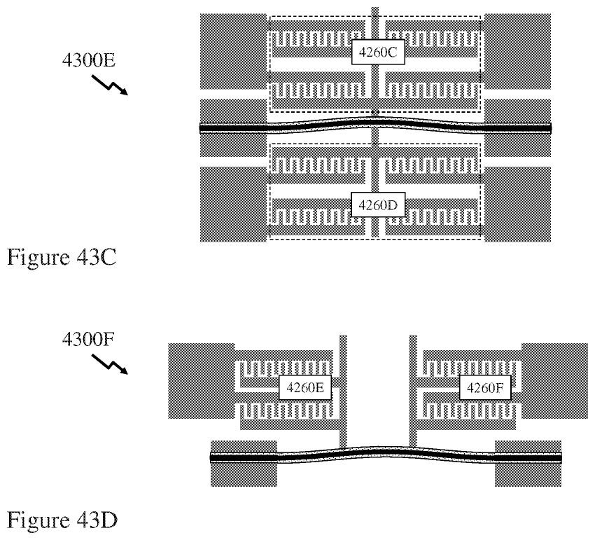

FIG. 43 depicts experimental results 7700 and structural schematic 7750 for a thermo-optic phase shifter without a suspended beam according to the same geometric design of the suspended beam according to an embodiment of the invention in FIG. 76. Accordingly, the measured temperature increase of the suspended beam was approximately 0.44 °C/mW such that a temperature increase of 100 °C for phase shifting required approximately 220 mW. Accordingly, suspension of the thermo-optic phase shifter element results in approximately 1000% efficiency improvement, reducing the required drive power from approximately 2.2 mW/° °C to approximately 0.2 mW/°C.

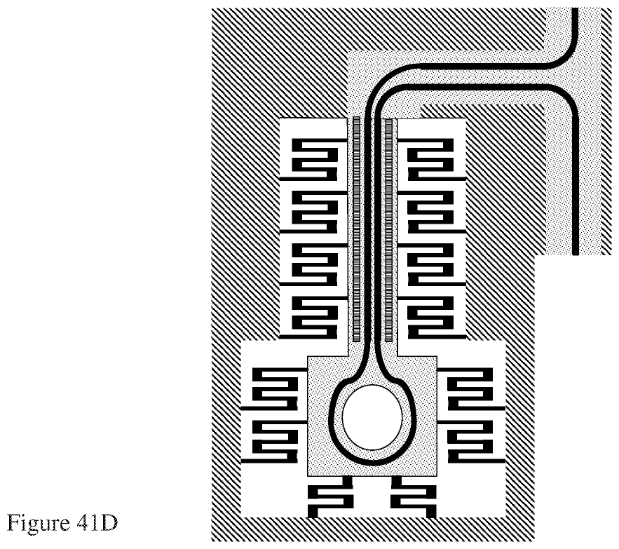

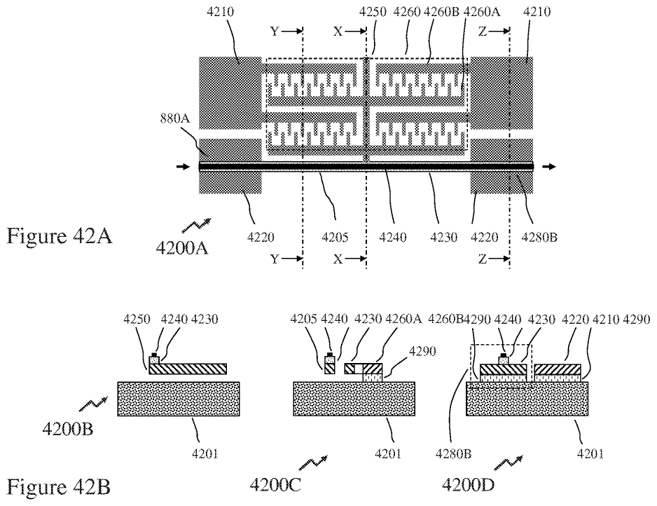

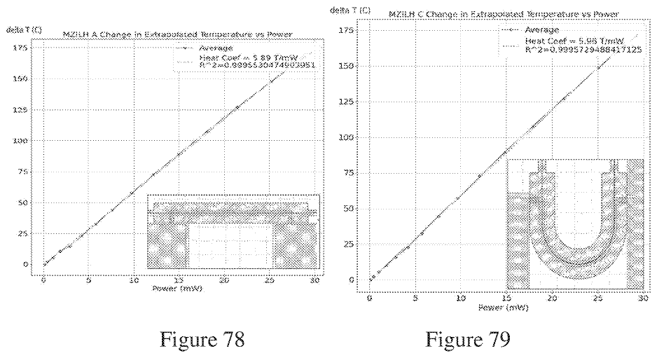

FIGS. 78 and 79 depict experimental results for thermo-optic phase shifters with suspended beams according to embodiments of the invention with inset schematics of the structures. FIG. 78 being a linear suspended beam similar to that depicted in FIG. 41 wherein the resulting measured temperature increase of the suspended beam was 5.9 °C/mW. FIG. 79 being a U-shaped suspended beam similar to that depicted in FIG. 42 wherein the additional layers of the optical waveguide stack (other than the core) now cover a smaller footprint. The resulting measured temperature increase of the suspended beam was 6.0 °C/mW. Accordingly, relative to the 5.2 °C/mW of the design of FIG. 42 the reduction in additional material from the waveguide stack has a smaller effect on the device's efficiency (increasing it from 5.2 °C/mW to 6.0 °C/mW) relative to the suspension of thermo-optic phase shift element increasing it from 0.44 °C/mW to 5.2 °C/mW or 6.0 °C/mW.

Whilst within the embodiments of the invention described above the suspended beams are described and depicted with respect to thermos-optic phase shifting elements for optical circuits. However, within other embodiments of the invention the suspended beams with heaters may be employed within other MEMS devices such as thermally actuated MEMS actuators wherein the suspended beams do not include the additional layers of the optical waveguide(s) atop the suspended beam.

Within the embodiments of the invention described and depicted above the optical waveguide has been depicted as being centrally positioned with respect to the heater as are the upper cladding. However, it would be evident that the placement and design of the heater relative to the waveguide core discretely or in combination to the upper cladding etch may be offset in order to adjust the effective index change for the TE and TM polarizations within the polarization phase shifter.

It would be evident to one skilled in the art that aspects of phase shifters described and depicted below in Section C exploiting MEMS based actuation may be exploited within other embodiments of the invention in conjunction with those of thermo-optic phase shifters. An exemplary schematic of such a combination being depicted within FIG. 72 wherein the MEMS actuator is coupled to the suspended waveguide via springs such that the heater (not depicted for clarity) can provide thermo-optic phase shifting whilst the MEMS actuator can deform the waveguide. The shifting structure of the suspended waveguide being managed by the springs in both axis parallel to and perpendicular (but in the plane of the substate) to the MEMS.

### C: Microelectromechanical Systems (MEMS) Phase Shifter/Delays Structures and Methods

As noted above a variety of effects can be employed within optical waveguides according to the material system employed to induce optical phase shifts. For example, these may be via an electro-optic effect, a magneto-optic effect, or a thermo-optic effect. However, it is also possible to induce the optical phase shift without employing any characteristic of the material system the waveguide is formed from apart from a direct mechanical length change.

Accordingly, as will become evident with respect to embodiments of the invention as described and depicted in respect of FIGS. 8A to 38 that the inventors have established phase shifter elements exploiting MEMS actuators allowing them to be actuated electrostatically, for example, with low-power consumption. Accordingly, the inventors combine MEMS actuators, such as parallel plate or comb actuators, to stretch portions of suspended integrated optics waveguides, thereby creating changes both in their effective index and length to impart optical phase shifts on optical signals propagating within the optical waveguide(s) on beams engaged by the MEMS actuators. The resulting integrated optics micro-electro-mechanical-systems (IO-MEMS) phase shifters can serve to effect a change in optical path sufficient to result in optical phase shifts up to 360 degrees (2π radians). Such IO-MEMS phase shifter elements can be integrated as will be evident from the following embodiments of the invention on suspended waveguide portions or portions of integrated optics circuit, for example, traveling wave resonators or interferometers, such as using on one or both arms of balanced Mach-Zehnder Interferometers (MZI). The resulting IOMEMS-enabled phase shifting devices, e.g. an MZI implemented with either 1×2 or 2×2 couplers on either the input or the output forming an MZI switch unitary cell, have inherent phase tuning capability and can be implemented discretely or nested as part of a tree structure, optical cross-connect etc. enabling extinction ratio tuning, wavelength-dependent routing or even broadband switching for example.

Referring to FIGS. 42A and 42B there are depicted a plan image 4200A and first to third cross-sectional images 4200B to 4200D respectively of a MEMS actuated phase shifter according to an embodiment of the invention in an initial non-deflected state. Accordingly, considering initially plan image 4200A an optical waveguide comprising an input non-suspended portion 4280A upon a waveguide anchor 4220 is coupled to an output non-suspended portion 4280B upon the waveguide anchor 4220 via a suspended waveguide comprising cladding 4230 and core 4240. Coupled to the cladding 4230 is an arm 4250 of a MEMS comb actuator 4260 which comprises moving elements 4260A and fixed elements 4260B which are mechanically connected to anchors 4210. In this structure electrostatic attraction/repulsion by application of potential difference between the moving elements 4260A and fixed elements 4260B results in movement of the moving elements 4260A relative to the fixed elements 4260B and therein motion of the arm 4250 which is mechanically connected to the moving elements 4260A.

Referring to first to third cross-sectional images 4200B to 4200D respectively, these depict cross-sections X-X, Y-Y and Z-Z through the IO-MEMS device according to an embodiment of the invention as depicted in plan image 4200A in FIG. 42A. Accordingly, first cross-sectional image 4200B representing cross-section X-X is through the IO-MEMS device where the arm 4250 joins the cladding 4230. As evident in first cross-section image 4200B the arm 4250, cladding 4230 and core 4240 are disposed above a substrate 4201. The arm 4250 as depicted extending under the cladding 4230 and the core 4240. Next, in second cross-sectional image 4200C representing cross-section Y-Y the cladding 4230 and core 4240 are upon a beam 4205 formed from the same mechanical layer of the device as that of the arm 4250 and MEMS 4260. Also depicted are the moving element 4260A and fixed element 4260B of the MEMS 4260. The fixed element 4260B being attached to the substrate via layer 4290. For ease of depiction second cross-sectional image 4200C depicts only one repeat of the moving element 4260A/fixed element 4260B of the MEMS 4260 whereas in plan image 4200A in FIG. 42A the MEMS 4260 is depicted with a pair of moving elements 4260A and pair of fixed elements 4260B. Third cross-sectional image 4200D representing cross-section Z-Z denotes a cross-section through output non-suspended portion 4280B and anchor 4210. Accordingly, the anchor 4210 is mechanically coupled to the substrate 4201 via layer 4290 as is the output non-suspended portion 4280B comprising waveguide anchor 4220, cladding 4230 and core 4240.

Optionally, the fixed element 4260B may also be suspended and connected to anchor 4210 rather than being attached to the substrate via layer 4290.

Within the embodiment of the invention described and depicted in FIG. 42A and as will be described and depicted with respect to FIGS. 42B to 38 respectively then the material system depicted is:
silicon nitride for the core 4240;
silicon oxide (SiO₂) for the cladding 4230;
silicon for the beam 4250, moving elements 4260A, fixed elements 4260B, waveguide anchors 4220 and anchors 4210; and
silicon dioxide for the layer 4290.

However, it would be evident that other waveguide material systems may be employed in conjunction with silicon based MEMS or other MEMS material systems. For example, the optical waveguide comprising core 4240 and cladding 4230 may be a core 4240 embedded within cladding 4230. Optionally, the beam 4205 may be omitted within other embodiments of the invention. Optionally, the beam 4205 may be formed from an additional layer disposed atop the mechanical material for the beam 4250, moving elements 4260A, fixed elements 4260B, waveguide anchors 4220 and anchors 4210. It would be evident other materials may be employed for layer 4290.

Now referring to FIGS. 43A and 43B there are depicted a plan image 4300A and first to third cross-sectional images 4300B to 4300D respectively of a MEMS actuated phase shifter according to an embodiment of the invention in a deflected state. Accordingly, considering initially plan image 4300A the optical waveguide comprising the input non-suspended portion 4280A upon waveguide anchor 4220 is coupled to the output non-suspended portion 4280B upon the waveguide anchor 4220 via the suspended waveguide comprising cladding 4230 and core 4240. Coupled to the cladding 4230 is arm 4250 of the MEMS comb actuator 4260 which comprises moving elements 4260A and fixed elements 4260B wherein electrostatic attraction/repulsion by application of potential difference between the moving elements 4260A and fixed elements 4260B has resulted in movement of the moving elements 4260A relative to the fixed elements 4260B and therein motion of the arm 4250 which is mechanically connected to the moving elements 4260A. The fixed elements 4260B of the MEMS 4260 being mechanically connected to anchors 4210. Accordingly, motion of the arm 4250 results in distortion of the suspended waveguide comprising cladding 4230 and core 4240 by a defection Δy resulting over a portion of length L_{B} of the optical waveguide where the overall separation between the anchors 4220 is L.

Referring to first to third cross-sectional images 4300B to 4300D respectively these depict cross-sections X-X, Y-Y and Z-Z through the IO-MEMS device according to an embodiment of the invention as depicted in plan image 4300A. Accordingly, first cross-sectional image 4300B representing cross-section X-X is through the IO-MEMS device where the arm 4250 joins the cladding 4230. As evident in first cross-section image 4300B the arm 4250, cladding 4230 and core 4240 are disposed above the substrate 4201 and have been displaced relative to the non-deflected state depicted in second cross-section 4200B of FIG. 42B by movement of the arm 4250 which is depicted extending under the cladding 4230 and the core 4240. Next, in second cross-sectional image 4300C representing cross-section Y-Y the cladding 4230 and core 4240 are upon the beam 4205 formed from the same mechanical layer of the device as that of the arm 4250 and MEMS 4260. Also depicted are the moving element 4260A and fixed element 4260B of the MEMS 4260. The fixed element 4260B being attached to the substrate via layer 4290. The cladding 4230 and core 4240 upon the beam 4205 have been displaced by actuation of the MEMS 4260 as evident by the movement of the moving elements 4260A relative to the fixed elements 4260B. Third cross-sectional image 4300D representing cross-section Z-Z denotes a cross-section through output non-suspended portion 4280B and anchor 4210 wherein the anchor 4210 is mechanically coupled to the substrate 4201 via layer 4290 as is the output non-suspended portion 4280B comprising waveguide anchor 4220, cladding 4230 and core 4240.

Optionally, the fixed element 4260B may also be suspended and connected to anchor 4210 rather than being attached to the substrate via layer 4290.

Accordingly, actuation of the MEMS 4260 as depicted in FIGS. 43A and 43B relative to FIGS. 42A and 42B results in deformation of the cladding 4230, core 4240 and beam 4205 and thereby L_{B}>L. Accordingly, the resulting change in length of the optical waveguide comprising cladding 4230 and core 4240 is ΔL=L_{B}−L which results in a phase shift for an optical signal of Δφ as given by Equation (3) where n_{eff} is the effective index of the optical waveguide and λ is the wavelength in vacuum of the optical signal within the optical waveguide.

Δφ=(2πn_{eff}ΔL/λ) (3)

The beam displacement Δy, i.e. deflection of the optical waveguide at the center of the MEMS phase shifter as depicted in FIGS. 42A to 43B respectively is given by Equation (4) where F is the force of the electrostatic actuator and k is the spring stiffness of the beam (for example beam 4205, cladding 4230 and core 4240 as depicted in FIGS. 42A to 43B respectively). The stiffness for a fixed-fixed beam (i.e. anchored at either end) for a point force at the center of the beam is given by Equation (5A) whilst for a distributed force the stiffness is given by Equation (5B). In each of Equations (5A) and (5B) E is the Young's modulus of the beam, I the beam's second moment of inertia and L the length of the beam. Accordingly, as evident from Equation (4) the displacement is proportional to the applied force and inversely proportional to the stiffness of the beam.

For a comb electrostatic actuator the force per unit length of the comb is given by Equation (6) whilst for a parallel plate electrostatic actuator the force per unit length of the parallel plates is given by Equation (7) where ε₀ is the vacuum permittivity, ¿, the relative permittivity, U the applied voltage, h the height of the conductive part of the actuator, m the width of an actuator finger, g the gap between fingers and H the gap between parallel plates.

$$Δ y = F / k \qquad ( 4 )$$

$$k = ( 192 \cdot E \cdot I ) / ( {L}^{3} ) \qquad ( 5 A )$$

$$k = ( 384 \cdot E \cdot I ) / ( {L}^{3} ) \qquad ( 5 B )$$

$${f}_{C} = \frac{{ε}_{0} {ε}_{r} {U}^{2} h}{2 ( m + g ) g} \qquad ( 6 )$$

$${f}_{P} = \frac{{ε}_{0} {ε}_{r} {U}^{2} h}{2 {H}^{2}} \qquad ( 7 )$$

$$y ( x ) = Δ y \frac{4}{{L}^{3}} ( - 4 {x}^{3} + 3 L {x}^{2} ) for 0 \leq x \leq ( L / 2 ) \qquad ( 8 )$$

$$y ( x ) = Δ y \frac{16}{{L}^{4}} ( {x}^{4} - 2 L {x}^{3} + {L}^{2} {x}^{2} ) for 0 \leq x \leq L \qquad ( 9 )$$

If we now consider the beam deflection for a point force then we obtain Equation (8) whilst for a distributed force we obtain the deflection given by Equation (9). In order to establish the length of the deformed beam either an exact length can be calculated or a simplified model employed based upon several approximations. The exact length is given by Equations (10) to (12) whereas the simplified model is given by Equations (13) to (17) wherein the beam is simplified to two straight lines each from the mid-point of the beam to its fixed end and the displacement is small.

$${L}_{B} = L {\int }_{0}^{1} \sqrt{{[ {Y}^{′} ( X ) ]}^{2} + 1} dX \qquad ( 10 )$$

$$Y ( X ) = \frac{y ( LX )}{L} \qquad ( 11 )$$

$$Δ L = L ( {\int }_{0}^{1} \sqrt{{[ {Y}^{′} ( X ) ]}^{2} + 1} d X - 1 ) \qquad ( 12 )$$

$${( \frac{{L}_{B}}{2} )}^{2} = {( \frac{L}{2} )}^{2} + {( Δ y )}^{2} \qquad ( 13 )$$

$$Δ y = \frac{\sqrt{Δ L ( 2 L + Δ L )}}{2} \qquad ( 14 )$$

$$Δ L = \sqrt{( {L}^{2} ) + {( 2 Δ y )}^{2}} - L \qquad ( 15 )$$

$$Δ y ≅ \sqrt{\frac{L \cdot Δ L}{2}} \qquad ( 16 )$$

$$Δ L ≅ \frac{2 {( Δ y )}^{2}}{L} \qquad ( 17 )$$

Accordingly, referring to Table 4 there are presented the design and material parameters employed in performing the design simulations presented in Tables 5A to 5C respectively, for a phase shift of π (leading to a length increase of 0.530 μm). Accordingly, it is evident that with increasing beam length increasing beam displacement occurs at lower force such that a design tradeoff between force of the MEMS actuator, length of beam and maximum induced phase shift at maximum deflection exists.

TABLE 4
Simulation Mechanical and Material Parameters

| Parameter | Value | Unit |
|---|---|---|
| Optical Frequency | 187.65 | THz |
| Optical Wavelength | 1597.62 | nm |
| Effective Refractive Index | 1.5085 | |
| Beam Configuration | Fixed-Fixed | |
| | Point Force at Center | |
| Beam Width (w) | 7.25 | μm |
| Beam Height (h_{Si}) | 59 | μm |
| Beam Height (h_{SiO2}) | 6.8 | μm |
| Youngs Modulus (Si) | 169 | GPa |
| Youngs Modulus (SiO₂) | 70 | GPa |
| Voltage applied | 170 | V |
| Gap between fingers (comb drive actuator) | 4 | μm |
| Finger width (comb drive actuator) | 4 | μm |
| Stopper to fixed plate distance | 2 | μm |
| (parallel plate actuator) | | |
| Relative permittivity (εᵣ) | 1 | |

TABLE 5A
Simulated Results for Beam Lengths 200 μm to 800 μm

| Beam Length (L) μm | 200 | 400 | 600 | 800 |
|---|---|---|---|---|
| Beam Displacement (Δy) μm | 6.64918 | 9.39892 | 11.5095 | 13.2889 |
| Force (F) mN | 52.94240 | 9.35457 | 3.39412 | 1.65328 |
| Comb Drive Length (L_{COMB}) μm | 224432 | 39655.7 | 14388.3 | 7008.54 |
| Parallel Plate Length (Lₚ) μm | 101109 | 28931.1 | 14269.7 | 8726.02 |

TABLE 5B
Simulated Results for Beam Lengths 1000 μm to 1600 μm

| Beam Length (L) μm | 1000 | 1200 | 1400 | 1600 |
|---|---|---|---|---|
| Beam Displacement (Δy) μm | 14.8568 | 16.2743 | 17.5778 | 18.7912 |
| Force (F) mN | 0.94635 | 0.59997 | 0.40804 | 0.29222 |
| Comb Drive Length (L_{COMB}) μm | 4011.73 | 2543.11 | 1729.77 | 1238.8 |
| Parallel Plate Length (Lₚ) μm | 5987.95 | 4415.0 | 3418.72 | 2743.03 |

TABLE 5C
Simulated Results for Beam Lengths 1800 μm and 2000 μm

| Beam Length (L) μm | 1800 | 2000 |
|---|---|---|
| Beam Displacement (Δy) μm | 19.9308 | 21.0087 |
| Force (F) mN | 0.21769 | 0.16723 |
| Comb Drive Length (L_{COMB}) μm | 922.81 | 709.11 |
| Parallel Plate Length (Lₚ) μm | 2260.99 | 1903.44 |

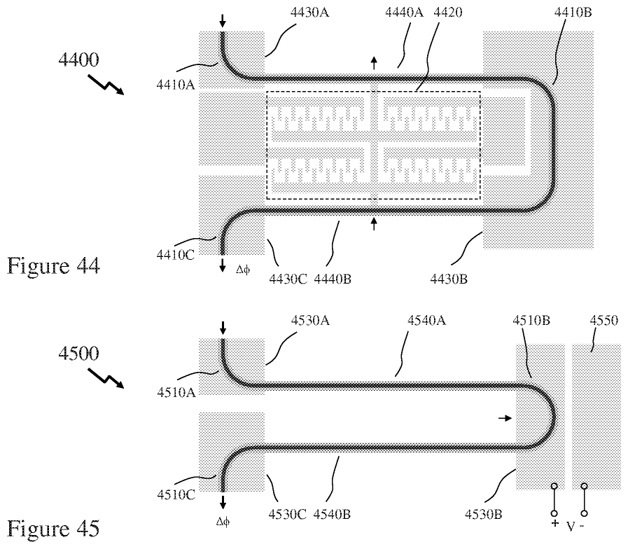

FIGS. 43C and 44D depict MEMS actuated phased shifters according to embodiments of the invention. Within FIG. 43C in schematic 4300E first and second MEMS actuators 4260C and 4260D are depicted disposed on either side of the suspended waveguide portion. In FIG. 43D in schematic 4300F first and second MEMS actuators 4260E and 4260F are depicted disposed on the same side of the suspended waveguide portion but at different locations along its length. It would be evident that within other embodiments multiple actuators may be employed along the length of a suspended waveguide portion to generate a serpentine effect increasing the overall induced phase shift over a longer distance but with reduced displacement.

FIG. 44 depicts a MEMS actuated phase shifter 4400 according to an embodiment of the invention wherein a MEMS actuator 4420 engages first and second suspended waveguides 4440A and 4440B on either side of the MEMS actuator 4420. The first suspended waveguide 4440A extending from an input waveguide 4410A upon a first non-suspended element (first anchor 4430A) to a first end of waveguide portion 4410B upon a second non-suspended element (second anchor 4430B). The second suspended waveguide 4440B extending from a second end of waveguide portion 4410B upon the second non-suspended element (second anchor 4430B) to an output waveguide 4410C upon a third non-suspended element (third anchor 4430C).

FIG. 45 depicts a MEMS actuated phase shifter 4500 according to an embodiment of the invention. As depicted an electrostatic MEMS actuator 4550 engages a suspended platform 4530B which is coupled to first and second suspended waveguides 4540A and 4540B. The first suspended waveguide 4540A extending from an input waveguide 4510A upon a first non-suspended element (first anchor 4530A) to a first end of waveguide portion 4510B upon the suspended platform 4530B. The second suspended waveguide 4540B extending from a second end of waveguide portion 4510B upon the suspended platform 4530B to an output waveguide 4510C upon a second non-suspended element (second anchor 4530C). Accordingly, motion of the suspended platform 4530B under action of the electrostatic MEMS actuator 4550 applies a force axially along the length of the first and second suspended waveguides 4540A and 4540B thereby increasing or decreasing their length according to the motion of the suspended platform 4530B and therein inducing an optical phase shift on the optical signals propagating from the input waveguide 4510A to the output waveguide 4510C. It would be evident that the MEMS actuated phase shifter 4500 may be combined with other embodiments of the invention such as MEMS actuated phase shifter 4400 for example.

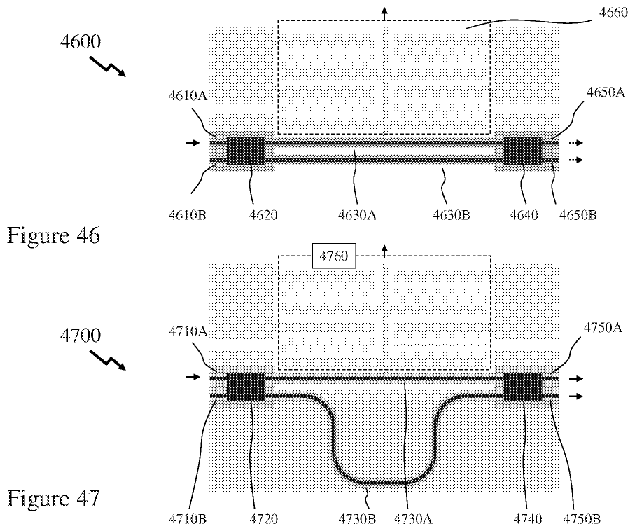

Referring to FIG. 46 there is depicted a 2×2 Mach-Zehnder interferometer (MZI) 4600 exploiting a MEMS actuated phase shifter according to an embodiment of the invention. As depicted at an input of the 2×2 MZI 4600, an input 2×2 coupler 4620 couples optical signals from first and second input waveguides 4610A and 4610B to the third and fourth waveguides 4630A and 4630B upon parallel suspended waveguide portions. These then couple to output 2×2 coupler 4640 and therein to first and second output waveguides 4650A and 4650B. Where the input 2×2 coupler 4620 and output 2×2 coupler 4640 are 3 dB couplers (e.g. directional couplers or MMIs) then optical signals coupled into the first input waveguide 4610A are coupled to the first and second output waveguides 4650A and 4650B in dependence upon the phase shift between the pair of parallel third and fourth waveguides 4630A and 4630B respectively. Accordingly, the 2×2 MZI 4600 can function as a switch routing the optical signals coupled into the first input waveguide 4610A to either the first output waveguide 4650A or the second output waveguide 4650B with the inverse action for optical signals on the second input waveguide 4610B. The phase shift between the third and fourth waveguides 4630A and 4630B being induced by MEMS actuator 4660. It would be evident that the input 2×2 coupler 4620 can be replaced with a 1×2 coupler and/or the output 2×2 coupler 4640 can be replaced with a 2×1 coupler.

Referring to FIG. 47 there is depicted a 2×2 Mach-Zehnder interferometer (MZI) 4700 exploiting a MEMS actuated phase shifter according to an embodiment of the invention. As depicted at an input of the 2×2 MZI 4700, an input 2×2 coupler 4720 couples optical signals from first and second input waveguides 4710A and 4710B to the second and third waveguides 4730A and 4730B which are upon suspended waveguide portion 4730A and non-suspended waveguide portion 4730B respectively. These then couple to output 2×2 coupler 4740 and therein to first and second output waveguides 4750A and 4750B. Where the input 2×2 coupler 4720 and output 2×2 coupler 4740 are 3 dB couplers (e.g. directional couplers or MMIs) then optical signals coupled into the first input waveguide 4710A are coupled to the first and second output waveguides 4750A and 4750B in dependence upon the phase shift between the pair of parallel second and third waveguides 4730A and 4730B respectively. Accordingly, the 2×2 MZI 4700 can function as a switch routing the optical signals coupled into the first input waveguide 4710A to either the first output waveguide 4750A or the second output waveguide 4750B with the inverse action for optical signals on the second input waveguide 4710B. The phase shift between the second and third waveguides 4730A and 4730B being induced by MEMS actuator 4760. It would be evident that the input 2×2 coupler 4720 can be replaced with a 1×2 coupler and/or the output 2×2 coupler 4740 can be replaced with a 2×1 coupler. In contrast to 2×2 MZI 4600 in FIG. 46 only one arm of the MZI is upon a suspended waveguide portion.

FIG. 46 depicts a balanced MZI and FIG. 47 depicts an unbalanced MZI. These MZI devices may be employed as an optical switch, amplitude modulator or tunable optical filter. Further, the phase shifter may be employed discretely as an optical phase shifter or time delay in systems.

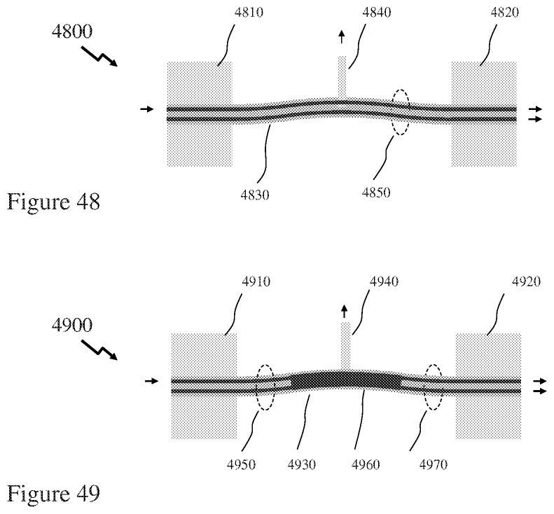

Now referring to FIG. 48 there is depicted a MEMS actuated tunable directional coupler 4800 according to an embodiment of the invention. Accordingly, a pair of waveguides 4850 run along a suspended waveguide portion 4830 from a first anchor 4810 to a second anchor 4820. The suspended waveguide portion 4830 being coupled to a MEMS actuator (not depicted for clarity) via an arm 4840. Accordingly, as the suspended waveguide portion 4830 is deflected by the MEMS actuator via the arm 4840 then the waveguide spacing of the pair of waveguides 4850 is varied resulting in an adjustment in the coupling of optical signals between the pair of waveguides 4850. As the coupling strength between a pair of waveguides is exponentially dependent upon the distance between the waveguides then small adjustments in effective spacing can result in significant adjustments of coupling.

Within other embodiments of the invention the second anchor 4820 may be moved under action of a MEMS actuator (not depicted for clarity) so that the suspended waveguide portion is stretched/compressed rather than being “bent.” It would be evident to one of skill in the art that whilst the above description describes the coupling between the optical waveguides as being dependent upon the gap between the waveguides that the coupling is dependent upon other factors including, but not limited to, changes in optical mode through refractive index changes, e.g. stress induced, the optical mode within the waveguide, which is different between a straight waveguide and a curved or “bent” waveguide, and the length over which the optical waveguides are coupled.

Now referring to FIG. 49 there is depicted a MEMS actuated tunable MMI 4900 according to an embodiment of the invention. Accordingly, a pair of input waveguides 4950 run along a suspended waveguide portion 4930 from a first anchor 4910 to an MMI 4960 formed upon the suspended waveguide portion 4930. From the MMI 4960 a pair of output waveguides 4970 run along the suspended waveguide portion 4930 to a second anchor 4920. The suspended waveguide portion 4930 being coupled to a MEMS actuator (not depicted for clarity) via an arm 4940. Accordingly, as the suspended waveguide portion 4930 is deflected by the MEMS actuator via the arm 4940 then the properties of the MMI 4960 are adjusted, (e.g. splitting ratio, phase shift, beam imaging etc.) so that the result is coupling of the optical signals upon the pair of input waveguides 4950 to the pair of output waveguides 4970 is varied in dependence upon the deflection induced by the MEMS actuator. Within other embodiments of the invention the number of input waveguides 4950 and number of output waveguides 4970 may be varied. In each instance, the number may be 1,2,3, . . . , etc. For example, a single input waveguide 4950 may couple to 3 output waveguides 4970 via the MMI 4960

Optionally, the second anchor 4920 may be moved under action of a MEMS actuator (not depicted for clarity) so that the suspended waveguide portion is stretched/compressed rather than being “bent.” Optionally, within other embodiments of the invention multiple MMIs may be implemented upon the suspended waveguide portion with each MMI acting upon different subsets of the plurality of optical waveguides upon the suspended waveguide portion 4930.

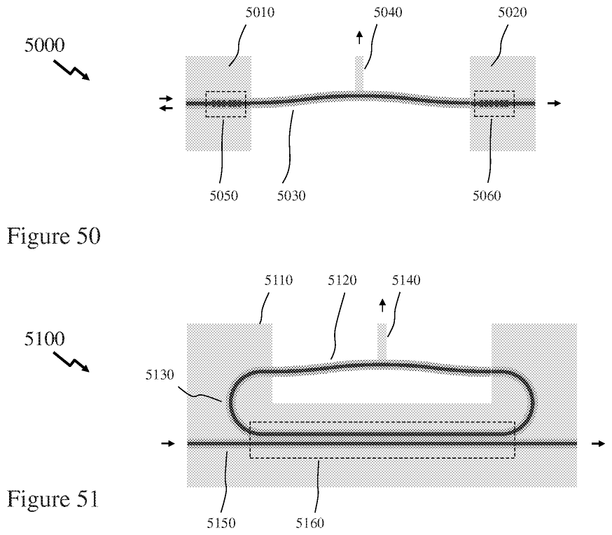

Referring to FIG. 50 there is depicted a MEMS actuated tunable resonator 5000 according to an embodiment of the invention wherein a suspended waveguide portion 5030 is disposed between a first grating 5050 upon a first anchor 5010 and a second grating 5060 upon a second anchor 5020. The suspended waveguide portion 5030 being coupled via an arm 5040 a MEMS actuator (not shown for clarity). Accordingly, the first grating 5050 and second grating 5060 provide a Fabry-Perot cavity for optical signals propagating within the waveguide upon the suspended waveguide portion 5030 wherein the wavelength performance of the Fabry-Perot cavity is determined by the phase shift of optical signals propagating within the Fabry-Perot cavity. Accordingly, deflection of the suspended waveguide portion 5030 under actuation of the MEMS actuator via arm 5040 results in this phase shift being varied and accordingly the optical properties of the Fabry-Perot cavity varying, e.g. transmission wavelength of signal(s) passed, reflection wavelength of signal(s) reflected.

Now referring to FIG. 51 there is depicted a MEMS actuated tunable ring resonator 5100 according to an embodiment of the invention. As depicted a first waveguide 5150 couples to a second waveguide 5130 in a coupling region 5160 upon a non-suspended portion 5110. The second waveguide 5130 being a ring waveguide such that optical signals coupled into it at the end of the coupler region 5160 are coupled back to the start of the coupler region 5160. Such a ring resonator 5100 can provide a high finesse and hence very narrow wavelength passband(s). The characteristics of the ring resonator 5100 are determined in part by the phase shift within the second waveguide 5130 so that, for example, the central wavelength of the ring resonator can be varied by adjusting the phase of the optical signals propagating within the second waveguide. Accordingly, as depicted a portion of the second waveguide 5130 is a suspended waveguide portion 5120 coupled to a MEMS actuator (not shown for clarity) via an arm 5140. Accordingly, the ring resonator 5100 can be tuned through deflection of the suspended waveguide portion 5120 by the MEMS actuator.

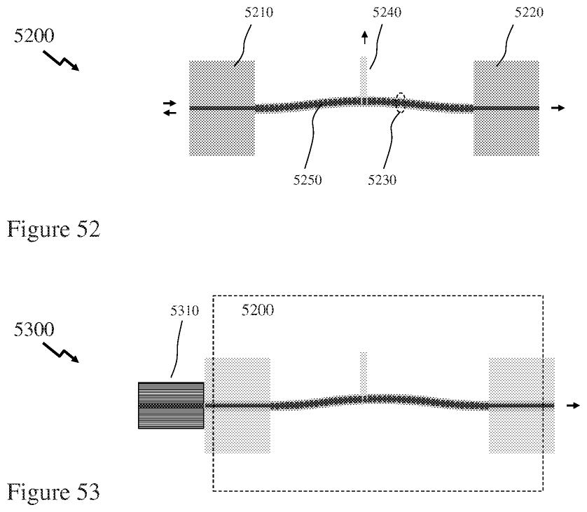

Referring to FIG. 52 there is depicted a MEMS actuated tunable Bragg grating element 5200 according to an embodiment of the invention. As depicted a grating 5250 within a waveguide upon a suspended waveguide portion 5230 is coupled to input and output waveguides upon input and output anchors 5210 and 5220 respectively. The suspended waveguide portion 5230 being coupled to a MEMS actuator (not shown for clarity) via an arm 5240. Accordingly, deflection of the suspended waveguide portion 5230 results in adjustment of the grating period of the grating 5250 such that the optical properties of the grating, e.g. passband, centre wavelength, etc. are adjusted in dependence upon the deflection induced within the suspended waveguide portion 5230 by the MEMS actuator.

Referring to FIG. 53 there is depicted an example of using a MEMS actuated tunable Bragg grating element 5200 within an external cavity laser (ECL) 5300 according to an embodiment of the invention. As depicted the ECL 5300 couples a reflective semiconductor optical amplifier (SOA) 5310 to the MEMS actuated tunable Bragg grating element 5200 such that the MEMS actuated tunable Bragg grating element 5200 acts as a tunable filter for the resonant cavity with the other facet of the reflective SOA disposed away from the MEMS actuated tunable Bragg grating element 5200.

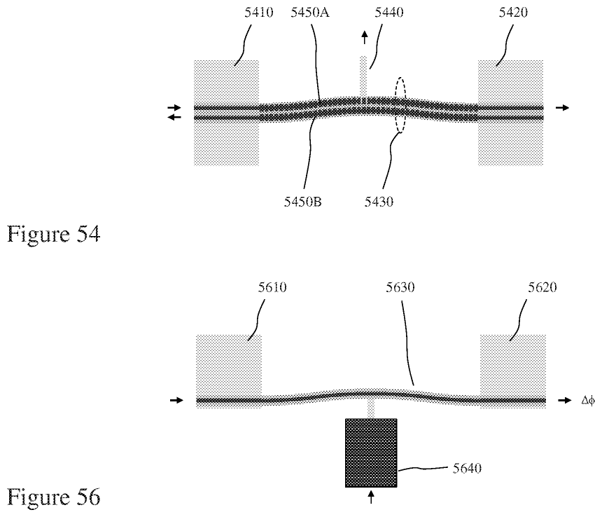

Now referring to FIG. 54 there is depicted a MEMS actuated tunable contra-directional coupler 5400 according to an embodiment of the invention. As depicted a pair of waveguides with gratings 5450A and 5450B run along a suspended waveguide portion 5430 between a pair of inputs upon a first non-suspended portion 5410 and a pair of outputs upon a second non-suspended portion 5454. Accordingly, the suspended waveguide portion 5430 is coupled to a MEMS actuator (not shown for clarity) via an arm 5440. In common with MEMS actuated tunable Bragg grating element 5540 the gratings 5450A and 5450B vary in optical characteristics as the suspended waveguide portion is deflected under action of the MEMS actuator so that the resulting reflected and transmitted optical signals from the MEMS actuated tunable contra-directional coupler 5400 vary in dependence upon the deflection of the suspended waveguide portion 5430.

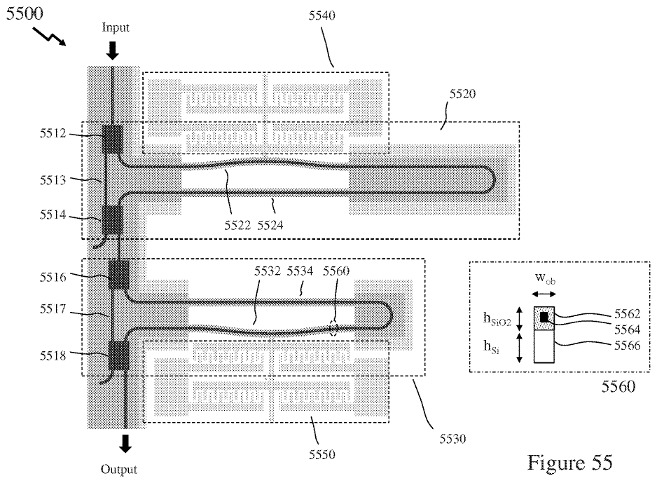

Referring to FIG. 55 there is depicted a MEMS actuated tunable lattice filter 5500 according to an embodiment of the invention. The MEMS actuated tunable lattice filter 5500 comprising a pair of MEMS actuated MZI wavelength filters, first MEMS MZI 5520 and second MEMS MZI 5530 according to an embodiment of the invention. As depicted first MEMS MZI 5520 comprises an input 1×2 coupler 5512, a first arm 5513, an output 2×2 coupler 5514 and a second arm employing suspended waveguide portions comprising a first movable portion 5522 and a second fixed portion 5524. The first movable portion 5522 being coupled to a first MEMS actuator 5540. Accordingly, the first movable portion 5522 of the second arm is a suspended waveguide portion such that the first MEMS actuator 5540 can deform the first movable portion 5522 yielding a phase shift in the optical signal propagating within the second arm relative to the first arm 5513.

Similarly, the second MEMS MZI 5530 comprises an input 1×2 coupler 5516, a first arm 5517, an output 2×2 coupler 5518 and a second arm employing suspended waveguide portions comprising a first movable portion 5532 and a second fixed portion 5534. The first movable portion 5532 being coupled to a second MEMS actuator 5550. Accordingly, the first movable portion 5532 of the second arm is a suspended waveguide portion such that the second MEMS actuator 5550 can deform the first movable portion 5532 yielding a phase shift in the optical signal propagating within the second arm relative to the first arm 5517. Insert 5560 depicts a cross-section through the suspended waveguide portion wherein the suspended waveguide portion comprises a waveguide core 5564 with cladding 5562 which are disposed atop a membrane 5566, such as silicon, which is attached at either end to non-suspended portions of the structure and the MEMS actuator.

Accordingly, in each of the first MEMS MZI 5520 and the second MEMS MZI 5530 adjustment of the phase shift between the second arm and the first arm between the input and output couplers can be adjusted by the respective MEMS actuator. As depicted the path length in the first MEMS MZI 5520 is longer than that of the second MEMS MZI 5530 such that the wavelength response of the first MEMS MZI 5520 and second MEMS MZI 5530 are different, e.g. the first MEMS MZI 5520 has a wavelength response half that of the second MEMS MZI 5530 such that first MEMS MZI 5520 may couple, for example, odd wavelengths (1,3, . . . , N−1 where N is even) to the second MEMS MZI 5530 whilst the even wavelengths (2,4, . . . ,N) are coupled to another MEMS MZI which is not depicted for clarity but is coupled to the second output of the output 2×2 coupler. The second MEMS MZI 5530 then filters wavelengths 1, 5, . . . , N−3, for example, to the output depicted whilst the other wavelengths 3, 7, . . . , N−1 are routed to another port via the other output of the output 2×2 coupler of the second MEMS MZI 5530. Such an embodiment may be used in applications where the phase imbalance is set either once to remove manufacturing variations or periodically to reconfigure the device.

Whilst the first MEMS MZI 5520 and second MEMS MZI 5530 are depicted with a lateral MEMS actuator such as described and depicted with respect to FIG. 42A it would be evident that other configuration such as those described and depicted with respect to FIGS. 43C, 43D, and 44 may be employed or that alternative configurations such as described and depicted with respect to FIG. 45 may be employed.

Referring to FIG. 56 there is depicted a MEMS actuated force/displacement sensor 5600 according to an embodiment of the invention. As depicted a suspended waveguide portion 5630 is disposed between an input anchor 5610 and an output anchor 5620. A mass 5640 is coupled to the suspended waveguide portion 5630 via a beam. Accordingly, movement of the mass 5640 results in deflection of the suspended waveguide portion 5630 inducing an optical phase shift in the optical signals within the suspended waveguide portion 5630. Accordingly, where this MEMS actuated force/displacement sensor 5600 forms part of a phase detector, e.g. a MZI such as described and depicted in respect of FIGS. 46 and 47 respectively or resonators such as described and depicted in respect of FIGS. 50 and 51, then this motion can be detected. This motion may be used to determine a force applied to the mass 5640, a displacement of the mass 5640, etc.

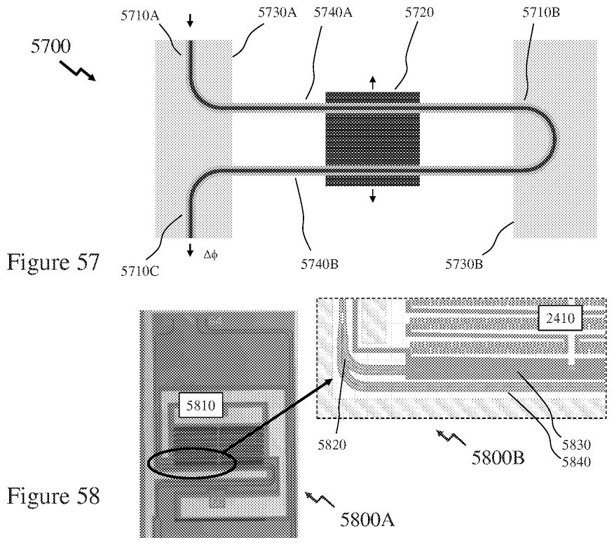

Now referring to FIG. 57 there is depicted a MEMS actuated accelerometer 5700 according to an embodiment of the invention. As depicted a first suspended waveguide portion 5740A is disposed between an input waveguide 5710A upon a first non-suspended portion 5730A and a waveguide 5710B upon a second non-suspended portion 5730B. A second suspended waveguide portion 5740B is disposed between an output waveguide 5710C upon the first non-suspended portion 5730A and the waveguide 5710B upon the second non-suspended portion 5730B. Each of the first and second suspended waveguide portions 5740A and 5740B being coupled to a proof mass 5720. Accordingly, movement of the proof mass 5720 results in deflection of the first and second suspended waveguide portions 5740A and 5740B inducing an optical phase shift in the optical signals within the first and second suspended waveguide portions 5740A and 5740B. Accordingly, where this MEMS actuated accelerometer 5700 forms part of a phase detector, e.g. a MZI such as described and depicted in respect of FIGS. 46 and 47 respectively or resonators such as described and depicted in respect of FIGS. 50 and 51, then this motion can be detected. Accordingly, movement of the proof mass 5720 can be used to determine a force applied to the proof mass 5720 and therein an acceleration applied to a system within which the MEMS actuated accelerometer 5700 is disposed.

It would be evident that two or more sensor elements such as described and depicted in respect of FIGS. 56 and 57 may be employed so that phase changes of more than π or 2π can be detected.

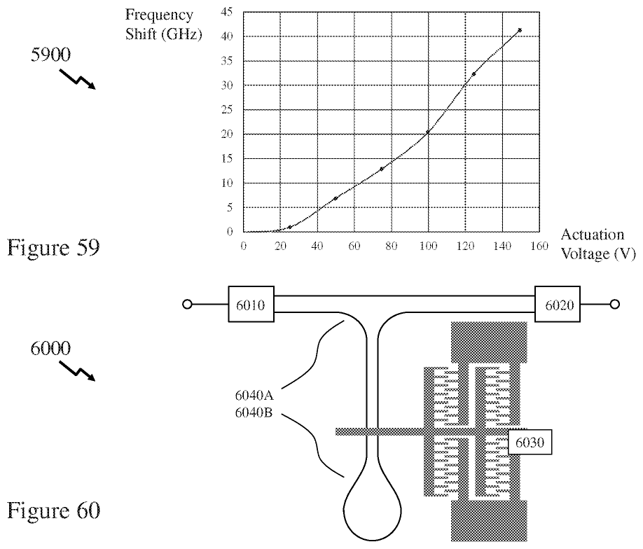

Referring to FIG. 58 there is depicted an optical micrograph 5800A and design 5800B of a MEMS actuated 1×2 MZI according to an embodiment of the invention. Accordingly, as depicted in optical micrograph 5800A a MEMS comb actuator 5810 was implemented. As depicted in design 5800B which shows part of the overall circuit depicted in optical micrograph 5800A the MEMS comb actuator 5810 was coupled to a suspended arm 5830 of the 1×2 MZI which ran in parallel to a non-suspended arm 5840. These being coupled to a multimode interferometer (MMI) 5820 at the input of the 1×2 MZI. Accordingly, with actuation the frequency shift of the peak transmission of the 1×2 MZI was measured as a function of actuation voltage as depicted in FIG. 59. Accordingly, at 150V the induced frequency shift was approximately 42 GHz. MMI 5820 may alternatively be a Y-junction, directional coupler or other power splitter element providing 50:50 power splitting to the two arms of the MZI.

Referring to FIG. 60 there is depicted a MEMS actuated dual phase shifter element for a 1×1 Mach-Zehnder interferometer based variable optical attenuator (VOA) 6000 according to an embodiment of the invention. Accordingly, a MEMS actuator 6030 is coupled to a loop back waveguide 6040B disposed between an input 1×2 coupler 6010 and output 2×1 coupler 6020 together with the other arm 6040A of the 1×1 MZI VOA 6000. Accordingly, the MEMS actuator 6030 when actuated deflects the portion of the loop back waveguide 6040B which is suspended such as described and depicted above in respect of embodiments of the invention. Accordingly, this actuation structure may be similar in structure as that depicted and described above in respect of FIG. 44 for example.

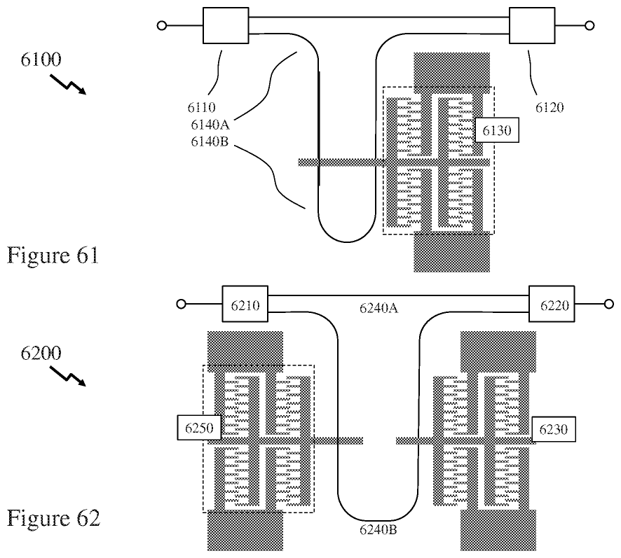

Now referring to FIG. 61 there is depicted a MEMS actuated dual phase shifter element for a 1×1 Mach-Zehnder interferometer based variable optical attenuator (VOA) 6100 according to an embodiment of the invention. Accordingly, a MEMS actuator 6130 is coupled to a loop back waveguide 6140B disposed between an input 1×2 coupler 6110 and output 2×1 coupler 6120 together with the other arm 6140A of the 1×1 MZI VOA 6100. Accordingly, the MEMS actuator 6130 when actuated deflects the portion of the loop back waveguide 6140B which is suspended such as described and depicted above in respect of embodiments of the invention. Accordingly, this actuation structure may be similar in structure as that depicted and described above in respect of FIG. 44 for example.

Referring to FIG. 62 there are depicted dual MEMS actuated phase shifter elements for a 1×1 Mach-Zehnder interferometer based variable optical attenuator (VOA) 6200 according to an embodiment of the invention. As depicted a loop back arm 6240B and arm 6240A are disposed between an input 1×2 coupler 6210 and output 2×1 coupler 6220 of the 1×1 MZI VOA 6200. First and second MEMS actuators 6250 and 6230 are coupled to suspended waveguide portions of the loop back arm 6240B such that when actuated individually or concurrently they induce phase shifts within the loop back arm 6240B and establish the state of the 1×1 MZI VOA 6200.

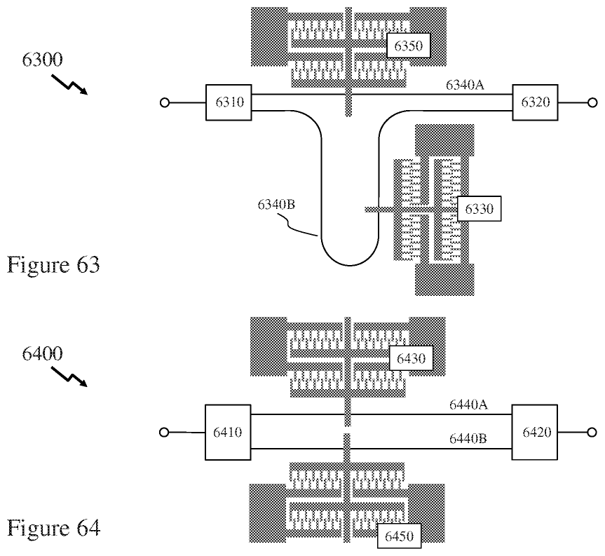

Now referring to FIG. 63 there are depicted dual MEMS actuated phase shifter elements for a 1×1 Mach-Zehnder interferometer based variable optical attenuator (VOA) 6300 according to an embodiment of the invention. As depicted a loop back arm 6340B and arm 6340A are disposed between an input 1×2 coupler 6310 and output 2×1 coupler 6320 of the 1×1 MZI VOA 6300. First and second MEMS actuators 6330 and 6350 are coupled to suspended waveguide portions of the arm 6340A and loop back arm 6340B. Accordingly, each of the first and second MEMS actuators 6330 and 6350 induce phase shifts in their respective arm of the 1×1 MZI VOA 6300 such that, for example, with an initial static bias between the arms the 1×1 MZI VOA 6300 can be driven into the “ON” state with one of the first and second MEMS actuators 6330 and 6350 and into the “OFF” state with the other of the first and second MEMS actuators 6330 and 6350 rather than requiring a single MEMS actuator to induce the total phase shift required to transition the 1×1 MZI VOA 6300 from “ON” to “OFF” or vice-versa.

Referring to FIG. 64 there are depicted dual MEMS actuated phase shifter elements for a 1×1 Mach-Zehnder interferometer based variable optical attenuator (VOA) 6400 according to an embodiment of the invention. As depicted first and second arms 6440A and 6440B are disposed between an input 1×2 coupler 6410 and output 2×1 coupler 6420 of the 1×1 MZI VOA 6400. First and second MEMS actuators 6430 and 6450 are coupled to suspended waveguide portions of the first arm 6440A and second arm 6440B respectively. Accordingly, each of the first and second MEMS actuators 6430 and 6450 induce phase shifts into their respective arms of the 1×1 MZI VOA 6400 such that, for example, with an initial static bias between the arms, the 1×1 MZI VOA 6400 can be driven into the “ON” state with one of the first and second MEMS actuators 6430 and 6450 and into the “OFF” state with the other of the first and second MEMS actuators 6430 and 6450 rather than requiring a single MEMS actuator to induce the total phase shift required to transition the 1×1 MZI VOA 6400 from “ON” to “OFF” or vice-versa.

Whilst the embodiments of the invention described and depicted in respect of FIG. 60 to 64 have been 1×1 MZI VOA structures it would be evident to one of skilled in the art that the same structures may be employed to provide phase tuning of 1×2 MZI optical switches/wavelength filters, 2×2 MZI optical switches/wavelength filters, and 2×1 MZI optical switches/wavelength filters.

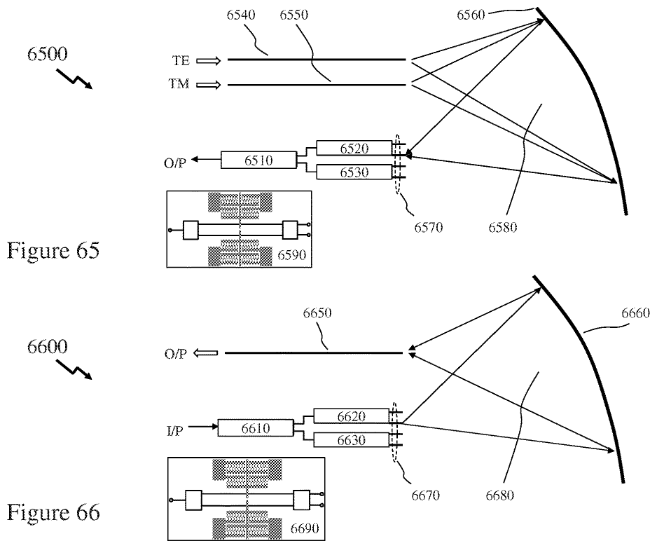

Now referring to FIG. 65 there is depicted a polarization diverse tunable filter 6500 exploiting MEMS actuated phase shifter elements within a lattice filter-based switch in conjunction with a grating structure according to an embodiment of the invention. As depicted first and second waveguides 6540 and 6550 carrying respectively TE and TM polarization optical signals are coupled to a grating 6560 and reflected such that their position at the focal plane of the grating 6560 is determined by their wavelength. The first and second waveguides 6540 and 6550 being positioned to compensate for polarization dependent wavelength offsets within the grating 6560 such that optical signals at the same wavelength are aligned at the same point on the focal plane of the grating from the first and second waveguides 6540 and 6550 for TE and TM polarizations respectively. The relative positions of the first and second waveguides 6540 and 6550 may vary according to the design of the grating 6560, material system, etc. and may even reverse in position.

Disposed at the focal plane of the grating 6560 are an array of waveguides 6570, only 4 are depicted here, which are coupled in pairs to first and second optical switches 6520 and 6530. The outputs of these first and second optical switches 6520 and 6530 respectively are coupled to a third optical switch 6510 and therein an output port of the polarization diverse tunable filter 6500. Accordingly, the first to third optical switches 6520, 6530 and 6510 select an optical waveguide of the array of waveguides and therein a wavelength range of the optical signals upon the first and second waveguides 6540 and 6550, e.g. a single channel of a DWDM stream, a single channel of a CWDM system, etc. Each of the first to third optical switches 6520, 6530 and 6510 being a 2×1 MZI 6590 employing MEMS actuated phase shifters such as described and depicted above in respect of embodiments of the invention. The Region 6580 between the grating 6560 and the ends of the first and second waveguides 6540 and 6550 together with the ends of the array of waveguides 6570 is a free propagation region, i.e. a 2D or planar waveguide.

Referring to FIG. 66 there is depicted a tunable filter 6600 exploiting MEMS actuated phase shifter elements within a lattice filter-based switch in conjunction with a grating according to an embodiment of the invention. As depicted a lattice switch comprising first to third switches 6610 to 6630 couples an input signal to a waveguide of an array of waveguides 6670. The optical signals from the selected waveguide of the array of waveguides 6670 are coupled to the grating 6660 and therein reflected and coupled to the output waveguide 6650. As the wavelength of optical signals coupled to the output waveguide 6650 varies according to which waveguide of the array of waveguides 6670 is employed then the overall circuit acts as a tunable filter wherein programmable selection of the waveguide of the array of waveguides determines which wavelength(s) of the optical signals coupled to the input are passed to the output. Each of the first to third optical switches 6610 to 6630 being a 1×2 MZI 6690 employing MEMS actuated phase shifters such as described and depicted above in respect of embodiments of the invention. The Region 6680 between the grating 6660 and the end of the output waveguide 6650 together with the ends of the array of waveguides 6670 is a free propagation region, i.e. a 2D or planar waveguide.

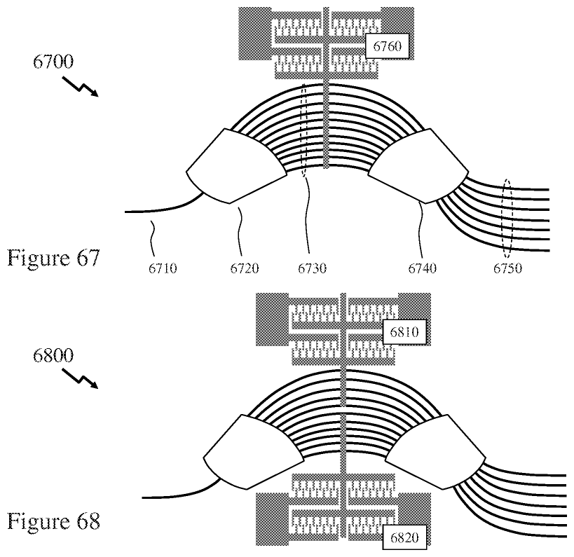

Now referring to FIG. 67 there are depicted MEMS actuated phase shifters within an array waveguide grating (AWG) 6700 according to an embodiment of the invention. As depicted the AWG comprises an input waveguide 6710 which couples to a first free propagating region (FPR, also known as a planar or 2D waveguide) 6720. Accordingly, the optical signals from the input waveguide 6710 form an optical wavefront which couples to the array of waveguides 6730 which start at the other end of the first FPR 6720 to the input waveguide 6710 and ends at the second FPR 6740. The multiple optical signals from the array of waveguides 6730 coupled to the second FPR 6740 combine according to accumulated phase shifts to a waveguide of an output array 6750 at the other end of the second FPR 6740. As the accumulated phase shifts vary with wavelength then different wavelengths have different combination positions such that different waveguides in the output array 6750 couple different wavelengths. However, in contrast to prior art AWGs the AWG 6700 incorporates a MEMS actuator 6760 which is coupled to the array of waveguides 6730 which are suspended waveguide elements such that actuation of the MEMS actuator 6760 results in deflection of each waveguide of the array of waveguides 6730 and a change in its phase shift relative to the other waveguides within the array of waveguides. Accordingly, as the length of each waveguide of the array of waveguides 6730 varies then the induced deflection and phase shift also varies. Accordingly, the MEMS actuator 6760 can be used to tune the AWG 6700 so that, for example, it is aligned to a specific grid, e.g. ITU 100 GHz or ITU 50 GHz for example and/or that the AWG has exactly a 100 GHz spacing or 50 GHz spacing.

Referring to FIG. 68 there are depicted multiple MEMS actuated phase shifter structures within an array waveguide grating 6800 according to an embodiment of the invention. Accordingly, in contrast to AWG 6700 in FIG. 67 the array of waveguides between the free propagation zones are now coupled to a pair of arms and therein to first and second MEMS actuators 6810 and 6820 respectively. The AWG 6800 may allow a large number of waveguides to be employed in the AWG 6800. Optionally, more MEMS actuators may be employed further sub-dividing the array of waveguides into small groups.

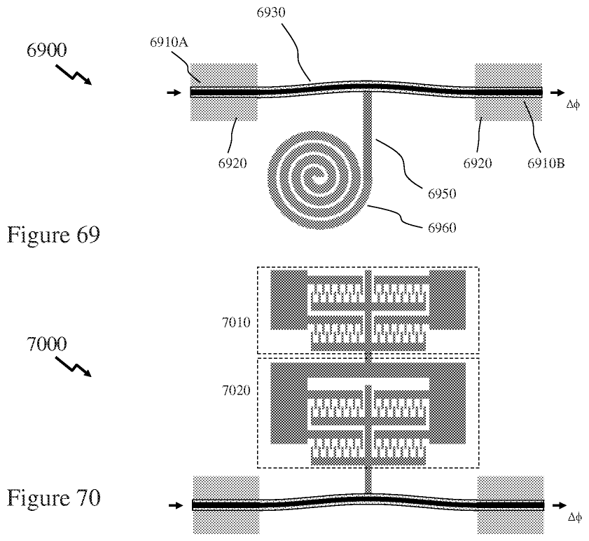

Referring to FIG. 69 there is depicted a thermally actuated suspended beam phase shifter 6900 according to an embodiment of the invention to provide athermal operation. As depicted a suspended waveguide portion 6930 is disposed between input and output waveguide portions 6910A and 6910B on non-suspended portions 6920. The suspended waveguide portion 6930 is coupled via arm 6950 to a MEMS actuator 6960. The MEMS actuator 6960 having a non-suspended portion attached to a substrate and a second suspended portion which adjusts in one or more dimensions as a result of temperature variations. Accordingly, a variation in temperature of the circuit comprising the phase shifter 6900 results in the MEMS actuator 6960 length varying and accordingly the deflection of the suspended waveguide portion 6930 varying in dependence upon the temperature. If the phase shift induced through the varying deflection of the suspended waveguide portion 6930 is of equal magnitude but opposite sign to the phase shift variations induced due to the temperature dependent refractive index, then the phase shifter 6900 can provide for thermal compensation of induced phase shift versus temperature and accordingly may form the basis of athermal waveguide elements such as MZIs etc.

Within another embodiment of the invention a side wall of the suspended waveguide portion 6930 may be metallized and no MEMS actuator 6960 implemented. In this embodiment the thermal expansion of the metallization results in a deflection of the suspended waveguide portion 6930 and can similarly form the basis of an athermal waveguide element.

Now referring to FIG. 70 there is depicted a structure for cascading MEMS actuators, first and second MEMS actuators 7010 and 7020, such that the deflection achievable is increased over that from a single MEMS actuator. As depicted the second MEMS actuator 7020 moves in its entirety based upon the actuation of the first MEMS actuator 7010 and then the second MEMS actuator 7020 can be actuated.

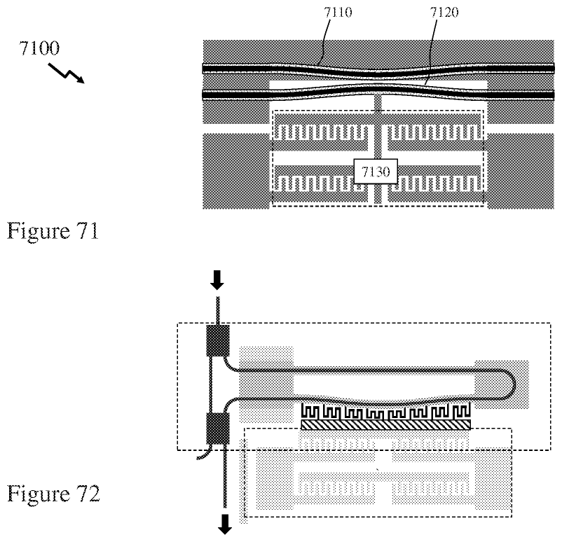

Referring to FIG. 71 there is depicted a MEMS actuator based tunable coupler 7100 according to an embodiment of the invention. As depicted the tunable coupler comprises a non-suspended waveguide 7110 and a suspended waveguide 7120. The suspended waveguide 7120 being coupled to a MEMS actuator 7130 via an arm such that actuation of the MEMS actuator 7130 results in deflection of the suspended waveguide 7120 with a varying separation from the non-suspended waveguide 7110 such that the coupling between the suspended waveguide 7120 and non-suspended waveguide 7110 is controlled via the MEMS actuator 7130.

Whilst the embodiments of the invention described and depicted above in respect of FIGS. 42A to 72 have been described and depicted with respect to linear electrostatic comb actuators it would be evident that other electrostatic actuators may be employed including, but not limited to, linear parallel plate actuators, rotational electrostatic comb actuators, rotational parallel plate actuators, and MEMS based inch-worm drives.

Further, whilst embodiments of the invention have been described with respect to electrostatic actuation it would be evident that other actuation means/mechanisms may be employed within other embodiments of the invention including, but not limited to, piezoelectric, magnetic and thermal.

Embodiments of the invention may further incorporate other MEMS elements allowing additional functionality or features to be implemented. For example, MEMS elements may grip or lock the MEMS actuator such that long term actuation of the actuator is not required. For example, a gripping structure may be actuated to allow the actuator to move and then once set to the desired point the gripping structure de-actuated to re-grip. Alternatively, a tooth or teeth on the MEMS actuator may be selectively engaged with other teeth upon a locking actuator so that the locking actuator is engaged to separate its teeth from those on the actuator, the actuator adjusted, and then the locking actuator de-actuated to relock its teeth with those on the actuator.

Within the embodiments of the invention described above the optical waveguides have been described as exploiting a silicon nitride core upon a silicon dioxide SiO₂ cladding, i.e. a SiN—SiO₂ waveguide structure. However, it would be evident that embodiments of the invention may also be employed in conjunction with other waveguide materials systems. These may include, but not be limited to:
a silicon nitride core with silicon oxide upper and lower cladding, a SiO₂—Si₃N₄—SiO₂ waveguide structure;
a silicon core and silicon nitride lower cladding, a Si—Si₃N₄ waveguide structure;
a silicon core and silicon nitride upper and lower claddings, a Si₃N₄—Si—Si₃N₄ waveguide structure;
a silicon core with silicon oxide lower claddings, a Si—SiO₂ waveguide;
a silicon core with silicon oxide upper and lower claddings, a SOI waveguide, e.g. SiO₂—Si—SiO₂;
a doped silica core relative to undoped cladding, a SiO₂-doped SiO₂—SiO₂, e.g. germanium doped (Ge) yielding SiO₂—Ge: SiO₂—SiO₂;
a silicon core and silicon oxynitride upper and lower claddings, a SiO_{X}N_{Y}—Si—SiO_{X}N_{Y} waveguide structure;
silicon oxynitride core with silicon oxide upper and lower claddings, a SiO₂—SiO_{X}N_{Y}—SiO₂ waveguide structure;
polymer-on-silicon; and
doped silicon waveguides.

Additionally, whilst within the embodiments of the invention described above the waveguide structures are described with respect to silicon photonics, it would be evident to one skilled in the art that the embodiments of the invention may be employed in a variety of waveguide coupling structures coupling onto and/or from waveguides employing material systems that include, but not limited to, SiO₂—Si₃N₄—SiO₂; SiO₂—Ge: SiO₂—SiO₂; Si—SiO₂; ion exchanged glass, ion implanted glass, polymeric waveguides, indium gallium arsenide phosphide (InGaAsP), InP, GaAs, III-V materials, II-VI materials, Si, SiGe, and single mode optical waveguides and multimode optical waveguides.

Any material system may be employed where a region of the optical waveguide may be suspended relative to fixed non-suspended ends and an actuator employed to deflect the suspended waveguide portion. Whilst the embodiments of the invention have been described and depicted with respect to silicon material system supporting monolithic integration of the optical waveguides and MEMS actuators it would be evident that other embodiments of the invention may employ discrete actuators or hybrid integration methodologies.

Within embodiments of the invention the suspended waveguide portion has been mechanically part of the arm. However, within other embodiments of the invention it would be evident that they may mechanically separate but engage upon one another.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A waveguide based optical element forming part of an optical device comprising:
the waveguide based optical element comprising:
a non-suspended portion attached to a substrate of the optical device;
a suspended portion disposed above the substrate;
one or more optical waveguides disposed upon the non-suspended portion; and
another optical waveguide disposed upon the suspended portion; and
an actuator inducing a variation within a property of optical signals propagating within the another optical waveguide upon the suspended portion.

2. The waveguide based optical element according to claim 1, further comprising a layer of a piezoelectric material; wherein
the piezoelectric material is coupled to one or more electrode pads allowing electrical activation of the piezoelectric material; and
the piezoelectric layer is at least one of:
disposed upon another suspended portion of the waveguide based optical element coupled to the suspended portion;
a core of the another optical waveguide;
disposed upon a lower surface of a portion of the suspended portion;
disposed upon the another optical waveguide;
disposed adjacent to the another optical waveguide on the suspended portion; and
disposed upon a portion of the suspended portion adjacent to a raised portion of the suspended portion upon which the another optical waveguide is formed.

3. The waveguide based optical element according to claim 2, wherein
one or more optical waveguides disposed upon the non-suspended portion comprise an input waveguide and an output waveguide:
the suspended portion comprises:
a body portion having an elongated geometry along an axis with a first end coupled to the non-suspended portion and a second distal end free to move relative to the non-suspended portion; and
the another optical waveguide is a waveguide disposed along a predetermined portion of the body portion having a first end coupled to the input waveguide and at a second distal end coupled to the output waveguide;
the suspended portion is attached to the non-suspended portion;
the suspended portion extends away from the non-suspended portion and at least one of a variation in a polarizability of the waveguide and an expansion of the suspended portion are dependent upon a magnitude of a voltage applied to the piezoelectric material via the one or more electrode pads.

4. The waveguide based optical element according to claim 3, further comprising
a first set of springs disposed along a first side of the body portion along the body portion disposed along the axis perpendicular to the axis of the non-suspended portion further coupling the body portion to the substrate via the first set of springs; and
a second set of springs disposed along a second side of the body portion distal the first side of the body portion along the body portion disposed along the axis perpendicular to the axis of the non-suspended portion further coupling the body portion to the substrate via the second set of springs.

5. The waveguide based optical element according to claim 3, further comprising
a first set of springs disposed along a first side of the body portion along the body portion disposed along the axis perpendicular to the axis of the non-suspended portion further coupling the body portion to the substrate via the first set of springs; and
a second set of springs disposed along a second side of the body portion distal the first side of the body portion along the body portion disposed along the axis perpendicular to the axis of the non-suspended portion further coupling the body portion to the substrate via the second set of springs; and
disposed within the first set of springs and second set of springs are a set of linkages, each linkage further coupling the body portion to the substrate and limiting movement of the body portion in an axis parallel to the substrate and parallel to the axis of the non-suspended portion.

6. The waveguide based optical element according to claim 1, wherein
the suspended portion is attached to the non-suspended portion via a membrane which is suspended above the substrate; and
the membrane comprises a plurality of openings disposed through the membrane.

7. The waveguide based optical element according to claim 1, wherein
the suspended portion is disposed between a first portion of the non-suspended portion and a second portion of the suspended portion;
the suspended portion is attached at an end to the first portion of the non-suspended portion and at a distal end to a second portion of the suspended portion;
the actuator is one or more microelectromechanical systems (MEMS) actuators where each MEMS actuator comprises at least an arm mechanically coupled to the suspended portion of the optical waveguide;
actuation of each MEMS actuator of the one or more MEMS actuators results in movement of the arm such that the suspended portion of the optical waveguide is deflected;
each MEMS actuator of the one or more MEMS actuators comprises a layer of a piezoelectric material; and
the piezoelectric material is coupled to one or more electrode pads allowing electrical activation of the piezoelectric material.

8. The waveguide based optical element according to claim 7, wherein
the another optical waveguide comprises incorporates a Bragg grating; and
deflection of the suspended portion of the optical waveguide adjusts an optical characteristic of the Bragg grating.

9. The waveguide based optical element according to claim 7, wherein
the one or more optical waveguides disposed upon the non-suspended portion comprises:
an optical waveguide disposed upon the first portion of the non-suspended portion and coupled to an end of the another optical waveguide; and
another optical waveguide disposed upon the second portion of the non-suspended portion and coupled to a distal end of the another optical waveguide;
the one or more optical waveguides disposed upon the non-suspended portion and the another optical waveguide on the suspended portion comprise part of an optical ring resonator;
the actuator is one or more microelectromechanical systems (MEMS) actuators where each MEMS actuator comprises at least an arm mechanically coupled to the suspended portion of the optical waveguide;
actuation of each MEMS actuator of the one or more MEMS actuators results in movement of the arm such that the suspended portion of the optical waveguide is deflected thereby adjusting a characteristics of the optical ring resonator.

10. The waveguide based optical element according to claim 1, wherein
the actuator comprises a portion formed from a piezoelectric material coupled to one or more electrode pads allowing electrical activation of the piezoelectric material; and
the piezoelectric layer is a core of the another optical waveguide.

11. The waveguide based optical element according to claim 1, wherein
the actuator comprises a portion formed from a piezoelectric material coupled to one or more electrode pads allowing electrical activation of the piezoelectric material; and
the piezoelectric layer is disposed upon at least one of a lower surface of a portion of the suspended portion and upon the another optical waveguide.

12. The waveguide based optical element according to claim 1, wherein
the actuator comprises a portion formed from a piezoelectric material coupled to one or more electrode pads allowing electrical activation of the piezoelectric material; and
the piezoelectric layer is one of:
disposed upon another suspended portion of the waveguide based optical element coupled to the suspended portion;
disposed adjacent to the another optical waveguide on the suspended portion; and
disposed upon a portion of the suspended portion adjacent to a raised portion of the suspended portion upon which the another optical waveguide is formed.

13. The waveguide based optical element according to claim 1, wherein
the another optical waveguide disposed upon the suspended portion comprises a sequence of layers comprising at least a core layer of a defined material and a cladding layer of another defined material wherein the core layer is disposed between the cladding layer and a material from which the suspended portion of the waveguide based optical element is formed; and
disposed upon a lower surface of the suspended portion of the waveguide based optical element is another sequence of layers comprising at least another core layer of the defined material and another cladding layer of the another defined material wherein the another core layer is disposed between the cladding layer and the material from which the suspended portion of the waveguide based optical element is formed;
the another sequence of layers comprising the another core layer of the defined material and the another cladding layer of the another defined material is patterned the same as the sequence of layers comprising at least the core layer of a defined material and the cladding layer of another defined material;
the actuator comprises a layer of a piezoelectric material coupled to one or more electrode pads allowing electrical activation of the piezoelectric material; and
the piezoelectric layer is at least one of:
disposed upon another suspended portion of the waveguide based optical element coupled to the suspended portion;
a core of the another optical waveguide;
disposed upon a lower surface of a portion of the suspended portion;
disposed upon the another optical waveguide;
disposed adjacent to the another optical waveguide on the suspended portion; and
disposed upon a portion of the suspended portion adjacent to a raised portion of the suspended portion upon which the another optical waveguide is formed.

14. The waveguide based optical element according to claim 1, wherein
the suspended portion of the waveguide based optical element is disposed above a recess formed within the substrate; and
the recess does not extend through the substrate such that the substrate is absent a bottom capping layer disposed on a surface of the substrate distal from that within which the waveguide based optical element is formed.

15. The waveguide based optical element according to claim 1, wherein
the another optical waveguide disposed upon the suspended portion comprises a sequence of layers comprising at least a core layer of a defined material and a cladding layer of another defined material wherein the core layer is disposed between the cladding layer and a material from which the suspended portion of the waveguide based optical element is formed; and
disposed upon a lower surface of the suspended portion of the waveguide based optical element is another sequence of layers comprising at least another core layer of the defined material and another cladding layer of the another defined material wherein the another core layer is disposed between the cladding layer and the material from which the suspended portion of the waveguide based optical element is formed;
the another sequence of layers comprising the another core layer of the defined material and the another cladding layer of the another defined material is patterned the same as the sequence of layers comprising at least the core layer of a defined material and the cladding layer of another defined material;
the suspended portion of the waveguide based optical element is disposed above a recess formed within the substrate;
the recess does not extend through the substrate such that the substrate is absent a bottom capping layer disposed on a surface of the substrate distal from that within which the waveguide based optical element is formed;
the actuator comprises a layer of a piezoelectric material coupled to one or more electrode pads allowing electrical activation of the piezoelectric material; and
the piezoelectric layer is at least one of:
disposed upon another suspended portion of the waveguide based optical element coupled to the suspended portion;
a core of the another optical waveguide;
disposed upon a lower surface of a portion of the suspended portion;
disposed upon the another optical waveguide;
disposed adjacent to the another optical waveguide on the suspended portion; and
disposed upon a portion of the suspended portion adjacent to a raised portion of the suspended portion upon which the another optical waveguide is formed.

16. The waveguide based optical element according to claim 1, wherein
the one or more optical waveguides and the another optical waveguide comprise a sequence of layers vertically disposed comprising:
a lower stack comprising a bottom layer, a mechanical layer and an upper layer;
an upper stack comprising another bottom layer, another mechanical layer and another upper layer; and
a core layer disposed between the upper layer of the lower stack and the another bottom layer of the upper stack;
the lower stack, upper stack and core layer are the suspended portion of the waveguide based optical element;
the actuator comprises a layer of a piezoelectric material coupled to one or more electrode pads allowing electrical activation of the piezoelectric material; and
the piezoelectric layer is at least one of:
disposed upon another suspended portion of the waveguide based optical element coupled to the suspended portion;
the core layer;
disposed upon a lower surface of the lower stack of the suspended portion;
disposed upon an upper surface of the upper stack of the suspended portion;
disposed adjacent to the another optical waveguide on the suspended portion.

17. The waveguide based optical element according to claim 1, wherein
the actuator comprises a layer of a piezoelectric material coupled to one or more electrode pads allowing electrical activation of the piezoelectric material; and
the actuator adjusts the suspended portion of the waveguide based optical element between a first position and a second position;
in the first position an end of an optical waveguide of the one or more optical waveguides disposed upon the non-suspended portion is in contact with the another optical waveguide disposed upon the suspended portion such that optical signals can couple between the optical waveguide of the one or more optical waveguides disposed upon the non-suspended portion and the another optical waveguide disposed upon the suspended portion;
in the second position an end of an optical waveguide of the one or more optical waveguides disposed upon the non-suspended portion is not in contact with the another optical waveguide disposed upon the suspended portion such that optical signals do not couple between one of the optical waveguide of the one or more optical waveguides disposed upon the non-suspended portion and the another optical waveguide disposed upon the suspended portion and the other of the optical waveguide of the one or more optical waveguides disposed upon the non-suspended portion and the another optical waveguide disposed upon the suspended portion;
in the second position the optical signals exit the one of the optical waveguide of the one or more optical waveguides disposed upon the non-suspended portion and the another optical waveguide disposed upon the suspended portion at an angle exceeding the total reflection angle of the air-waveguide interface established by a gap established between the end of an optical waveguide of the one or more optical waveguides disposed upon the non-suspended portion and the another optical waveguide on the suspended portion with the actuator in the second position; and
the piezoelectric layer is at least one of:
disposed upon another suspended portion of the waveguide based optical element coupled to the suspended portion;
a core of the another optical waveguide;
disposed upon a lower surface of a portion of the suspended portion;
disposed upon the another optical waveguide;
disposed adjacent to the another optical waveguide on the suspended portion; and
disposed upon a portion of the suspended portion adjacent to a raised portion of the suspended portion upon which the another optical waveguide is formed.
